(19) United States
(12) Patent Application Publication
(10) Pub. No.: US 2025/0119268 A1
(43) Pub. Date: Apr. 10, 2025

(54) DORMANCY INDICATION IN FULL-DUPLEX SYSTEMS

(71) Applicant: Samsung Electronics Co., Ltd., Suwon-si (KR)

(72) Inventors: Marian Rudolf, Longueuil (CA); Aristides Papasakellariou, Houston, TX (US)

(21) Appl. No.: 18/889,333

(22) Filed: Sep. 18, 2024

Related U.S. Application Data
(60) Provisional application No. 63/542,690, filed on Oct. 5, 2023.
(60) Provisional application No. 63/543,179, filed on Oct. 9, 2023.

(51) Int. Cl. H04L 5/14; H04W 36/00; H04W 72/231

(52) U.S. Cl. CPC H04L 5/14; H04W 36/00692; H04W 72/231

(57) ABSTRACT

Apparatuses and methods for dormancy indication in full-duplex (FD) systems. A method for a user equipment (UE) to receive physical downlink control channels (PDCCHs) includes receiving a set of carrier aggregation (CA) parameters for a serving cell associated with a subband full-duplex (SBFD) configuration on the serving cell and receiving a first PDCCH that provides a downlink control information (DCI) format. The DCI format includes a secondary cell (SCell) dormancy indication enabling or disabling receptions of a second PDCCH, in a downlink (DL) bandwidth part (BWP) associated with a group of configured SCells, for a symbol or a subband type. The method further includes selecting, based on the SCell dormancy indication, the symbol or the subband type for receptions of the second PDCCHs on an SCell in the group of configured SCells and receiving the second PDCCH in the BWP of the SCell at a first occasion.

### CROSS-REFERENCE TO RELATED AND CLAIM OF PRIORITY

The present application claims priority under 35 U.S.C. § 119 (e) to U.S. Provisional Patent Application No. 63/542,690 filed on Oct. 5, 2023, and U.S. Provisional Patent Application No. 63/543,179 filed on Oct. 9, 2023, which are hereby incorporated by reference in their entirety.

### TECHNICAL FIELD

The present disclosure relates generally to wireless communication systems and, more specifically, the present disclosure is related to apparatuses and methods for dormancy indication in full-duplex (FD) systems.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to dormancy indication in FD systems.

In one embodiment, a method for a user equipment (UE) to receive physical downlink control channels (PDCCHs) is provided. The method includes receiving a set of carrier aggregation (CA) parameters for a serving cell associated with a subband full-duplex (SBFD) configuration on the serving cell and receiving a first PDCCH that provides a downlink control information (DCI) format. The DCI format includes a secondary cell (SCell) dormancy indication enabling or disabling receptions of a second PDCCH, in a downlink (DL) bandwidth part (BWP) associated with a group of configured SCells, for a symbol or a subband type. The enabling or disabling of receptions of the second PDCCH is based on the set of CA parameters. The method further includes selecting, based on the SCell dormancy indication, the symbol or the subband type for receptions of the second PDCCHs on an SCell in the group of configured SCells and receiving, based on the selected symbol or subband type and the set of CA parameters, the second PDCCH in the BWP of the SCell at a first occasion. The first occasion is after reception of the first PDCCH and before an end of a time duration. The symbol or subband type is one of an SBFD symbol or a non-SBFD symbol, a downlink (DL) or a flexible symbol for an SBFD symbol, or a first SBFD DL subband, a second SBFD DL subband, an SBFD flexible subband, or an SBFD UL subband.

In another embodiment, a UE is provided. The UE includes a transceiver configured to receive a set of CA parameters for a serving cell associated with a SBFD configuration on the serving cell and receive a first PDCCH that provides a DCI format. The DCI format includes a SCell dormancy indication enabling or disabling receptions of a second PDCCH, in a DL BWP associated with a group of configured SCells, for a symbol or a subband type. The enabling or disabling of receptions of the second PDCCH is based on the set of CA parameters. The UE further includes a processor operably coupled with the transceiver. The processor is configured to select, based on the SCell dormancy indication, the symbol or the subband type for receptions of the second PDCCHs on an SCell in the group of configured SCells. The transceiver is further configured to receive, based on the selected symbol or subband type and the set of CA parameters, the second PDCCH in the BWP of the SCell at a first occasion. The first occasion is after reception of the first PDCCH and before an end of a time duration. The symbol or subband type is one of an SBFD symbol or a non-SBFD symbol, a DL or a flexible symbol for an SBFD symbol, or a first SBFD DL subband, a second SBFD DL subband, an SBFD flexible subband, or an SBFD UL subband.

In yet another embodiment, a base station is provided. The base station includes a transceiver configured to transmit a set of CA parameters for a serving cell associated with a SBFD configuration on the serving cell and transmit a first PDCCH that provides a DCI format. The DCI format includes a SCell dormancy indication enabling or disabling transmissions of a second PDCCH, in a DL BWP associated with a group of configured SCells, for a symbol or a subband type. The enabling or disabling of transmissions of the second PDCCH is based on the set of CA parameters. The base station further includes a processor operably coupled with the transceiver. The processor configured to select, based on the SCell dormancy indication, the symbol or the subband type for transmissions of the second PDCCHs on an SCell in the group of configured SCells. The transceiver is further configured to transmit, based on the selected symbol or subband type and the set of CA parameters, the second PDCCH in the BWP of the SCell at a first occasion. The first occasion is after transmission of the first PDCCH and before an end of a time duration. The symbol or subband type is one of an SBFD symbol or a non-SBFD symbol, a DL or a flexible symbol for an SBFD symbol, or a first SBFD DL subband, a second SBFD DL subband, an SBFD flexible subband, or an SBFD UL subband.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates an example of a transmitter structure for physical downlink shared channel (PDSCH) in a subframe according to embodiments of the present disclosure;

FIG. 7 illustrates an example of a receiver structure for PDSCH in a subframe according to embodiments of the present disclosure;

FIG. 8 illustrates an example of a transmitter structure for physical uplink shared channel (PUSCH) in a subframe according to embodiments of the present disclosure;

FIG. 9 illustrates an example of a receiver structure for a PUSCH in a subframe according to embodiments of the present disclosure;

FIG. 10 illustrates a timeline of an example time division duplex (TDD) configuration according to embodiments of the present disclosure;

FIG. 11 illustrates timelines of example FD configurations according to embodiments of the present disclosure;

FIG. 12 illustrates a timeline for frequency range 1 (FR1)-FR1 inter-band carrier aggregation (CA) configuration according to embodiments of the present disclosure;

FIG. 13 illustrates a flowchart of an example UE procedure for an example secondary cell (SCell) dormancy indication according to embodiments of the present disclosure;

FIG. 14 illustrates a flowchart of an example UE procedure for SCell dormancy indication according to embodiments of the present disclosure;

FIG. 15 illustrates a flowchart of an example UE procedure for dormancy indication according to embodiments of the present disclosure;

FIG. 16 illustrates a flowchart of an example procedure for evaluation of link recovery according to embodiments of the present disclosure; and

FIG. 17 illustrates a flowchart of an example procedure for evaluation of link recovery according to embodiments of the present disclosure.

### DETAILED DESCRIPTION

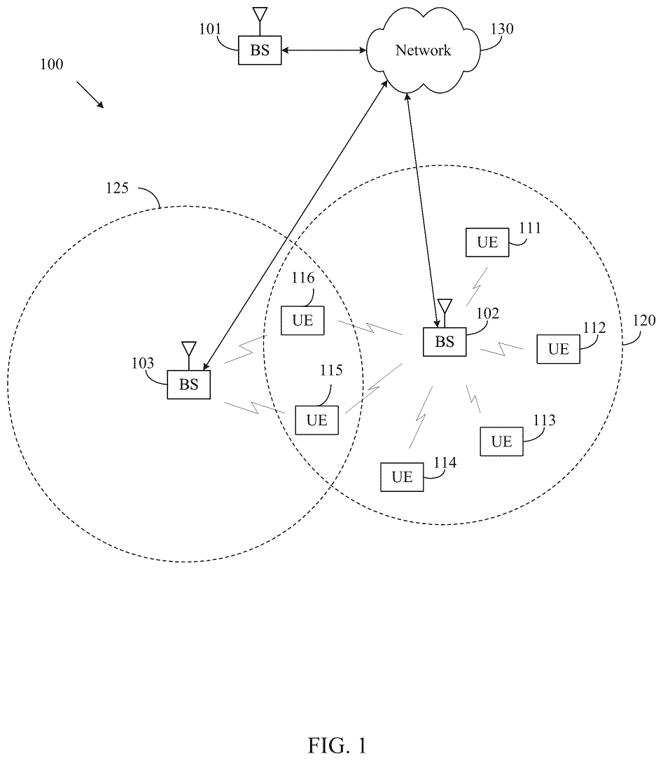

FIGS. 1-17, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents are hereby incorporated by reference into the present disclosure as if fully set forth herein: 3GPP TS 38.211 v18.0.0, “NR; Physical channels and modulation” (REF1); 3GPP TS 38.212 v18.0.0, “NR; Multiplexing and Channel coding” (REF2); 3GPP TS 38.213 v18.0.0, “NR; Physical Layer Procedures for Control” (REF3); 3GPP TS 38.214 v18.0.0, “NR; Physical Layer Procedures for Data” (REF4); 3GPP TS 38.321 v17.5.0, “NR; Medium Access Control (MAC) protocol specification” (REF5); 3GPP TS 38.331 v17.5.0, “NR; Radio Resource Control (RRC) Protocol Specification” (REF6); 3GPP TS 38.133 v18.3.0, “NR; Requirements for support of radio resource management” (REF7); 3GPP TS 38.300 v17.5.0, “NR; NR and NG-RAN Overall Description; Stage 2” (REF8); and 3GPP TS 38.306 v17.4.0, “NR; User Equipment (UE) radio access capabilities” (REF9).

FIGS. 1-4B below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of UEs within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for identifying or using a dormancy indication in FD systems. In certain embodiments, one or more of the BSs 101-103 include circuitry, programing, or a combination thereof to provide or support dormancy indication in FD systems.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

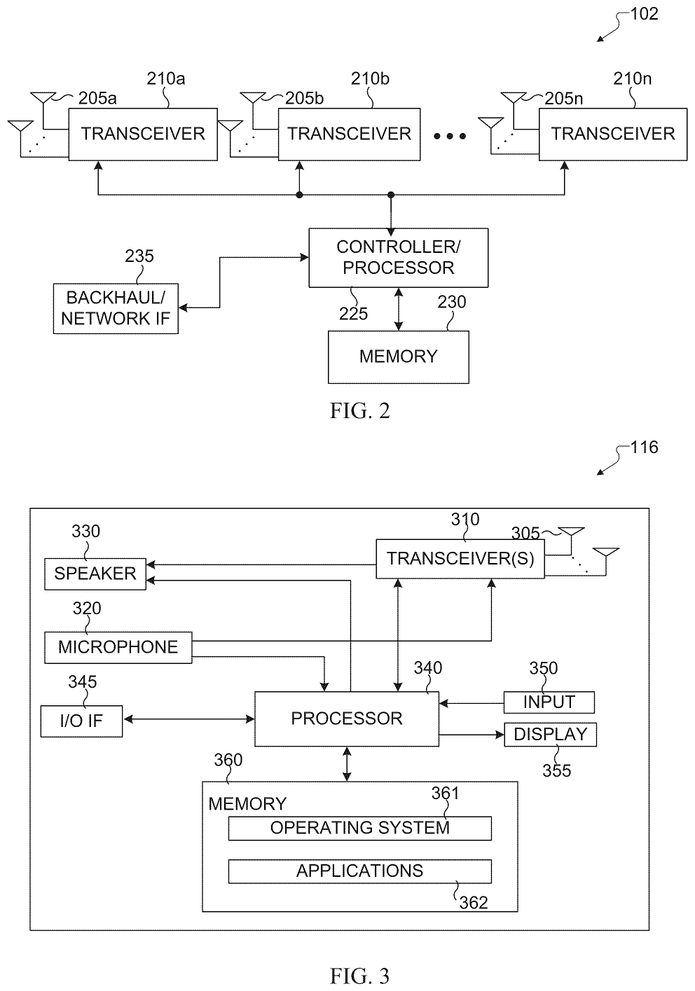

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for dormancy indication in FD systems as described in greater detail below. Any of a wide variety of other functions could be supported in the gNB 102 by the controller/processor 225. The controller/processor 225 can move data into or out of the memory 230 as required by an executing process.

The controller/processor 225 is also capable of executing programs and other processes resident in the memory 230, such as processes to support dormancy indication in FD systems. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to identify or use dormancy indications in FD systems as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

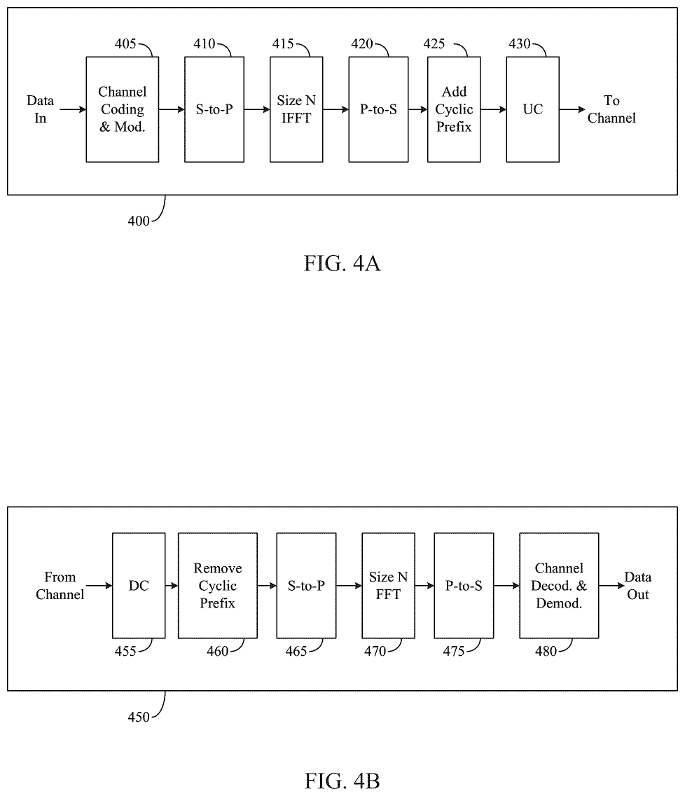

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the receive path 450 is configured to receive information for dormancy indication in FD systems as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

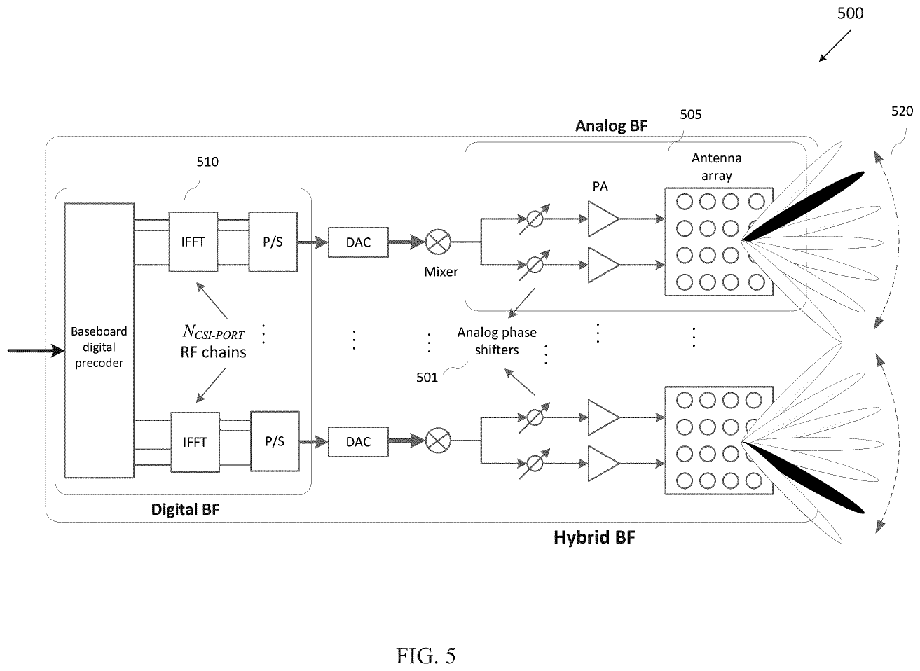

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports NeSI-PORT. A digital beamforming unit 510 performs a linear combination across NeSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 2-2 or FR2-2). In this case, the system can employ only analog beams. Due to the O2 absorption loss around 60 GHz frequency (˜10 dB additional loss per 100 m distance), a larger number and narrower analog beams (hence a larger number of radiators in the array) are necessary to compensate for the additional path loss.

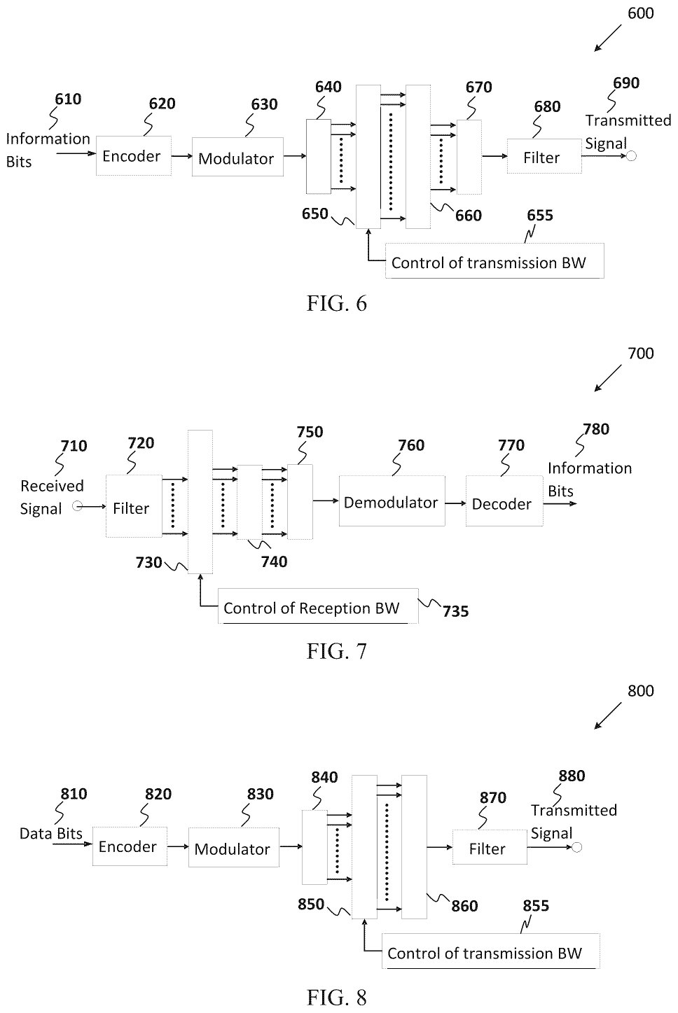

FIG. 6 illustrates an example of a transmitter structure 600 for PDSCH in a subframe according to embodiments of the present disclosure. For example, transmitter structure 600 can be implemented in gNB 102 of FIG. 1. This example is for illustration only and other embodiments can be used without departing from the scope of the present disclosure.

As illustrated in FIG. 6, information bits 610 are encoded by encoder 620, such as a turbo encoder, and modulated by modulator 630, for example using Quadrature Phase Shift Keying (QPSK) modulation. A Serial to Parallel (S/P) converter 640 generates M modulation symbols that are subsequently provided to a mapper 650 to be mapped to REs selected by a transmission beamwidth (BW) selection unit 655 for an assigned PDSCH transmission BW, unit 660 applies an Inverse Fast Fourier Transform (IFFT), the output is then serialized by a Parallel to Serial (P/S) converter 670 to create a time domain signal, filtering is applied by filter 680, and a signal transmitted 690. Additional functionalities, such as data scrambling, cyclic prefix insertion, time windowing, interleaving, and others are well known in the art and are not shown for brevity.

FIG. 7 illustrates an example of a receiver structure 700 for PDSCH in a subframe according to embodiments of the present disclosure. For example, receiver structure 700 can be implemented by any of the UEs 111-116 of FIG. 1. This example is for illustration only and other embodiments can be used without departing from the scope of the present disclosure.

With reference to FIG. 7, a received signal 710 is filtered by filter 720, REs 730 for an assigned reception BW are selected by BW selector 735, unit 740 applies a Fast Fourier Transform (FFT), and an output is serialized by a parallel-to-serial converter 750. Subsequently, a demodulator 760 coherently demodulates data symbols by applying a channel estimate obtained from a demodulation reference signal (DMRS) or a CRS (not shown), and a decoder 770, such as a turbo decoder, decodes the demodulated data to provide an estimate of the information data bits 780. Additional functionalities such as time-windowing, cyclic prefix removal, de-scrambling, channel estimation, and de-interleaving are not shown for brevity.

FIG. 8 illustrates an example of a transmitter structure 800 for PUSCH in a subframe according to embodiments of the present disclosure. For example, transmitter structure 800 can be implemented in gNB 103 of FIG. 1. This example is for illustration only and other embodiments can be used without departing from the scope of the present disclosure.

As illustrated in FIG. 8, information data bits 810 are encoded by encoder 820, such as a turbo encoder, and modulated by modulator 830. A Discrete Fourier Transform (DFT) unit 840 applies a DFT on the modulated data bits, REs 850 corresponding to an assigned PUSCH transmission BW are selected by transmission BW selection unit 855, unit 860 applies an IFFT and, after a cyclic prefix insertion (not shown), filtering is applied by filter 870 and a signal transmitted 880.

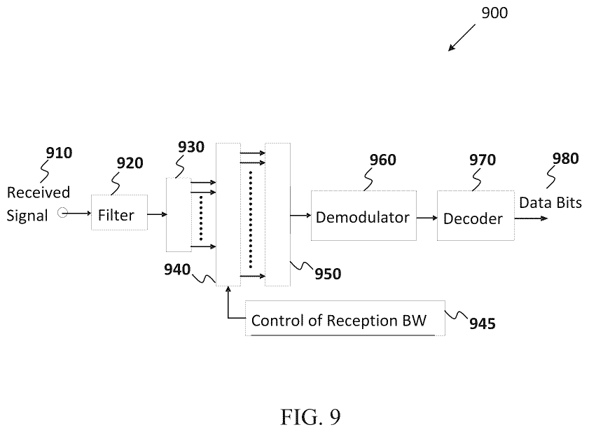

FIG. 9 illustrates an example of a receiver structure 900 for a PUSCH in a subframe according to embodiments of the present disclosure; For example, receiver structure 900 can be implemented by the UE 116 of FIG. 3. This example is for illustration only and other embodiments can be used without departing from the scope of the present disclosure.

As illustrated in FIG. 9, a received signal 910 is filtered by filter 920. Subsequently, after a cyclic prefix is removed (not shown), unit 930 applies a FFT, REs 940 corresponding to an assigned PUSCH reception BW are selected by a reception BW selector 945, unit 950 applies an Inverse DFT (IDFT), a demodulator 960 coherently demodulates data symbols by applying a channel estimate obtained from a DMRS (not shown), a decoder 970, such as a turbo decoder, decodes the demodulated data to provide an estimate of the information data bits 980.

A communication system can include a downlink (DL) that refers to transmissions from a base station (such as the BS 102) or one or more transmission points to UEs (such as the UE 116) and an uplink (UL) that refers to transmissions from UEs (such as the UE 116) to a base station (such as the BS 102) or to one or more reception points.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 1 millisecond or 0.5 millisecond, include 14 symbols and an RB can include 12 SCs with inter-SC spacing of 15 kHz or 30 kHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A gNB (such as the BS 102) transmits one or more of multiple types of RS including channel state information RS (CSI-RS) and demodulation RS (DM-RS). A CSI-RS is primarily intended for UEs to perform measurements and provide channel state information (CSI) to a gNB.

For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE (such as the UE 116) can determine CSI-RS transmission parameters through DL control signaling or higher layer signaling, such as radio resource control (RRC) signaling, from a gNB (such as the BS 102). Transmission instances of a CSI-RS can be indicated by DL control signaling or be configured by higher layer signaling. A DM-RS is transmitted only in the BW of a respective PDCCH or PDSCH and a UE can use the DM-RS to demodulate data or control information.

In certain embodiments, UL signals also include data signals conveying information content, control signals conveying UL control information (UCI), DM-RS associated with data or UCI demodulation, sounding RS (SRS) enabling a gNB to perform UL channel measurement, and a RA preamble enabling a UE to perform RA (see also NR specification). A UE transmits data information or UCI through a respective PUSCH or a physical UL control channel (PUCCH). A PUSCH or a PUCCH can be transmitted over a variable number of slot symbols including one slot symbol. The gNB can configure the UE to transmit signals on a cell within an active UL bandwidth part (BWP) of the cell UL BW.

UCI includes hybrid automatic repeat request (HARQ) acknowledgement (ACK) information, indicating correct or incorrect detection of data transport blocks (TBs) in a PDSCH, scheduling request (SR) indicating whether a UE has data in a buffer, and CSI reports enabling a gNB to select appropriate parameters for PDSCH or PDCCH transmissions to a UE. Hybrid automatic repeat request acknowledgement (HARQ-ACK) information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER (see NR specification), of a precoding matrix indicator (PMI) informing a gNB how to combine signals from multiple transmitter antennas in accordance with a MIMO transmission principle, and of a rank indicator (RI) indicating a transmission rank for a PDSCH.

UL RS includes DM-RS and SRS. DM-RS is transmitted only in a BW of a respective PUSCH or PUCCH transmission. A gNB can use a DM-RS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel (PRACH as shown in NR specifications).

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may expect the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a synchronization signal/physical broadcast channels (SS/PBCH) block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may expect that synchronization signal (SS)/PBCH block (also denoted as synchronization signal blocks (SSBs)) transmitted with the same block index on the same center frequency location are quasi co-located with respect to Doppler spread, Doppler shift, average gain, average delay, delay spread, and, when applicable, spatial Rx parameters. The UE may not expect quasi co-location for any other synchronization signal SS/PBCH block transmissions.

In absence of CSI-RS configuration, and unless otherwise configured, the UE may expect PDSCH DM-RS and SSB to be quasi co-located with respect to Doppler shift, Doppler spread, average delay, delay spread, and, when applicable, spatial Rx parameters. The UE may expect that the PDSCH DM-RS within the same code division multiplexing (CDM) group is quasi co-located with respect to Doppler shift, Doppler spread, average delay, delay spread, and spatial Rx. The UE may also expect that DM-RS ports associated with a PDSCH are quasi co located (QCL) with QCL type A, type D (when applicable) and average gain. The UE may further expect that no DM-RS collides with the SS/PBCH block.

A beam may be determined by a transmission configuration indication (TCI) state that establishes a quasi-co-location (QCL) relationship or a spatial relation between a source reference signal, e.g., a synchronization signal block (SS/PBCH Block or SSB) or channel state information reference signal (CSI-RS) and a target reference signal, or a spatial relationship information that establishes an association to a source reference signal, such as an SSB, CSI-RS, or sounding reference signal (SRS). In either case, the ID of the source reference signal can identify the beam.

The TCI state and/or the spatial relationship reference RS can determine a spatial Rx filter for reception of downlink channels or signals at the UE, or a spatial Tx filter for transmission of uplink channels or signals from the UE. The TCI state and/or the spatial relation reference RS can determine a spatial Tx filter for transmission of downlink channels or signals from the gNB, or a spatial Rx filter for reception of uplink channels or signals at the gNB.

A UE can be indicated a spatial setting for a PDCCH reception based on a configuration of a value for a transmission configuration indication state (TCI state) of a control resource set (CORESET) where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

The UE can be configured with a list of up to M transmission configuration indication (TCI) State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

A quasi-co-location (QCL) relationship may be configured by the higher layer parameter qcl-Type1 for a first DL RS, and qcl-Type2 for a second DL RS (if configured). For the case of two DL RSs, the QCL types may not be the same, regardless of whether the references are to the same DL RS or different DL RSs. The quasi-co-location types corresponding to each DL RS can be given by the higher layer parameter qcl-Type in QCL-Info and may take one of the following values: QCL-TypeA: {Doppler shift, Doppler spread, average delay, delay spread}; QCL-TypeB: {Doppler shift, Doppler spread; QCL-TypeC: {Doppler shift, average delay}; and QCL-TypeD: {Spatial Rx parameter}.

A reference RS may correspond to a set of characteristics of a DL beam or an UL Tx beam, such as a direction, a precoding/beamforming, a number of ports, and so on.

A UE can be provided through higher layer RRC signaling a set of TCI States with N elements. In one example, DL and joint TCI states are configured by higher layer parameter DLorJoint-TCIState, wherein, the number of DL and Joint TCI state is N_{DJ}. UL TCI states are configured by higher layer parameter (IL-TCIState, wherein the number of UL TCI states is N_{U}. N=N_{DJ}+N_{U}. The DLorJoint-TCIState can include DL or Joint TCI states for a serving cell. The source RS of the TCI state may be associated with the serving cell, e.g., the physical cell ID (PCI) of the serving cell. Additionally, the DL or Joint TCI states can be associated with a cell having a PCI different from the PCI of the serving cell, e.g. the source RS of the TCI state is associated with a cell having a PCI different from the PCI of the serving cell. The (II.-TCIState can include UL TCI states that belong to a serving cell, e.g. the source RS of the TCI state is associated with the serving cell (the PCI of the serving cell); additionally, the UL TCI states can be associated with a cell having a PCI different from the PCI of the serving cell, e.g. the source RS of the TCI state is associated with a cell having a PCI different from the PCI of the serving cell.

MAC CE signaling can include a subset of M (M≤N) TCI states or TCI state code points from the set of N TCI states, wherein a code point is signaled in the “transmission configuration indication” field of a DCI used for indication of the TCI state. A codepoint can include one TCI state, e.g., DL TCI state or UL TCI state or Joint (DL and UL) TCI state. Alternatively, a codepoint can include two TCI states, e.g., a DL TCI state and an UL TCI state. L1 control signaling, i.e., Downlink Control Information (DCI) can update the UE's TCI state, wherein the DCI includes a “transmission configuration indication” (beam indication) field, e.g., using m bits such that M≤2′. The TCI state may correspond to a code point signaled by MAC CE. A DCI used for indication of the TCI state can be a DCI format 1_1 or DCI format 1_2 or DCI format 1_3 with a DL assignment for PDSCH receptions or without a DL assignment for PDSCH receptions.

The TCI states can be associated through a QCL relation with an SSB or a CSI-RS of serving cell, or an SSB or a CSI-RS associated with a PCI different from the PCI of the serving cell. The QCL relation with an SSB can be a direct QCL relation, wherein the source RS, e.g., for a QCL Type D relation or a spatial relation of the QCL state is the SSB. The QCL relation with an SSB can be an indirect QCL relation wherein the source RS, e.g., for a QCL Type D relation or a spatial relation can be a CSI-RS and the CSI-RS has the SSB as its source, e.g., for a QCL Type D relation or a spatial relation. The indirect QCL relation to an SSB can involve a QCL or spatial relation chain of more than one CSI-RS.

The UE can be configured with a list of up to M transmission configuration indication (TCI) State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

The quasi-co-location relationship is configured by the higher layer parameter qcl-Type I for the first DL RS, and qcl-Type2 for the second DL RS (if configured). For the case of two DL RSs, the QCL types may not be the same, regardless of whether the references are to the same DL RS or different DL RSs. The quasi-co-location types corresponding to each DL RS are given by the higher layer parameter qcl-Type in QCL-Info and may take one of the following values: QCL-TypeA: {Doppler shift, Doppler spread, average delay, delay spread}; QCL-TypeB: {Doppler shift, Doppler spread; QCL-TypeC: {Doppler shift, average delay}; and QCL-TypeD: {Spatial Rx parameter}.

A reference RS may correspond to a set of characteristics of a DL beam or an UL Tx beam, such as a direction, a precoding/beamforming, a number of ports, and so on.

A UE can be provided through higher layer RRC signaling a set of TCI States with N elements. In one example, DL and joint TCI states are configured by higher layer parameter DLorJoint-TCIState, wherein, the number of DL and Joint TCI state is N_{DJ}. UL TCI states are configured by higher layer parameter UL-TCIState, wherein the number of UL TCI states is N_{U}. N=N_{DJ}+N_{U}. The DLorJoint-TCIState can include DL or Joint TCI states for a serving cell. The source RS of the TCI state may be associated with the serving cell, e.g., the PCI of the serving cell. Additionally, the DL or Joint TCI states can be associated with a cell having a PCI different from the PCI of the serving cell, e.g. the source RS of the TCI state is associated with a cell having a PCI different from the PCI of the serving cell. The UL-TCIState can include UL TCI states that belong to a serving cell, e.g. the source RS of the TCI state is associated with the serving cell (the PCI of the serving cell); additionally, the UL TCI states can be associated with a cell having a PCI different from the PCI of the serving cell, e.g. the source RS of the TCI state is associated with a cell having a PCI different from the PCI of the serving cell.

MAC CE signaling can include a subset of M (M≤N) TCI states or TCI state code points from the set of N TCI states, wherein a code point is signaled in the “transmission configuration indication” field of a DCI used for indication of the TCI state. A codepoint can include one TCI state, e.g., DL TCI state or UL TCI state or Joint (DL and UL) TCI state. Alternatively, a codepoint can include two TCI states, e.g., a DL TCI state and an UL TCI state. L1 control signaling, i.e., Downlink Control Information (DCI) can update the UE's TCI state, wherein the DCI includes a “transmission configuration indication” (beam indication) field, e.g., using m bits such that M≤2^{m}. The TCI state may correspond to a code point signaled by MAC CE. A DCI used for indication of the TCI state can be a DCI format 1_1 or DCI format 1_2 or DCI format 1_3 with a DL assignment for PDSCH receptions or without a DL assignment for PDSCH receptions.

The TCI states can be associated through a QCL relation with an SSB or a CSI-RS of serving cell, or an SSB or a CSI-RS associated with a PCI different from the PCI of the serving cell. The QCL relation with an SSB can be a direct QCL relation, wherein the source RS, e.g., for a QCL Type D relation or a spatial relation of the QCL state is the SSB. The QCL relation with an SSB can be an indirect QCL relation wherein the source RS, e.g., for a QCL Type D relation or a spatial relation can be a CSI-RS and the CSI-RS has the SSB as its source, e.g., for a QCL Type D relation or a spatial relation. The indirect QCL relation to an SSB can involve a QCL or spatial relation chain of more than one CSI-RS.

In the present disclosure, the frequency resolution (reporting granularity) and span (reporting bandwidth) of CSI or calibration coefficient reporting can be defined in terms of frequency “subbands” and “CSI reporting band” (CRB), respectively.

A subband for CSI or calibration coefficient reporting is defined as a set of contiguous physical resource blocks (PRBs) which represents the smallest frequency unit for CSI or calibration coefficient reporting. The number of PRBs in a subband can be fixed for a given value of DL system bandwidth, configured either via higher layer/RRC signaling, or via L1 DL control signaling or MAC control element (MAC CE). The number of PRBs in a subband can be included in CSI or calibration coefficient reporting setting. The term “CSI reporting band” is defined as a set/collection of subbands, either contiguous or non-contiguous, wherein CSI or calibration coefficient reporting is performed. For example, CSI or calibration coefficient reporting band can include the subbands within the DL system bandwidth. This can also be termed “full-band”. Alternatively, CSI or calibration coefficient reporting band can include only a collection of subbands within the DL system bandwidth. This can also be termed “partial band”. The term “CSI reporting band” is used only as an example for representing a function. Other terms such as “CSI reporting subband set” or “CSI or calibration coefficient reporting bandwidth” can also be used.

In terms of UE configuration, a UE can be configured with at least one CSI or calibration coefficient reporting band. This configuration can be semi-static (via higher layer signaling or RRC) or dynamic (via MAC CE or L1 DL control signaling). When configured with multiple (N) CSI or calibration coefficient reporting bands (e.g., via RRC signaling), a UE can report CSI associated with n≤N CSI reporting bands. For instance, >6 GHz, large system bandwidth may require multiple CSI or calibration coefficient reporting bands. The value of n can either be configured semi-statically (via higher layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mn subbands when one CSI parameter for the Mn subbands within the CSI reporting band. A CSI parameter is configured with “subband” for the CSI reporting band with Mn subbands when one CSI parameter is reported for each of the Mn subbands within the CSI reporting band.

In certain embodiments, 5G NR radio supports time-division duplex (TDD) operation and frequency division duplex (FDD) operation. Use of FDD or TDD depends on the NR frequency band and per-country allocations. TDD is required in most bands above 2.5 GHz.

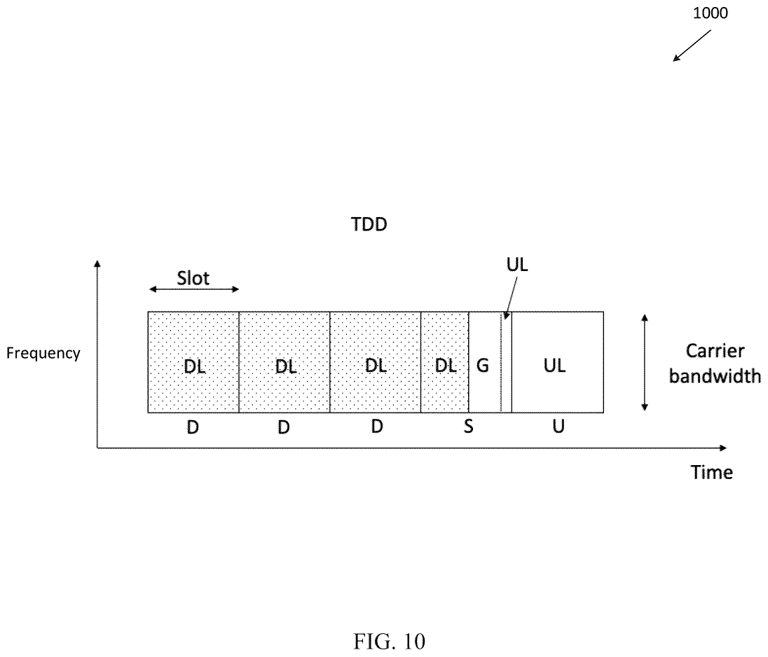

FIG. 10 illustrates a timeline 1000 of an example TDD configuration. For example, timeline 1000 of an example TDD configuration can be utilized by the BS 102 of FIG. 1 and the UE 116 of FIG. 3. This example is for illustration only and other embodiments can be used without departing from the scope of the present disclosure.

With reference to FIG. 10, a DDDSU UL-DL configuration is shown. Here, D denotes a DL slot, U denotes an UL slot, and S denotes a special or switching slot with a DL part, a flexible part that can also be used as guard period G for DL-to-UL switching, and optionally an UL part.

TDD has a number of advantages over FDD. For example, use of the same band for DL and UL transmissions leads to simpler UE implementation with TDD because a duplexer is not required. Another advantage is that time resources can be flexibly assigned to UL and DL taking into account an asymmetric ratio of traffic in both directions. DL is typically assigned most time resources in TDD to handle DL-heavy mobile traffic. Another advantage is that CSI can be more easily acquired via channel reciprocity. This reduces an overhead associated with CSI reports especially when there is a large number of antennas.

Although there are advantages of TDD over FDD, there are also disadvantages. A first disadvantage is a smaller coverage of TDD due to the smaller portion of time resources available for transmissions from a UE, while with FDD time resources can be used. Another disadvantage is latency. In TDD, a timing gap between reception by a UE and transmission from a UE containing the hybrid automatic repeat request acknowledgement (HARQ-ACK) information associated with receptions by the UE is typically larger than that in FDD, for example by several milliseconds. Therefore, the HARQ round trip time in TDD is typically longer than that with FDD, especially when the DL traffic load is high. This causes increased UL user plane latency in TDD and can cause data throughput loss or even HARQ stalling when a PUCCH providing HARQ-ACK information needs to be transmitted with repetitions in order to improve coverage (an alternative in such case is for a network (e.g., the network 130) to forgo HARQ-ACK information at least for some transport blocks in the DL).

To address some of the disadvantages for TDD operation, an adaptation of link direction based on physical layer signaling using a DCI format is supported where, with the exception of some symbols in some slots supporting predetermined transmissions such as for SSBs, symbols of a slot can have a flexible direction (UL or DL) that a UE can determine according to scheduling information for transmissions or receptions. A PDCCH can also be used to provide a DCI format, such as a DCI format 2_0 as described in REF3, that can indicate a link direction of some flexible symbols in one or more slots. Nevertheless, in actual deployments, it is difficult for a gNB scheduler to adapt a transmission direction of symbols without coordination with other gNB schedulers in the network. This is because of CLI where, for example, DL receptions in a cell by a UE can experience large interference from UL transmissions in the same or neighboring cells from other UEs.

Full-duplex (FD) communications offer an option for increased spectral efficiency, improved capacity, and reduced latency in wireless networks (e.g., the wireless network 100). When using FD communications, UL and DL signals are simultaneously received and transmitted on fully or partially overlapping, or adjacent, frequency resources, thereby improving spectral efficiency and reducing latency in user and/or control planes.

There are several options for operating a FD wireless communication system. For example, a single carrier may be used such that transmissions and receptions are scheduled on same time-domain resources, such as symbols or slots. Transmissions and receptions on same symbols or slots may be separated in frequency, for example by being placed in non-overlapping subbands. An UL frequency sub-band, in time-domain resources that also include DL frequency sub-bands, may be located in the center of a carrier, or at the edge of the carrier, or at a selected frequency-domain position of the carrier. The allocations of DL subbands and UL subbands may also partially or even fully overlap.

A gNB may simultaneously transmit and receive in time-domain resources using same physical antennas, antenna ports, antenna panels and transmitter-receiver units (TRX). Transmission and reception in FD may also occur using separate physical antennas, ports, panels, or TRXs. Antennas, ports, panels, or TRXs may also be partially reused, or only respective subsets can be active for transmissions and receptions when FD communication is enabled.

When a UE receives signals/channels from a gNB in a full-duplex slot, the receptions may be scheduled in a DL subband of the full-duplex slot. When full-duplex operation at the gNB uses DL slots for scheduling transmissions from the UE using full-duplex transmission and reception at the gNB, there may be one or multiple, such as two, DL subbands in the full-duplex slot. When a UE is scheduled to transmit in a full-duplex slot, the transmission may be scheduled in an UL subband of the full-duplex slot. When full-duplex operation at the gNB (e.g., the gNB 102) uses UL slots for purpose of scheduling transmissions to UEs using full-duplex transmission and reception at the gNB, there may be one or multiple, such as two, UL subbands in the full-duplex slot. Full-duplex operation using an UL subband or a DL subband may be referred to as Subband-Full-Duplex (SBFD).

For example, when full-duplex operation at the gNB uses a DL or F slot or symbol for scheduling transmissions from the UE using full-duplex transmission and reception at the gNB, there may be one DL subband on the full-duplex slot or symbol and one UL subband of the full-duplex slot or symbol in the NR carrier. A frequency-domain configuration of the DL and UL subbands may then be referred to as ‘DU’ or ‘UD’, respectively, depending on whether the UL subband is configured/indicated in the upper or the lower part of the NR carrier. In another example, when full-duplex operation at the gNB uses a DL or F slot or symbol for scheduling transmissions from the UE using full-duplex transmission and reception at the gNB, there may be two, SBFD DL subbands and one SBFD UL subband on the full-duplex slot or symbol. A frequency-domain configuration of the SBFD DL and UL subbands may then be referred to as ‘DUD’ when the UL subband is configured/indicated in a part of the NR carrier and the DL subbands are configured/indicated at the edges of the NR carrier, respectively.

In the following, for brevity, full-duplex slots/symbols and SBFD slots/symbols may be jointly referred to as SBFD slots/symbols and non-full-duplex slots/symbols and normal DL or UL slot/symbols may be referred to as non-SBFD slots/symbols.

Instead of using a single NR carrier for full-duplex operation, it is also feasible to use different component carriers (CCs) for receptions and transmissions by a UE. For example, receptions by a UE can occur on a first CC and transmissions by the UE occur on a second CC having a small, including zero, frequency separation from the first CC. For example, when carrier-aggregation based full-duplex operation is used, an SBFD subband may correspond to a component carrier or a part of a component carrier or an SBFD subband may be allocated using parts of multiple component carriers.

In one example, the gNB may support full-duplex operation, e.g., support simultaneous DL transmission to a UE in an SBFD DL subband and UL reception from a UE in an SBFD UL subband on an SBFD slot or symbol. In one example, the gNB-side may support full-duplex operation using multiple TRPs, e.g., TRP A may be used for simultaneous DL transmission to a UE and TRP B for UL reception from a UE on an SBFD slot or symbol.

Full-duplex operation may be supported by a half-duplex UE or by a full-duplex UE. A UE operating in half-duplex mode can either transmit or receive at a same time but cannot simultaneously transmit and receive on a same symbol. A UE operating in full-duplex mode can simultaneously transmit and receive on a same symbol. For example, a UE can operate in full-duplex mode on a single NR carrier or based on the use of intra-band or inter-band carrier aggregation.

For example, when the UE is capable of full-duplex operation, SBFD operation based on overlapping or non-overlapping subbands or using one or multiple UE antenna panels may be supported by the UE. In one example, an FR2-1 UE may support simultaneous transmission to the gNB and reception from the gNB on a same time-domain resource, e.g., symbol or slot. The UE capable of full-duplex operation may then be configured, scheduled, assigned or indicated with DL receptions from the gNB in an SBFD DL subband on a same SBFD symbol where the UE is configured, scheduled, assigned or indicated for UL transmissions to the gNB on an SBFD UL subband. In one example, the DL receptions by the UE may use a first UE antenna panel while the UL transmissions from the UE may use a second UE antenna panel on the same SBFD symbol/slot. For example, UE-side self-interference cancellation capability may be supported in the UE by one or a combination of techniques as described in the gNB case, e.g., based on spatial isolation provided by the UE antennas or UE antenna panels, or based on analog and/or digital equalization, or filtering. In one example, DL receptions by the UE in a first frequency channel, band or frequency range, may use a TRX of a UE antenna or UE antenna panel while the UL transmissions from the UE in a second frequency channel, band or frequency range may use the TRX on a same SBFD symbol/slot. For example, when the UE is capable of full-duplex operation based on the use of carrier aggregation, simultaneous DL reception from the gNB and UL transmission to the gNB on a same symbol may occur on different component carriers.

In the following, for brevity, a UE operating in half-duplex mode but supporting a number of enhancements for gNB-side full-duplex operation may be referred to as SBFD-aware UE. For example, the SBFD-aware UE may support time-domain or frequency-domain resource allocation enhancements to improve the UL coverage or throughput or spectral efficiency when operating on a serving cell with gNB-side SBFD support.

In the following, for brevity, a UE (e.g., the UE 116) operating in full-duplex mode may be referred to as SBFD-capable UE, or as full-duplex capable UE, or as a full-duplex UE. A full-duplex UE may support a number of enhancements for gNB-side full-duplex operation.

In one example, a gNB may operate in full-duplex (or SBFD) mode and a UE operates in half-duplex mode. In one example, a gNB may operate in full-duplex (or SBFD) mode and a UE operates in full-duplex (or SBFD) mode. In one example, gNB-side support of full-duplex (or SBFD) operation is based on multiple TRPs wherein a TRP may operate in half-duplex mode, and a UE operates in full-duplex mode.

In one example, a TDD serving cell supports a mix of full-duplex and half-duplex UEs. For example, UE1 supports full-duplex operation and the UE1 can transmit and receive simultaneously in a slot or symbol when configured, scheduled, assigned or indicated by the gNB, but UE2 supports half-duplex operation and can either transmit or receive in a slot or symbol while simultaneous DL reception by UE2 and UL transmission from UE2 cannot occur on the same slot or symbol.

FD transmission/reception is not limited to gNBs, TRPs, or UEs, but can also be used for other types of wireless nodes such as relay or repeater nodes

Full duplex operation needs to overcome several challenges in order to be functional in actual deployments. When using overlapping frequency resources, received signals are subject to co-channel CLI and self-interference. CLI and self-interference cancellation methods include passive methods that rely on isolation between transmit and receive antennas, active methods that utilize RF or digital signal processing, and hybrid methods that use a combination of active and passive methods. Filtering and interference cancellation may be implemented in RF, baseband (BB), or in both RF and BB. While mitigating co-channel CLI may require large complexity at a receiver, it is feasible within current technological limits. Another aspect of FD operation is the mitigation of adjacent channel CLI because in several cellular band allocations, different operators have adjacent spectrum.

Throughout the disclosure, the term Full-Duplex (FD) is used as a short form for a full-duplex operation in a wireless system. The terms ‘cross-division-duplex’ (XDD), ‘full duplex’ (FD) and ‘subband-full-duplex’ (SBFD) may be used interchangeably in the disclosure.

FD operation in NR can improve spectral efficiency, link robustness, capacity, and latency of UL transmissions. In an NR TDD system, transmissions from a UE are limited by fewer available transmission opportunities than receptions by the UE. For example, for NR TDD with subcarrier spacing (SCS)=30 kHz, DDDU (2 msec), DDDSU (2.5 msec), or DDDDDDDSUU (5 msec), the UL-DL configurations allow for an DL: UL ratio from 3:1 to 4:1. Any transmission from the UE can only occur in a limited number of UL slots, for example every 2, 2.5, or 5 msec, respectively.

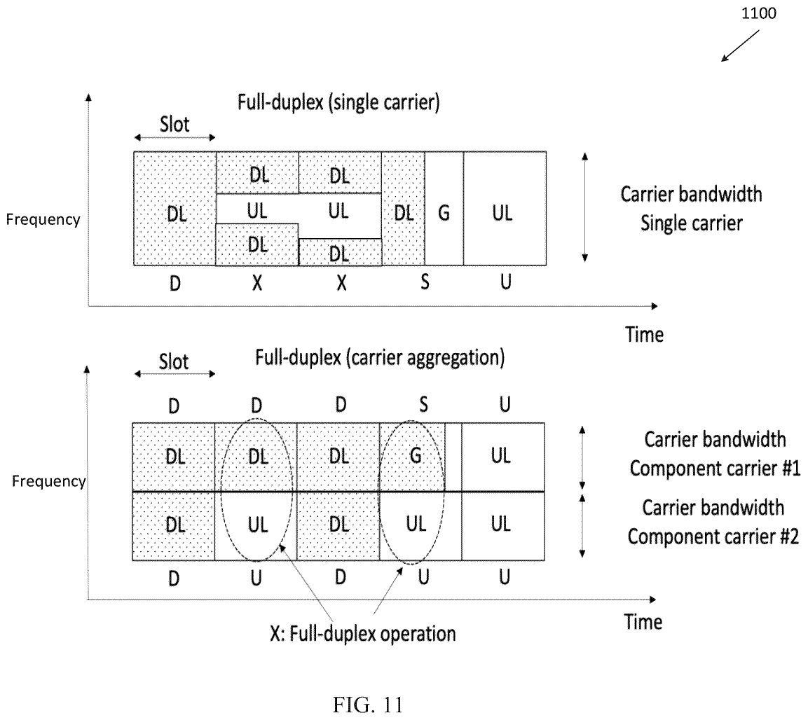

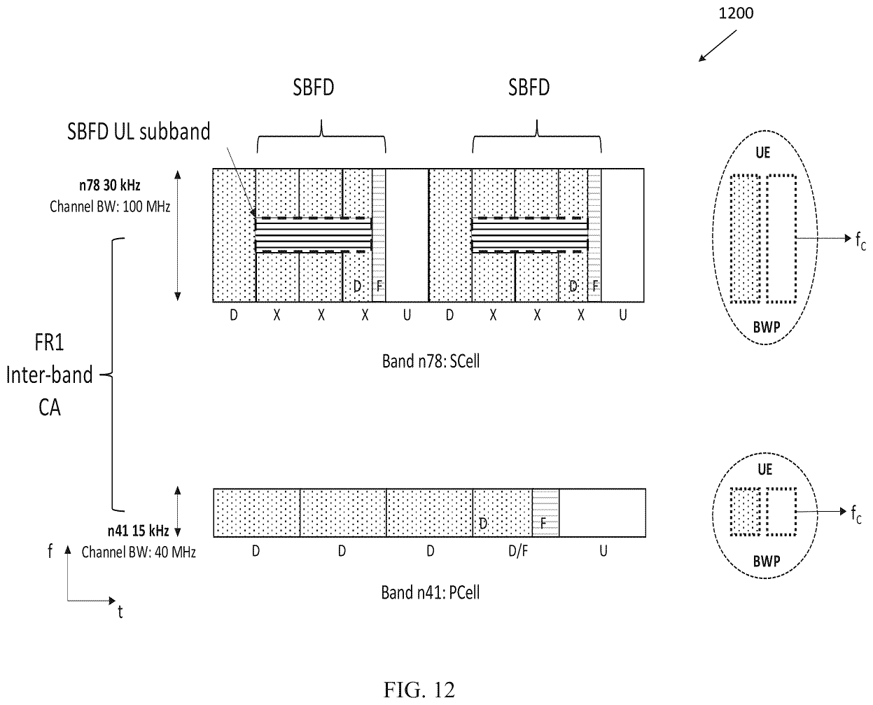

FIG. 11 illustrates timelines 1100 of example FD configurations according to embodiments of the present disclosure. For example, timelines 1100 can be utilized by the BS 102 of FIG. 1 and the UE 116 of FIG. 3. This example is for illustration only and other embodiments can be used without departing from the scope of the present disclosure.

For a single carrier TDD configuration with FD enabled, slots denoted as X are FD slots. Both DL and UL transmissions can be scheduled in FD slots for at least one or more symbols. The term FD slot is used to refer to a slot where UEs can simultaneously receive and transmit in at least one or more symbols of the slot if scheduled or assigned radio resources by the base station. A half-duplex UE cannot transmit and receive simultaneously in a FD slot or on a symbol of a FD slot. When a half-duplex UE is configured for transmission in symbols of a FD slot, another UE can be configured for reception in the symbols of the FD slot. A FD UE can transmit and receive simultaneously in symbols of a FD slot, possibly in presence of other UEs with resources for either receptions or transmissions in the symbols of the FD slot. Transmissions by a UE in a first FD slot can use same or different frequency-domain resources than in a second FD slot, wherein the resources can differ in bandwidth, a first RB, or a location of the center carrier.

When a UE receives signals/channels from a gNB in a full-duplex slot, the receptions may be scheduled in a DL subband of the full-duplex slot. When full-duplex operation at the gNB 102 uses DL slots for scheduling transmissions from the UE 116 using full-duplex transmission and reception at the gNB 102, there may be one or multiple, such as two, DL subbands in the full-duplex slot. When a UE is scheduled to transmit in a full-duplex slot, the transmission may be scheduled in an UL subband of the full-duplex slot. When full-duplex operation at the gNB 102 uses UL slots for purpose of scheduling transmissions to UEs using full-duplex transmission and reception at the gNB 102, there may be one or multiple, such as two, UL subbands in the full-duplex slot.

For a carrier aggregation TDD configuration with FD enabled, a UE receives in a slot on CC #1 and transmits in at least one or more symbols of the slot on CC #2. In addition to D slots used only for transmissions/receptions by a gNB/UE, U slots used only for receptions/transmissions by the gNB/UE, and S slots that are used for both transmission and receptions by the gNB/UE and also support DL-UL switching, FD slots with both transmissions/receptions by a gNB or a UE that occur on same time-domain resources, such as slots or symbols, are labeled by X. For the example of TDD with SCS=30 kHz, single carrier, and UL-DL allocation DXXSU (2.5 msec), the second and third slots allow for FD operation. Transmissions from a UE can also occur in a last slot (U) where the full UL transmission bandwidth is available. FD slots or symbol assignments over a time period/number of slots can be indicated by a DCI format in a PDCCH reception and can then vary per unit of the time period, or can be indicated by higher layer signaling, such as via a MAC CE or RRC.

Using Rel-15 NR, the PDCCH monitoring activity of the UE in RRC_CONNECTED mode may be controlled in several ways by a serving gNB using higher layer signaling through bandwidth part (BWP) adaptation, or discontinuous reception (DRX) as described in REF3, REF5 and REF6. Note that discontinuous reception (DRX) for UEs in RRC_CONNECTED mode may also be referred to as C-DRX operation.

Using Rel-15 NR and when a gNB configures BWP adaptation to a UE, the gNB may set transmission and reception bandwidths for the UE to be smaller than the NR carrier bandwidth. Up to 4 DL or UL BWPs may be configured for a UE. For operation in unpaired spectrum, i.e., TDD, a DL BWP and UL BWP in a DL/UL BWP pair have a same center frequency. A UE has only one active DL BWP for receptions and only one active UL BWP for transmissions at any given time. A UE monitors PDCCH on the one active DL BWP i.e., the UE does not have to monitor PDCCH on the entire DL frequency of the cell or on configured DL BWPs that are not active. A BWP inactivity timer (independent from the DRX inactivity timer) may be used for a UE to switch an active DL BWP to a default DL BWP when multiple DL BWPs are available for the UE. The UE restarts the BWP inactivity timer upon successful decoding of a DCI format and the change to the default DL BWP occurs when the timer expires as described in REF3.

Using Rel-15 NR and when a UE operates with DRX, the UE is not required to continuously monitor the PDCCH on the active BWP. DRX operation in RRC_CONNECTED mode (C-DRX) is based on the use of a configurable DRX cycle for the UE. When a DRX cycle is configured, the UE monitors PDCCH only during the active time. The UE does not need to monitor PDCCH and can switch off receiver circuitry during certain periods of the inactivity time. That operation reduces UE power consumption. The longer the DRX inactive time, the lower the UE power consumption but the larger the latency for scheduling the UE as the gNB scheduler can only reach the UE when the UE is active according to its DRX cycle. Typically, if the UE has been scheduled and is receiving or transmitting data, the UE is likely to be frequently scheduled and waiting until the next activity period according to the DRX cycle would result in additional delays. Therefore, to reduce or avoid such delays, the UE remains in the active state for a configurable time period after being scheduled. That is realized by a DRX inactivity timer that the UE starts every time the UE is scheduled, and the UE remains awake until the timer expires.

Using Rel-16 NR, a configuration of DRX related parameters for a second DRX group using parameter drx-ConfigSecondaryGroup-r16 can be supported. Serving cells in the secondary DRX group then belong to one frequency range (FR) and serving cells in the default DRX group belong to another FR. The network configures only drx-Inactivity Timer and drx-onDuration Timer as part of this configuration. The network therefore has the flexibility to control ‘on duration’ and ‘inactivity time’ per serving cell. When the second DRX group is configured, the drx-Inactivity Timer and drx-onDuration Timer values for the second DRX group are smaller than the respective values configured for the default DRX group in IE DRX-Config. When parameter drx-ConfigSecondaryGroup-r16 is configured, the gNB can indicate the serving cells that belong to the secondary group using the IE SCellConfig. If no indication is provided, an SCell belongs to the default DRX group.

Using Rel-15 NR and when carrier aggregation (CA) is configured, an activation/deactivation mechanism of cells is supported. When an SCell is deactivated, the UE does not need to receive the corresponding PDCCH or PDSCH, cannot transmit in the corresponding UL, nor is it required to perform CSI measurements. Conversely, when an SCell is active, the UE receives PDSCH and PDCCH (if the UE is configured to monitor PDCCH from this SCell) and the UE expected to be able to perform CSI measurements. The network ensures that while PUCCH SCell (a Secondary Cell configured with PUCCH) is deactivated, SCells of secondary PUCCH group (a group of SCells whose PUCCH signalling is associated with the PUCCH on the PUCCH SCell) should not be activated. The network ensures that SCells mapped to PUCCH SCell are deactivated before the PUCCH SCell is changed or removed. When reconfiguring the set of serving cells: SCells added to the set are initially activated or deactivated, and SCells which remain in the set (either unchanged or reconfigured) do not change their activation status (activated or deactivated). At handover or connection resume from RRC_INACTIVE, SCells are activated or deactivated. To enable reasonable UE battery consumption when BWP adaptation is configured, only one UL BWP for each UL carrier and one DL BWP or only one DL/UL BWP pair can be active at a time in an active serving cell, other BWPs that the UE is configured with being deactivated. On deactivated BWPs, the UE does not monitor the PDCCH, does not transmit on PUCCH, PRACH and uplink shared channel (UL-SCH).

Using Rel-16 NR in order to enable fast SCell activation when CA is configured, one dormant BWP can be configured for an SCell. If the active BWP of the activated SCell is a dormant BWP, the UE stops monitoring PDCCH and transmitting SRS/PUSCH/PUCCH on the SCell but continues performing CSI measurements, automatic gain control (AGC) and beam management, if configured. A DCI is used to control entering/leaving the dormant BWP for one or more SCell(s) or one or more SCell group(s). The dormant BWP is one of the UE's dedicated BWPs configured by network via dedicated RRC signalling. The SpCell and PUCCH SCell cannot be configured with a dormant BWP.

To enable fast SCell activation when CA is configured, aperiodic CSI-RS for tracking for fast SCell activation can be configured for an SCell to assist AGC and time/frequency synchronization. A MAC CE is used to trigger activation of one or more SCell(s) and trigger the aperiodic CSI-RS for tracking for fast SCell activation for a (set of) deactivated SCell(s).

Using Rel-16 NR, DCI formats 0_1 and 1_1 can be configured with an SCell dormancy indication field. The field can have a size of 0 bit if parameter dormancyGroupWithinActive Time is not configured, or 1, 2, 3, 4, or 5 bits bitmap determined according to the number of different DormancyGroupID(s) provided by parameter dormancyGroupWithinActive Time. Each bit in the bitmap corresponds to one of the SCell group(s) configured by parameter dormancyGroupWithinActive Time, with most significant bit (MSB) to least significant bit (LSB) of the bitmap corresponding to the first to last configured SCell group in ascending order of DormancyGroupID. The SCell dormancy indication field is only present when this format is carried by PDCCH on the primary cell within DRX Active Time and the UE is configured with at least two DL BWPs for an SCell. Detailed procedures for UE reception of a DCI format 0_1 or 1_1 including an SCell dormancy field or for UE reception of a DCI format 1_1, for example such as in conditional cases where bits of the frequency domain resource assignment field are equal to zero or are equal to one are further provided by REF3.

A UE is expected to provide HARQ-ACK information in response to a detection of a DCI format 1_1 indicating SCell dormancy after N symbols from the last symbol of a PDCCH providing the DCI format 1_1. If processing Type2Enabled of PDSCH-ServingCellConfig is set to enable for the serving cell with the PDCCH providing the DCI format 1_1 where further details on the number of symbols N are provided by REF3.

Using Rel-16 NR, DCI format 2_6 can contain an SCell dormancy indication, e.g., a bitmap of size 1-5 bits, if configured, in a block as further elaborated herein. Using Rel-18 NR, the SCell dormancy indication field can be configured in DCI formats 0_3 and 1_3.

Using Rel-16 and/or Rel-17 NR, the PDCCH monitoring activity of the UE can be further controlled by several additional features such as the UE power savings feature using DCI format 2_6 with cyclic redundancy check (CRC) scrambled by power saving radio network temporary identifier (PS-RNTI) (DCP), or such as the PDCCH monitoring adaptation feature based on PDCCH skipping and search space set group (SSSG) switching as described in REF3.

Rel-16 NR provides additional features to reduce UE power consumption for UE in RRC_CONNECTED mode such as DCI with CRC scrambled by PS-RNTI (DCP), cross-slot scheduling, or MIMO layer adaptation features. The UE may provide assistance information to the gNB (e.g., the gNB 102) to indicate its preferred radio or protocol configurations, such as its preferred C-DRX configuration, aggregated bandwidth, SCell configuration, MIMO configuration, configuration parameters for an RRC state, or minimum scheduling offset values, for a gNB or network (e.g., the network 130) to select a UE radio or UE protocol configuration.

Using Rel-16 NR, when a UE is configured to monitor PDCCH associated with a DCI format 2_6 with CRC scrambled by PS-RNTI (DCP), the UE may be indicated by the DCP whether the UE is required to monitor PDCCH on the PCell during a next occurrence of the on-duration of the UE's C-DRX cycle. If the UE does not detect a DCP on the active BWP prior to a next on-duration, the UE does not monitor PDCCH during the next on-duration unless the UE is explicitly indicated by the gNB via prior higher signaling to monitor PDCCH in that case. The DCP feature using DCI format 2_6 may also provide SCell dormancy indication in case the UE has activated SCells. A UE can only be configured to monitor DCP when DRX in RRC_CONNECTED mode (C-DRX) is configured, and at one or more monitoring occasions located at configured offsets before the DRX on-duration. The UE does not monitor DCP on occasions occurring during active time, measurement gaps, BWP switching, or when the UE monitors response for a contention-free random access (CFRA) preamble transmission for beam failure recovery. If a UE is not configured to monitor PDCCH for DCP, the UE follows normal DRX operation. When the UE operates with CA, the UE may monitor PDCCH for DCP only on the PCell. One DCP can control PDCCH monitoring during a DRX on-duration for one or more UEs independently.

For example, the UE may be configured by higher layers, i.e. RRC, with one or more parameters to adjust or control the UE monitoring behavior for reception of PDCCH associated with a DCI format 2_6:
ps-RNTI: the RNTI value for scrambling CRC of DCI format 2-6 used for power saving;
ps-Offset: the start of the search-time of DCI format 2-6 with CRC scrambled by PS-RNTI relative to the start of the drx-onDurationTimer of Long DRX and where a value is in multiples of 0.125 msec;
ps-WakeUp: indicates the UE to wake-up if DCI format 2-6 is not detected outside active time (if absent, the UE does not wake-up if DCI format 2-6 is not detected outside active time);
ps-PositionDCI-2-6: starting position of UE wakeup and SCell dormancy indication in DCI format 2-6;
ps-TransmitPeriodicLI-RSRP: indicates the UE to transmit periodic layer 1 reference signal received power (L1-RSRP) report(s) when the drx-onDurationTimer does not start (if absent, the UE does not transmit periodic L1-RSRP report(s) when the drx-onDurationTimer does not start); and/or
ps-TransmitOtherPeriodicCSI: indicates the UE to transmit periodic CSI report(s) other than L1-RSRP reports when the drx-onDurationTimer does not start (if absent, the UE does not transmit periodic CSI report(s) other than L1-RSRP reports when the drx-onDuration Timer does not start).

With reference to the Rel-16 NR procedures for monitoring DCI format 2_6 (DCP), a UE can be configured to monitor PDCCH on a primary cell outside active time for detection of a DCI format 2_6 and a location of a wake-up indication bit in the DCI format 2_6. A ‘0’ value for the wake-up indication bit, when reported to higher layers, indicates to not start the drx-onDuration Timer for the next long DRX cycle. A ‘I’ value for the wake-up indication bit, when reported to higher layers, indicates to start the drx-onDurationTimer for the next long DRX cycle. When the UE is configured search space sets to monitor PDCCH for detection of a DCI format 2_6 and the UE fails to detect the DCI format 2_6, the UE behavior for whether or not the UE starts the drx-onDurationTimer for the next DRX cycle on the primary cell can be configured by higher layers, i.e., to start the drx-onDuration Timer or to not start the drx-onDuration Timer. When a UE detects DCI format 2_6, the physical layer of a UE reports the value of the wake-up indication bit for the UE to higher layers for the next long DRX cycle; otherwise, it does not.

For example, the following information is transmitted by means of the DCI format 2_6 with CRC scrambled by PS-RNTI: block number 1, block number 2, . . . , block number N where the starting position of a block is determined by the parameter ps-PositionDCI-2-6 provided to the UE configured with the block by higher layers. If the UE is configured with higher layer parameter ps-RNTI and dci-Format2-6, one block is configured for the UE by higher layers, with the following fields defined for the block: a Wake-up indication field of length 1 bit and/or an SCell dormancy indication field of length 0 bit if higher layer parameter dormancyGroupOutside Active Time is not configured; otherwise 1, 2, 3, 4 or 5 bits bitmap determined according to the number of different DormancyGroupID) (s) provided by higher layer parameter dormancyGroupOutside Active Time, where each bit corresponds to one of the SCell group(s) configured by higher layers parameter dormancyGroupOutside Active Time, with MSB to LSB of the bitmap corresponding to the first to last configured SCell group in ascending order of DormancyGroupID). The size of DCI format 2_6 is indicated by the higher layer parameter sizeDCI-2-6 as described in REF3.

The UE can be provided with an offset by parameter ps-Offset indicating a time, where the UE starts monitoring PDCCH for detection of DCI format 2_6 according to the number of search space sets, prior to a slot where the drx-onDurationTimer would start on the PCell or on the SpCell. For each search space set, the PDCCH monitoring occasions are the ones in the first T's slots indicated by parameter duration, or Tₛ slots=1 slot if duration is not provided, starting from the first slot of the first Tₛ slots and ending prior to the start of drx-onDurationTimer. If a UE reports for an active DL BWP a MinTimeGap value that is X slots prior to the beginning of a slot where the UE would start the drx-onDuration Timer, the UE is not required to monitor PDCCH for detection of DCI format 2_6 during the X slots, where X corresponds to the MinTimeGap value of the SCS of the active DL BWP as described in REF3.

When the UE is configured in DCI format 2_6 a bitmap for corresponding groups of configured SCells, a ‘0’ value for a bit of the bitmap indicates an active DL BWP that is a dormant BWP for the UE for each activated SCell in the corresponding group of configured SCells. A ‘I’ value for a bit of the bitmap indicates an active (non-dormant) DL BWP for the UE for each activated SCell in the corresponding group of configured SCells, if a current active DL BWP is the dormant DL BWP, or a current active DL BWP for the UE for each activated SCell in the corresponding group of configured SCells if the current active DL BWP is not the dormant DL BWP. The UE does not monitor PDCCH in the dormant BWP of an SCell. The UE can also be indicated to change an active DL BWP to a dormant BWP or to a non-dormant BWP by a DCI format scheduling PDSCH reception on the primary cell as described in REF2 and REF3 and the corresponding descriptions are omitted in this disclosure for brevity. An active DL BWP of a UE on a primary cell is not indicated to change to a dormant BWP.

On PDCCH monitoring occasions associated with a same long DRX cycle, a UE does not expect to detect more than one DCI format 2_6 with different values of the wake-up indication bit for the UE or with different values of the bitmap for the UE. The UE does not monitor PDCCH for detecting DCI format 2_6 during active time.

Rel-17 NR provides additional features in support of reduced UE power consumption for UEs in RRC_IDLE/RRC_INACTIVE or in RRC_CONNECTED modes such as paging enhancements for UEs in RRC_IDLE/RRC INACTIVE modes, the provision of tracking reference signal (TRS)/CSI-RS occasions available in RRC_CONNECTED mode to UEs in RRC IDLE/RRC_INACTIVE modes, or PDCCH monitoring reduction features including SSSG switching or PDCCH skipping for UEs in RRC_CONNECTED mode, or relaxation of UE measurements for RLM and/or bidirectional forwarding detection (BFD) for UEs in RRC_CONNECTED mode.

Using Rel-15 NR and with reference to NR link recovery procedures, a UE can be provided, for each BWP of a serving cell, a set q̅₀ of periodic CSI-RS resource configuration indexes by failureDetectionResources and a set q̅₁ of periodic CSI-RS resource configuration indexes and/or SS/PBCH block indexes by candidateBeamRSList for radio link quality measurements on the BWP of the serving cell. If the UE is not provided failure DetectionResources, the UE determines the set q̅₀ to include periodic CSI-RS resource configuration indexes with same values as the RS indexes in the RS sets indicated by TCI-State for respective CORESETs that the UE uses for monitoring PDCCH and, if there are two RS indexes in a TCI state, the set q̅₀ includes RS indexes with QCL-TypeD configuration for the corresponding TCI states. The UE expects the set q̅₀ to include up to two RS indexes. The UE expects single port RS in the set q̅₀.

The thresholds Q_{out,LR} and Q_{in,LR} correspond to the default value of rlmInSyncOutOfSyncThreshold, as described in REF7 for Qₒᵤₜ, and to the value provided by rsrp-ThresholdSSB, respectively.

The physical layer in the UE assesses the radio link quality according to the set q̅₀ of resource configurations against the threshold Q_{out,LR}. For the set q̅₀, the UE assesses the radio link quality only according to periodic CSI-RS resource configurations or SS/PBCH blocks that are quasi co-located, as described in REF4, with the DM-RS of PDCCH receptions monitored by the UE. The UE applies the Q_{in,LR} threshold to the L1-RSRP measurement obtained from a SS/PBCH block. The UE applies the Q_{in,LR} threshold to the L1-RSRP measurement obtained for a CSI-RS resource after scaling a respective CSI-RS reception power with a value provided by powerControlOffsetSS.

In non-DRX mode operation, the physical layer in the UE provides an indication to higher layers when the radio link quality for corresponding resource configurations in the set q̅₀ that the UE uses to assess the radio link quality is worse than the threshold Q_{out,LR}. The physical layer informs the higher layers when the radio link quality is worse than the threshold Q_{out,LR} with a periodicity determined by the maximum between the shortest periodicity among the periodic CSI-RS configurations and/or SS/PBCH blocks in the set q̅₀ that the UE uses to assess the radio link quality and 2 msec. In DRX mode operation, the physical layer provides an indication to higher layers when the radio link quality is worse than the threshold Q_{out,LR} with a periodicity determined as described in REF7.

Upon request from higher layers, the UE provides to higher layers the periodic CSI-RS configuration indexes and/or SS/PBCH block indexes from the set q̅₁ and the corresponding L1-RSRP measurements that are larger than or equal to the Q_{in,LR} threshold.

A UE can be provided a CORESET through a link to a search space set provided by recoverySearchSpaceId, as described in REF3, for monitoring PDCCH in the CORESET. If the UE is provided recoverySearchSpaceId, the UE does not expect to be provided another search space set for monitoring PDCCH in the CORESET associated with the search space set provided by recoverySearchSpaceId.

The UE may receive by PRACH-ResourceDedicatedBER, a configuration for PRACH transmission as described in REF3. For PRACH transmission in slot n and according to antenna port quasi co-location parameters associated with periodic CSI-RS resource configuration or with SS/PBCH block associated with index q_{new} provided by higher layers, e.g., described in REF5, the UE monitors PDCCH in a search space set provided by recoverySearchSpaceId for detection of a DCI format with CRC scrambled by cell RNTI (C-RNTI) or modulation and coding scheme C-RNTI (MCS-C-RNTI) starting from slot n+4 within a window configured by BeamFailureRecoveryConfig. For PDCCH monitoring in a search space set provided by recoverySearchSpaceId and for corresponding PDSCH reception, the UE expects the same antenna port quasi-collocation parameters as the ones associated with index q_{new} until the UE receives by higher layers an activation for a TCI state or any of the parameters tci-StatesPDCCH-ToAddList and/or tci-StatesPDCCH-ToReleaseList. After the UE detects a DCI format with CRC scrambled by C-RNTI or MCS-C-RNTI in the search space set provided by recoverySearchSpaceId, the UE continues to monitor PDCCH candidates in the search space set provided by recoverySearchSpaceId until the UE receives a MAC CE activation command for a TCI state or tci-StatesPD (CH-ToAddList and/or tci-StatesPDCCH-ToReleaseList.

After 28 symbols from a last symbol of a first PDCCH reception in a search space set provided by recoverySearchSpaceId for which the UE detects a DCI format with CRC scrambled by C-RNTI or MCS-C-RNTI and until the UE receives an activation command for PUCCH-SpatialRelationInfo as described in REF5 or is provided PUCCH-SpatialRelationInfo for PUCCH resource(s), the UE transmits a PUCCH on a same cell as the PRACH transmission using a same spatial filter as for the last PRACH transmission, and/or a power determined as described in REF3 with qᵤ=0, q_{d}=q_{new}, and l=0.

After 28 symbols from a last symbol of a first PDCCH reception in a search space set provided by recoverySearchSpaceId where a UE detects a DCI format with CRC scrambled by C-RNTI or MCS-C-RNTI, the UE expects same antenna port quasi-collocation parameters as the ones associated with index q_{new} for PDCCH monitoring in a CORESET with index 0.

Further details with respect to link recovery procedures according to features such as multi-TRP operation in later NR releases are defined in REF3.

In the following and throughout the disclosure, various embodiments of the disclosure may be also implemented in any type of UE including, for example, UEs with the same, similar, or more capabilities compared to typical 5G NR UEs. Although various embodiments of the disclosure discuss 3GPP 5G NR communication systems, the embodiments may apply in general to UEs operating with other RATs and/or standards, such as next releases/generations of 3GPP, IEEE Wi-Fi, and so on.

The term ‘activation’ describes an operation wherein a UE receives and decodes a signal from the network (or gNB) that signifies a starting point in time. The starting point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal. The term “deactivation” describes an operation wherein a UE receives and decodes a signal from the network (or gNB) that signifies a stopping point in time. The stopping point can be a present or a future slot/subframe or symbol and the exact location is either implicitly or explicitly indicated, or is otherwise specified in the system operation or is configured by higher layers. Upon successfully decoding the signal, the UE (e.g., the UE 116) responds according to an indication provided by the signal.

In the following, unless otherwise explicitly noted, providing a parameter value by higher layers includes providing the parameter value by a system information block (SIB), such as a SIB1, or by a common RRC signaling, or by UE-specific RRC signaling.

In the following, the suffix ‘-rxx’ is used to denote a parameter that does not currently exist in specifications and can be introduced to support the disclosed functionalities, with ‘xx’ denoting a number of a 3GPP release for the introduction of the parameter, e.g., xx=19 for Rel-19, or xx=20 for Rel-20, etc.

In the following, for brevity of description, the higher layer provided TDD UL-DL frame configuration refers to tdd-UL-DL-ConfigurationCommon as example for RRC common configuration and/or tdd-UL-DI-ConfigurationDedicated as example for UE-specific configuration. The UE determines a common TDD UL-DL frame configuration of a serving cell by receiving a SIB such as a SIB1 when accessing the cell from RRC_IDLE or by RRC signaling when the UE is configured with an SCell or additional secondary cell groups (SCGs) by an IE ServingCellConfigCommon in RRC_CONNECTED. The UE determines a dedicated TDD UL-DL frame configuration using the IE ServingCellConfig when the UE is configured with a serving cell, e.g., add or modify, where the serving cell may be the SpCell or an SCell of a master cell group (MCG) or secondary cell group (SCG). A TDD UL-DL frame configuration designates a slot or symbol as one of types ‘D’, ‘U’ or ‘F’ using at least one time-domain pattern with configurable periodicity.

In the following, for brevity of description, slot format indication (SFI) refers to a slot format indicator as example that is indicated using higher layer provided IEs such as slotFormatCombination or slotFormatCombinationsPerCell and which is indicated to the UE by group common DCI format such as DCI F2_0 where slotFormats are defined in REF3.

Terminology such as TCI, TCI states, SpatialRelationInfo, target RS, reference RS, and other terms is used for illustrative purposes and is therefore not normative. Other terms that refer to same functions can also be used. A “reference RS” corresponds to a set of characteristics of a DL RX beam or an UL TX beam, such as a direction, a precoding/beamforming, a number of ports, and so on. A beam may also be referred to as spatial filter or spatial setting and be associated with a TCI state for quasi co-location (QCL) properties.

In certain embodiments, a UE may be provided with an SBFD configuration based on a parameter sbfd-config to determine receptions and/or transmissions on a serving cell supporting full-duplex operation. For example, the UE may be provided with a set of RBs or a set of symbols for an SBFD UL or DL subband on a symbol or in a slot based on sbfd-config. For example, the UE may be provided with a set of symbols or slots for an SBFD subband based on sbfd-config. An SBFD configuration may be provided by higher layers, e.g., RRC, or may be indicated based on DCI and/or MAC-CE signaling. A combination of SBFD configuration based on higher layer parameters such as sbfd-config and indication through DCI and/or MAC-CE signaling may also be used. The UE may determine an SBFD configuration for a symbol or a slot or a set of symbols or a set of slots using higher layer parameters provided for an SBFD configuration and based on reception or transmission conditions such as a slot type ‘D’, ‘U’, or ‘F’. In one example, the SBFD configuration and/or parameters associated with the SBFD configuration are same for TRPs. In one example, the SBFD configuration and/or parameters associated with the SBFD configuration can be TRP specific following the aforementioned configuration examples.

For example, an SBFD configuration may provide a set of time-domain resources, e.g., symbols/slots, where receptions or transmissions by the UE are allowed, possible, or disallowed. An SBFD configuration may provide a range or a set of frequency-domain resources, e.g., serving cell, BWP, start and/or end or a set of RBs, where receptions or transmissions by the UE are allowed, possible, or disallowed. An SBFD configuration may provide one or multiple guard intervals or guard RBs for time and/or frequency domain radio resources during receptions or transmissions by the UE, e.g., guard SCs or RBs, guard symbols. An SBFD configuration may be provided based on one or multiple resource types such as ‘non-SBFD symbol’ or ‘SBFD symbol’, or ‘simultaneous Tx-Rx’, ‘Rx only’, ‘Tx only’ or ‘D’, ‘U’, ‘F’, ‘N/A’. An SBFD configuration may be associated with one or multiple scheduling behaviors, e.g., for “dynamic grant”, for “configured grant”, for “any”. An SBFD configuration and/or parameters associated an SBFD configuration may include indications or values to determine Tx power settings of receptions by the UE, such as, reference power, energy per resource element (EPRE), or power offset of a designated channel/or signal type transmitted by a serving gNB, or to determine the power and/or spatial settings for transmissions by the UE.

For example, a UE may be provided with an SBFD configuration to determine receptions and/or transmissions on a serving cell supporting full-duplex operation. For example, the UE may be provided with a set of RBs or a set of symbols for an SBFD UL or DL subband on a symbol or in a slot (frequency domain resources). For example, the UE may be provided with a set of symbols or slots for an SBFD subband (time domain resources). In one example, the SBFD configuration applies to TRPs in the cell. In one example, the SBFD configurations are separately provided for each TRP in the cell. In one example, a common SBFD configuration is provided for a cell and an additional delta configuration is separately provided for each TRP in the cell, wherein the delta configuration can include additional frequency/time domain resources to be added to the common configuration and/or excluded frequency/time domain resources to be excluded from the common configuration. In one example, the SBFD configurations are separately provided for each TRP in the cell. In one example, a common SBFD configuration is provided for a first TRP of the cell and an additional delta configuration is provided for each other TRP in the cell, wherein the delta configuration can include additional frequency/time domain resources to be added to the common configuration and/or excluded frequency/time domain resources to be excluded from the common configuration.

For example, an SBFD configuration and/or parameters associated with SBFD configuration based on sbfd-config may be provided by higher layer, e.g., RRC, or may be indicated based on DCI and/or MAC-CE signaling. A combination of SBFD configuration and/or parameterization based on higher layer parameters and indication through DCI and/or MAC-CE signaling may be used. The UE may determine an SBFD configuration for a symbol or a slot or a set of symbols or a set of slots using higher layer parameters provided for an SBFD configuration and based on reception or transmission conditions such as for a slot or symbol type ‘D’, ‘U’, or ‘F or a slot or a symbol type ‘SBFD’ or ‘non-SBFD’ or for an SBFD subband type such as ‘SBFD DL subband’, ‘SBFD UL subband’, or ‘SBFD Flexible subband’.

For example, an SBFD configuration may provide a set of time-domain resources, e.g., symbols/slots, where receptions or transmissions by the UE are allowed, possible, or disallowed. In one example, the time-domain resources are same (e.g., common) for TRPs as aforementioned. In another example, the time-domain resources can be different for each TRP, as aforementioned. An SBFD configuration may provide a range or a set of frequency-domain resources, e.g., serving cell, BWP, start and/or end or a set of RBs, where receptions or transmissions by the UE are allowed, possible, or disallowed. In one example, the frequency-domain resources are same (e.g., common) to TRPs as aforementioned. In another example, the frequency-domain resources can be different for each TRP, as aforementioned. An SBFD configuration may provide one or multiple guard intervals or guard RBs for time and/or frequency domain radio resources during receptions or transmissions by the UE, e.g., guard SCs or RBs, guard symbols, wherein the provided SBFD configuration may be same or different for each TRP as aforementioned. An SBFD configuration may be provided based on one or multiple resource types such as non-SBFD symbol’ or ‘SBFD symbol’, or ‘simultaneous Tx-Rx’, ‘Rx only’, ‘Tx only’ or ‘D’, ‘U’, ‘F’, ‘N/A’. In one example, SBFD configuration is performed at a slot level. In one example, SBFD configuration is performed at a symbol level. In one example, SBFD configuration is performed at a slot level and symbol level. In one example, An SBFD configuration may be associated with one or multiple scheduling behaviors, e.g., for “dynamic grant”, for “configured grant”, for “any”. An SBFD configuration and/or parameters associated with an SBFD configuration may include indications or values to determine Tx power settings of receptions by the UE, such as, reference power, energy per resource element (EPRE), or power offset of a designated channel/or signal type transmitted by a serving gNB; to determine the power and/or spatial settings for transmissions by the UE.

For example, an SBFD configuration and/or parameters associated with the SBFD configuration may be provided to the UE by means of common RRC signaling using SIB, or be provided by UE-dedicated RRC signaling such as ServingCellConfig. For example, an SBFD configuration and/or parameters associated with the SBFD configuration may be provided to the UE using an RRC-configured time domain resource allocation (TDRA) table, or a PDCCH, PDSCH, PUCCH or PUSCH configuration, and/or DCI-based signaling that can indicate to the UE a configuration or allow the UE to determine an SBFD configuration on a symbol or slot.

For example, the UE may be provided with information for an SBFD subband configuration such as an SBFD UL subband in one or more SBFD symbols by higher layer signaling. For example, a frequency-domain location and a size or a frequency-domain occupancy of the SBFD subband may be provided to the UE by means of indicating or assigning a start RB and an allocation bandwidth, or based on a resource indicator value (RIV), or a number of RBs, or a bitmap. An SBFD subband configuration may be provided to the UE with respect to a common resource block (CRB) grid. An SBFD subband configuration may be provided to the UE with respect to a UE BWP configuration, e.g., excluding resource blocks (RBs) in an NR carrier BW that are not within a configured or an active UE BWP. An SBFD subband configuration may be provided based on a reference RB and/or based on a reference SCS. The UE may be provided with information for an SBFD subband configuration such as an SBFD DL subband in an SBFD slot or symbol by higher layer signaling. For example, a frequency-domain location and a size or a frequency-domain occupancy of an SBFD DL subband may be provided to the UE by means of indicating or assigning a start RB and an allocation bandwidth, or an RIV value, or a number of RBs, or a bitmap, separately from a configuration provided to the UE for an SBFD UL subband. An SBFD DL subband configuration may be provided to the UE with respect to a CRB grid, or with respect to a UE BWP configuration. An SBFD DL subband configuration may be provided based on an indicated reference RB and/or based on a reference SCS. There may be multiple SBFD DL subband configurations in an SBFD symbol or slot. If multiple SBFD DL subband configurations are provided for an SBFD symbol or slot, the SBFD DL subbands may be non-contiguous. For example, two SBFD DL subband configurations may be provided to the UE for an SBFD symbol by higher layers. A same SBFD DL subband configuration or a same SBFD UL subband configuration may be provided for multiple symbols or slots, or different symbols or slots may be indicated or assigned separate SBFD DL subband and/or SBFD UL subband configurations, respectively.

For example, an SBFD configuration and/or parameters associated with the SBFD configuration for sbfd-config may be provided to the UE using tdd-(II.-DL-ConfigurationCommon as example for RRC common configuration and/or tdd-(II.-DL-ConfigurationDedicated as example for UE-specific configuration. The UE may determine an SBFD configuration based on a common TDD UL-DL frame configuration of a serving cell by receiving a SIB such as a SIB1 when accessing the cell from RRC_IDLE/INACTIVE or by RRC signaling when the UE is configured with an SCell or additional SCGs by an IE ServingCellConfigCommon in RRC CONNECTED. The UE may determine an SBFD configuration based on a dedicated TDD UL-DL frame configuration using the IE ServingCellConfig when the UE is configured with a serving cell, e.g., add or modify, where the serving cell may be the SpCell or an SCell of an MCG or SCG. A TDD UL-DL frame configuration can designate a slot or symbol as one of types ‘D’, ‘U’ or ‘F’ using at least one time-domain pattern with configurable periodicity.

In certain embodiments, a TCI state may be used for beam indication. A TCI state may refer to a DL TCI state for DL channels, e.g. PDCCH or PDSCH, an UL TCI state for UL channels, e.g. PUSCH or PUCCH, a joint TCI state for DL and UL channels, or separate TCI states for UL and DL channels or signals. A TCI state may be common across multiple component carriers or may be a separate TCI state for a component carrier of a set of component carriers. A TCI state may be gNB or UE panel specific or common across panels. In some examples, an UL TCI state may be replaced by an SRS resource indicator (SRI).

In certain embodiments, a cell may include more than one transmission/reception point (TRP). For example, mTRP operation may be referred to as intra-cell mTRP operation. In one example, a TRP may be identified by a CORESETPoolIndex associated with CORESETs for PDCCH receptions. In one example, a TRP may be identified by a group (e.g., one or more) SS/PBCH blocks (SSBs). For example, a first group or set of SSBs belong to or determine or identify a first TRP, a second group or set of SSBs belong to or determine or identify a second TRP, and so on. In one example, a TRP may be identified by a group (e.g., one or more) channel state information reference signal (CSI-RS) resources or CSI-RS resource sets. For example, a first group or set of CSI-RS resources or CSI-RS resource sets belong to or determine or identify a first TRP, a second group or set of CSI-RS resources or CSI-RS resource sets belong to determine or identify a second TRP, and so on. In one example, a TRP may be identified by a group (e.g., one or more) antenna ports. For example, a first group or set of antenna ports belong to or determine or identify a first TRP, a second group or set of antenna ports belong to determine or identify a second TRP, and so on. In one example, a TRP is identified or determined following one or more of the previous examples. In one example, a TRP may be identified by a group (e.g., one or more) sounding reference signal (SRS) resources or SRS resource sets. For example, a first group or set of SRS resources or SRS resource sets belong to or determine or identify a first TRP, a second group or set of SRS resources or SRS resource sets belong to or determine or identify a second TRP, and so on. In one example, a TRP may be identified by a group (e.g., one or more) TCI states (UL TCI states or DL TCI states or Joint TCI states or TCI state codepoints). For example, a first group or set of TCI states belong to or determine or identify a first TRP, a second group or set of TCI states belong to or determine or identify a second TRP, and so on.

FIG. 12 illustrates a timeline 1200 for FR1-FRI inter-band CA configuration according to embodiments of the present disclosure. For example, timeline 1200 for FR1-FR1 inter-band CA configuration can be followed by the UE 111 and the gNB 102 and/or network 130 in the wireless network 100 of FIG. 1. This example is for illustration only and other embodiments can be used without departing from the scope of the present disclosure.

When evaluating UE procedures for bandwidth part operation, discontinuous reception, receiving control information, and, more specifically, to UE procedures for enabling adaptation to monitoring of physical downlink control channels (PDCCHs) via indication of dormancy/non-dormancy for SCells in a full-duplex wireless system, several issues related to limitations and drawbacks of existing technology need to be overcome.

It needs to be evaluated that when gNB-side SBFD operation is supported in a TDD cell in an NR band, the TDD cell can be configured for a UE in NR intra-band carrier aggregation (CA), NR inter-band CA, FR1-FR2 CA, LTE-NR dual-connectivity (EN-DC), or NR-NR dual-connectivity (NR-DC). For operational backwards compatibility reasons, the NR TDD cell with gNB-side SBFD support should then be able to efficiently operate as PCell, SCell or SpCell for a typical UE or for an SBFD-aware UE. For example, the introduction of gNB-side SBFD support in selected network (e.g., the network 130) region for a given NR band should not affect the existing operator deployment expectations with respect to standalone (SA) or non-standalone (NSA) mode operation, or the availability of band-specific CA or DC features for an existing expected user base, or should not result in the need to separate or operate the typical and the SBFD-aware UEs using different frequency layers, respectively. Therefore, embodiments of the present disclosure recognize that it is necessary to evaluate the potential use, impact, limitations or benefits of SBFD operation in a TDD cell with SBFD support when the cell is configured as PCell, SCell or SpCell for CA or for DC for a UE.

With reference to FIG. 12, an example FRI-FRI inter-band CA configuration including a TDD cell with SBFD support is shown. For example, a mid-band NR TDD cell with SBFD support may be configured as an SCell. Some example deployment cases are NR band combinations n3+n78 or n41+n78. For example, an n78 (3.5 GHZ) NR TDD cell with SBFD support may use a 100 MHz NR channel BW. For example, an n3 (1.7 GHZ) NR FDD carrier or an n41 (2.5 GHZ) NR TDD carrier may provide the coverage layer and may be configured as the PCell. Note that simultaneous Tx/Rx capability is mandated for the UE for n3+n78, but not for n41+n78. The PCell and the NR TDD SCell with SBFD support may be located in different bands, respectively. For example, the SCell with SBFD support may carry a DL or UL data/control channel/signal. For example, the use of the FR1-FRI inter-band CA feature may increase the DL or UL peak or aggregate cell throughput or spectral efficiency, or may improve coverage. For example, a DL throughput or spectral efficiency for DL MIMO operation on the upper mid-band TDD SCell can be improved when a larger CSI payload can be transmitted in the UL on the lower mid-band TDD PCell or in the UL on the low-band FDD PCell if a higher UL signal-to-interference-plus-noise ratio (SINR) is available. For example, a TDD SCell with SBFD support may be configured as an SCell in a dormancy group to support a UE power-saving feature. A same TDD SCell with SBFD support may be configured in multiple dormancy groups.

A first issue relates to UE modem design complexity and increased UE power consumption for supporting receptions in a non-contiguous receive bandwidth in the SBFD subbands of an SCell with SBFD support when the Dormancy feature is enabled.

For example, when an SBFD configuration of type ‘DUD’ is provided to the UE for the SCell with SBFD support, the UE can set the RF receive processing to the size of active DL BWP but may then process the non-contiguous SBFD DL subband 1 and 2, respectively, using two separate ADC/FFT processes, or using two separate channel estimation processes, e.g., separate per SBFD DL subband. For a same size of the active DL BWP, this may increase the UE power consumption and result in a higher UE modem complexity when the SBFD-aware UE simultaneously receives the two non-contiguous SBFD DL subbands when compared to the processing of a single contiguous reception bandwidth on a symbol in the active DL BWP by a typical UE.

A second issue relates to the UE demodulation performance and decreased radio range for supporting receptions in a non-contiguous receive bandwidth in the SBFD subbands of an SCell with SBFD support when the Dormancy feature is enabled.

It should be regarded that a minimum performance requirement for reception of DL channels/signals, e.g., reference sensitivity power level (REFSENS) on a PCell or SCell with SBFD support for two non-contiguous SBFD DL subbands may be worse when compared to reception of a single contiguous reception bandwidth by a typical UE. The DL link budget, e.g., DL coverage or DL radio range, is then reduced correspondingly. This is due to the account for the additional presence and locations in frequency-domain of inter-modulation products affecting the UE receiver processing performance during simultaneous reception of two non-contiguous SBFD DL subbands, e.g., similar to cases such as LTE or NR intra-band non-contiguous carrier aggregation with 2 component carriers using a wideband UE receiver architecture. In addition, when the SCell with SBFD support is used for UL transmissions in the SBFD UL subband of an SBFD slot by other UEs, inter-subband inter-UE cross-link interference resulting from UL transmissions may further affect the DL reception performance of the UE under evaluation. For example, when receive filtering in the baseband is used by the UE to improve the inter-subband selectivity during DL reception of the active DL BWP on the SCell, it can be expected that the filtering implementation is less complex and can achieve better out-of-subband rejection when only a single SBFD DL subband needs to be filtered as passband. This can further improve the DL link budget and improve the radio range during SCell reception by the UE.

A third issue relates to different received SINR conditions, or different QCL expectations, in non-SBFD slots/symbols and in SBFD slots/symbols, respectively, or in different SBFD subbands of an SCell with SBFD support.

It needs to be taken into account that for transmissions by a gNB (e.g., the gNB 102) using one or more TRPs on a cell in a full-duplex system, a different number of transmitter/receiver antennas, a different effective transmitter antenna aperture area, and/or different transmitter antenna directivity settings may be available for transmissions in a DL slot or symbol, i.e., non-SBFD slot or symbol, when compared to transmissions in a SBFD slot or symbol. Similar regards may apply to gNB or TRP receptions in a normal UL slot or symbol when compared to gNB or TRP receptions in the UL subband of a SBFD slot. For example, the EPRE settings for transmissions by a gNB using one or more TRPs on a cell in a SBFD slot or symbol with full-duplex operation may be constrained to prevent TRP-side receiver AGC blocking and to enable effective implementation of serial interference cancellation (SIC) during TRP receptions in the UL subband of the SBFD slot or symbol when comparted to the EPRE settings of TRP transmissions in the normal DL slot. Therefore, the TRP transmission power budget and, correspondingly, the received signal strength available for the UE receiver, may not be same for a signal/channel being transmitted by the TRP on a non-SBFD slot/symbol when compared to transmission by the TRP of a same signal/channel on an SBFD slot/symbol. Similar observations hold when full-duplex transmission and reception by a gNB on a cell based on multiple antenna panels from one or more TRPs is implemented. For example, QCL and transmit timing may vary between different panels of a TRP or among different TRPs. The transmissions or receptions on a cell from/by a TRP may be subjected to different link gains depending on the antenna panel used in a transmission or reception instance. Transmissions to or receptions from a same UE using different TRPs may be subjected to different link gains depending on the TRP for a transmission or reception instance. Similar observations hold for transmissions or receptions using different SBFD subbands where different link conditions may result with respect to a same UE scheduled from the gNB or across TRPs. For example, the available DL Tx power budget at a TRP for transmissions on a cell may be more restricted in an SBFD subband when compared to another SBFD subband of the TRP. For example, a TRX configuration or an SBFD antenna configuration or an EPRE limitation(s) arising from the frequency-domain placement of the SBFD subband in the NR carrier bandwidth to ensure sufficient adjacent channel protection may be different for different TRPs.

Furthermore, interference levels experienced by the UE receiver may differ between receptions in a normal DL slot or symbol and receptions in a SBFD slot or symbol. For example, the UE receiver during receptions in a normal DL slot may be interfered by co-channel transmissions from TRPs in neighboring cells. The UE receiver during receptions in an SBFD slot or symbol may be subjected to UE-to-UE inter-subband co-channel and/or UE-to-UE adjacent channel cross-link interference (CLI) stemming from UL-to-DL transmissions in the SBFD slot or symbol. Therefore, the resulting interference power levels and their variation experienced by the UE receiver may not be same for reception of a signal/channel on non-SBFD slot/symbol when compared to reception of the signal/channel on an SBFD slot/symbol. Similar observations hold for transmissions or receptions using different SBFD subbands where different interference levels may result with respect to a same UE scheduled from one or more TRPs of a cell. For example, adjacent channel interference may affect a first SBFD DL subband in the upper part of the NR channel bandwidth more than a second SBFD DL subband in the lower part of the NR channel bandwidth. For example, UE-to-UE inter-subband co-channel interference may not be symmetric with respect to the UE actual transmission bandwidth of the aggressor UE, i.e., it can depend on the active UL BWP, the PUSCH transmission bandwidth allocation, or the UE Tx filtering. In presence of intra-cell or inter-cell TRP operation, larger variations may be expected due to non-co-location of the TRPs.

Due to the different received SINR conditions and QCL expectations for the SBFD subbands or for non-SBFD slots/symbols and in SBFD slots/symbols, respectively, of the SCell with SBFD support, it would be beneficial for a UE (e.g., the UE 116) to be separately indicated for receptions on an SBFD subband or for receptions non-SBFD slots/symbols and for SBFD slots/symbols, respectively. Note that in general, due to the different received SINR conditions and the different rate of variability in received SINR conditions at the UE in the SBFD subbands, or in SBFD slots/symbols and non-SBFD slots/symbols, respectively, it is beneficial to enable separate parameterization and UE reception behavior. Such separate adaptation can increase radio link robustness and/or reduce power consumption. For example, UE power-savings increase as a as a number of consecutive SBFD slots/symbols increases as the UE can then make use of a longer “sleep” duration in the UE modem implementation and shut-down UE receive components. For example, link robustness can be increased when AGC is performed based an indicated SBFD subband or when beam monitoring procedures are separately performed for non-SBFD/SBFD slots, respectively. In another example, link robustness can be increased when AGC is performed based an indicated SBFD subband or when beam monitoring procedures are separately performed for non-SBFD/SBFD slots, respectively. Separate indication for SCell receptions on an SBFD subband or for receptions non-SBFD slots/symbols and for SBFD slots/symbols, respectively, then also require efficient support, e.g., per slot/symbol type or for an SBFD subband type, for beam management procedures on the SCell and for CSI reporting by the UE for the SCell to support fast activation. For example, beam management including radio link quality monitoring or evaluation for beam failure detection and recovery can result in increased link robustness when enabled for a slot/symbol type or for an SBFD subband type of an SCell with SBFD support to be representative of the different SINR conditions or QCL expectations on the SCell.

Therefore, there is a need to provide procedures for supporting selective indication for reception of an active DL BWP on an SCell using the Dormancy feature for an SBFD subband, or for non-SBFD slots/symbols, or for SBFD slots/symbols.

Aspects of the disclosure provide:
SCell dormancy indication for SBFD subband or for non-SBFD/SBFD symbol/slot where the SCell dormancy indication field/block in DCI format 0_1/0_3/1_1/1_3 within DRX Active Time or a DCI format 2_6 outside DRX Active Time can indicate UE if the UE should receive in a selected SBFD subband or on a selected slot/symbol type in the active DL BWP of an SCell of the dormancy group.
Dormancy indication field/block design for SBFD subband or non-SBFD/SBFD slot where the design/signaling of SCell dormancy indication field in DCI format 0_1/0_3/1_1/1_3 within DRX Active Time or in a block of DCI format 2_6 outside DRX Active Time based on a typical field/block format with a new higher-layer parameter, or a new field/block format with a new higher-layer parameter, or based on a typical and a new field/block format.
Dormancy indication is associated/linked with an SBFD configuration of SCell where SCell dormancy indication in DCI format 0_1/0_3/1_1/1_3 within DRX Active Time or a DCI format 2_6 outside DRX Active Time can indicate an SBFD configuration associated with an SCell of the dormancy group to the UE.
Dormancy indication for SBFD subband or for non-SBFD/SBFD slots on PCell, where a dormancy indication in DCI format 0_1/0_3/1_1/1_3 within DRX Active Time or a DCI format 2_6 outside DRX Active Time can indicate to the UE if the UE should receive in a selected SBFD subband or on a selected slot/symbol type in the active DL BWP of the PCell. Dormant SBFD subband.

When evaluating UE procedures for beam management of SCells via beam failure detection, beam failure recovery, or link recovery in a full-duplex (FD) wireless system, several issues related to limitations and drawbacks of existing technology need to be overcome.

A fourth issue relates to different received SINR conditions, or different QCL expectations, in non-SBFD slots/symbols and in SBFD slots/symbols, respectively, or in different SBFD subbands of an SCell with SBFD support. An evaluation of DL radio link quality for radio link monitoring or link recovery using provided or determined RS resources or RS resource indices on a non-full-duplex slot or symbol may not be representative of the DL radio link quality evaluated using provided or determined RS resources or RS resource indices on a full-duplex slot or symbol by the UE. Similar evaluations can apply to an evaluation of DL radio link quality on different SBFD subbands. Similar evaluations, e.g., different SINR conditions or different QCL expectations on different symbol types or SBFD subband types, can apply to CSI reporting by the SBFD-aware UE for an SCell configured with the dormancy feature.

Therefore, there is a need to provide procedures for supporting selective indication for reception of an active DL BWP on an SCell using a carrier aggregation or a dual-connectivity feature for an SBFD subband, or for non-SBFD slots/symbols, or for SBFD slots/symbols. Therefore, there is a need to enable selective radio link quality monitoring or link recovery procedures on an SCell with SBFD support.

Aspects of the disclosure are as follows:
Separate link recovery procedures for non-SBFD/SBFD slots/symbols or SBFD subbands on SBFD SCell where the UE can be configured or the UE can determine to use separate beam failure detection and/or separate beam failure recovery procedures on an SCell with SBFD support. Separate beam failure detection and/or separate beam failure recovery procedures can apply with respect to a selected slot/symbol type or a selected SBFD subband of an SBFD SCell.
Separate sets of link recovery RS for evaluation of Q_{in,LR} and Q_{out,LR} on SBFD SCell where the UE is provided by higher layers or the UE determines separate (link) failure detection (resource) sets for non-SBFD slots/symbols and SBFD slots/symbols, respectively, or for different SBFD subbands, respectively. The UE evaluates thresholds Q_{in,LR} and Q_{out,LR}, and indicates/reports to higher layers, separately.
Separate parameterization and offset/adjustment where the sets of RS resources or RS resource indices associated with a first RS group for link failure detection and a second group for link failure detection are associated with separate parameters for rlmInSyncOutOfSync Threshold, or rsrp-ThresholdSSB or rsrp-ThresholdBFR. Separate evaluation periods for first RS group and second RS group, respectively, for link failure detection. Q_{in,LR} and Q_{out,LR}, respectively, for evaluation of radio link quality of second RS group can be determined from measurement in first RS group based on adjustment or offset value.

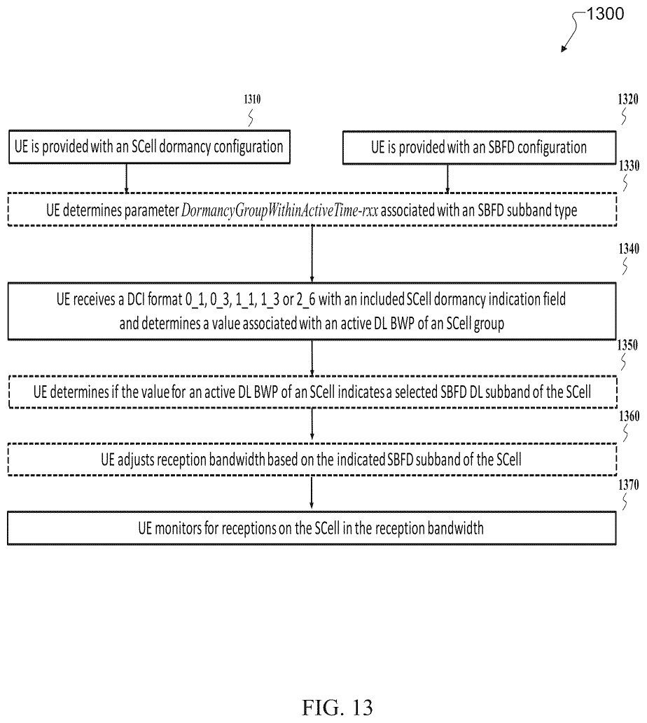

FIG. 13 illustrates a flowchart of an example UE procedure 1300 for an example SCell dormancy indication according to embodiments of the present disclosure. For example, procedure 1300 for an example SCell dormancy indication can be followed by any of the UEs 111-116 of FIG. 1, such as the UE 111. This example is for illustration only and other embodiments can be used without departing from the scope of the present disclosure.

The procedure begins in 1310, the UE is provided with an SCell dormancy configuration. In 1320, the UE is provided with an SBFD configuration. In 1330, the UE determines a parameter DormancyGroupWithinActive Time-rxx associated with an SBFD configuration for an SCell. In 1340, the UE receives a DCI format 0_1/0_3/1_1/1_3 or 2_6 that provides an SCell dormancy indication in a field/block and determines a value associated with an SCell group. In 1350, the UE determines if the value indicates reception on a selected SBFD DL subband of the SCell. In 1360, if the UE determines that reception for a selected SBFD subband is indicated by the value, the UE may adjust a UE receiver setting based on the indicated SBFD subband. In 1370, the UE then monitors for receptions on the SCell based on the indicated SBFD subband.

The SCell dormancy indication carried by PDCCH on the primary cell such as a DCI format 0_1/0_3/1_1/1_3 within DRX Active Time or a DCI format 2_6 outside DRX Active Time provides information to the UE if the UE should receive in a selected SBFD subband or on a selected slot/symbol type in the active DL BWP of an SCell of the dormancy group.

In one embodiment, a UE is provided by higher layers from a serving gNB a new parameter, for example DormancyGroupWithinActive Time-rxx, for reception of a SCell dormancy indication that selectively enables or disables reception of an active DL BWP for an SBFD subband type or a slot/symbol type. For example, an SBFD subband type may correspond to an SBFD DL subband, an SBFD UL subband, or an SBFD flexible subband. For example, a slot/symbol type may correspond to ‘SBFD’ or ‘non-SBFD’, or may correspond to ‘D’ or ‘F’ or ‘U’.

For example, DormancyGroupWithinActive Time-rxx can be associated with a set or a combination of SBFD subbands or subband types such as ‘SBFD DL subband 1 and 2’ or ‘SBFD DL and flexible subband’ or a set or a combination of symbol/slot types such as ‘D and F’ with respect to receptions in an active DL BWP from the gNB or a TRP. In one example, an active BWP may be provided by BWP-Id. In one example an active DL BWP may be provided by dormantBWP-Id. In one example, an active DL BWP may be provided by firstWithinActiveTimeBWP-Id.

For example, when UE receives the SCell dormancy indication selecting an SBFD subband type or a slot/symbol type for receptions in the current active DL BWP or in an active DL BWP provided by firstWithinActiveTimeBWP, the UE starts monitoring PDCCH, if configured, or receives the PDSCH, if scheduled or configured, on the selected SBFD subband type or on the selected slot/symbol type.

A motivation to enable selective indication of an SBFD subband for reception of an active DL BWP based on an SCell Dormancy indication is improved radio range. Another motivation is reduced UE power consumption. For example, when one SBFD subband is indicated to the UE for reception in the active DL BWP of the SCell, a single ADC process, a single FFT process, or a single channel estimation process can then be used by the UE. Upon reception of the SCell dormancy indication with respect to a limited receive bandwidth, e.g., on an indicated SBFD subband, for an active DL BWP of the SCell, the UE can adjust its receiver correspondingly. For example, the UE may set or adjust an ADC step size or ADC resolution, or adjust an FFT size to process the reception bandwidth in the active DL BWP based on the location or size of the indicated SBFD subband. For example, the UE may set or adjust receive filtering coefficients to increase inter-subband selectivity based on the location or size of the indicated SBFD subband.

For example, separate UE reception behaviors may be supported for an indicated SBFD subband or for an indicated slot/symbol type for symbols or for SBFD subbands where an SSB or CSI-RS is present or indicated.

In one example, when SSB is configured or indicated within SBFD DL subband 1 of an SCell and the UE is provided with an SCell dormancy indication selecting the SBFD DL subband 2 for reception of an active DL BWP in the SCell, the UE may set or adjust its reception or processing bandwidth for the active DL BWP to the indicated SBFD DL subband 2 on symbols where SSB is not present. The UE can further adjust its reception or processing bandwidth on SSB carrying symbols for SSB reception within SBFD DL subband 1 while not receiving on the SBFD DL subband 2. Following an SSB reception, the UE can further adjust is reception or processing bandwidth to the indicated SBFD DL subband 2. A guard or a switching time or a number of guard or of switching symbols may be expected by, configured for, or indicated to the UE for switching a reception or a processing bandwidth from/to SSBs or CSI-RS. The switch or adjustment of the UE reception or processing bandwidth from/to SSB or CSI-RS may be associated with a condition or may be subject to conditional behavior. For example, a UE may switch or adjust the reception or processing bandwidth from/to the SSB or CSI-RS in SBFD DL subband 1 only at a determined or indicated time based on a periodicity, or an offset or an index value, or based on a specified, or indicated or dependent condition such as a UE may switch or adjust the reception or processing bandwidth from/to the SSB or CSI-RS only if no PDCCH, or no PDSCH, or no higher priority or earlier reception is configured or scheduled in the indicated SBFD DL subband 2.

The SCell dormancy indication field carried by PDCCH on the primary cell such as a DCI format 0_1/0_3/1_1/1_3 within DRX Active Time or in a block of DCI format 2_6 outside DRX Active Time provides information to the UE if the UE should receive in a selected SBFD subband or on a selected slot/symbol type in the active DL BWP of an SCell of the dormancy group based on a typical field/block format with a new higher-layer parameter, or a new field/block format with a new higher-layer parameter, or based on a typical and a new field block format.

In one embodiment, the existing/typical SCell dormancy indication field such as in DCI format 0_1/0_3/1_1/1_3, or in DCI format 2_6 of the Rel-18 NR specifications is re-used. A (new) UE reception behavior with respect to an active DL BWP on the SCell is provided to the UE based on a new higher layer parameter. In one example, an active BWP may be provided by BWP-Id. In one example an active DL BWP may be provided by dormantBWP-Id. In one example, an active DL BWP may be provided by firstWithinActiveTimeBWP-Id.

For example, in case of DCI format 2_6, a Wake-up indication field in a block is L=1 bit. The SCell dormancy indication field in a block can be up to N=5 bits wherein each of the M=1 bit in the bitmap corresponds to one of the SCell group(s) configured by higher layers. For example, reception of an active DL BWP for a selected SBFD subband or for only SBFD symbols/slot, or for only non-SBFD symbols/slots, or for both SBFD and non-SBFD symbols/slots is configured by a new higher layer parameter DormancyGroupWithinActive Time-rxx for the M=1 bit of the up to N=5 bits wherein the M=1 bit is associated with an SCell or SCell group. For example, in case of DCI format 2_6, the UE may determine the size of the DCI format 2_6 by higher layer parameter sizeDCI-2-6. The UE may determine the starting position of the block in the DCI format 2_6 based the parameter ps-PositionDCI-2-6. The UE determines a reception behavior associated with an active DL BWP for a value of the SCell dormancy indication of an SCell in a block based on the DormancyGroupWithinActive Time-rxx.

A motivation for re-using an existing/typical SCell dormancy indication field such as in DCI format 0_1/0_3/1_1/1_3 or in a block of DCI format 2_6 is reduced specification impact and reduced UE implementation effort. Selective indication of an SBFD subband or a slot/symbol type for reception in an active DL BWP associated with the SCell dormancy indication can be supported by existing L1 functionality.

For example, a reception behavior provided to the UE by DormancyGroupWithinActive Time-rxx may correspond to a dormant BWP, e.g., a ‘0’ value of the SCell dormancy indication for M=1 bit of the bitmap indicates an active DL BWP provided by dormantBWP-Id. For example, a ‘1’ value may indicate ‘reception on SBFD DL subband 1 only’, e.g., the UE is indicated SBFD DL subband 1 for reception in an active DL BWP provided by firstWithinActiveTimeBWP-ID if a current active DL BWP is the dormant DL BWP. Or, one or a combination of UE reception behaviors associated with a ‘1’ value of the SCell dormancy indication for the SCell group may be configured for the UE by DormancyGroupWithinActive Time-rxx such as ‘reception in SBFD DL subband 1 only’, ‘reception in SBFD DL subband 2 only’, or ‘reception in both SBFD DL subband 1 and 2’, or ‘reception on SBFD symbols only’, or ‘reception on non-SBFD symbols’, or ‘reception on non-SBFD and SBFD symbols’, etc., is indicated. It can be seen that the designation of ‘0’ or ‘1’ values is chosen for illustration purposes only. Similar regards with respect to the size up to N=5 bits of the SCell dormancy field and M=1 bit associated with an SCell or an SCell group in the bitmap can be applied with respect to a dormancy indication provided by other DCI formats such as a DCI format 0_1/0_3/1_1/1_3.

In one embodiment, a new interpretation of an SCell dormancy indication field in a DCI format such as a DCI format 0_1/0_3/1_1/1_3 or a DCI format 2_6 is used. For example, an SCell dormancy indication field may use M>1 bit associated with one of the SCell group(s), e.g., M bits correspond to one of the SCell group(s) configured by higher layers.

For example, in the case of DCI format 2_6, a Wake-up indication in a block is L=1 bit, and the SCell dormancy indication field, if configured, is up to N bits in a block as configured for the UE by higher layers. In one variant of the example, the maximum block size Bₘₐₓ of the block configured for the UE by higher layers, e.g., based on the L=1 bit for the Wake-up indication and the M bits of an SCell Dormancy Indication associated with an SCell group, if present, is the same as in an existing/typical DCI format 2_6, e.g., L+N=Bₘₐₓ=6. A smaller maximum number of SCell groups may then be configured for the UE. In another variant of the example, the maximum block size Bₘₐₓ of the block configured for the UE by higher layers, e.g., based on the L=1 bit for the Wake-up indication and the M bits SCell Dormancy Indication associated with an SCell group, if present, is different from DCI format 2_6. For example, L+N=Bₘₐₓ=11 and for L=1 and M=2 bits for the SCell Dormancy Indication associated with an SCell, floor (Bₘₐₓ−L)/M=5 SCell groups may be configured in the bitmap. A same number of SCell group(s) configured by higher layer parameter dormancyGroupOutsideActive Time-rxx as in a block of the existing/typical DCI format 2_6 can then be supported for the UE. The block configured for a typical UE and the block configured for the later release, e.g., SBFD-aware UE can still be multiplexed into a same DCI format 2_6 even when the blocks have different lengths. This is because the typical UE and the later release UE are separately provided with a configuration of the starting position of a block in the DCI format 2_6 by the gNB. The UE may determine the size of the DCI format 2_6 by higher layer parameter sizeDCI-2-6. The UE may determine the starting position of the block in the DCI format 2_6 based the parameter ps-PositionDCI-2-6. The UE may determine a value, e.g., codepoint, for the SCell dormancy indication bit or bits associated with an SCell based on the starting position and the number of M bits per SCell group or based on the N bits of the bitmap. Similar design regards with respect to the size N bits of the SCell dormancy field and the M bits associated with an SCell group in the bitmap can be applied with respect to an SCell dormancy indication field provided by a DCI format such as a DCI format 0_1/0_3/1_1/1_3.

A motivation is improved PDCCH monitoring adaptability while preserving the ability to multiplex typical and new release UEs based on a same DCI format 2_6 signaling design.

For example, reception for the UE on the active DL BWP of an SCell using a selected SBFD subband, or using only the SBFD symbols/slots, or using only the non-SBFD symbols/slots, or using both the SBFD and non-SBFD symbols/slots, is configured for the UE based on a new higher layer parameter DormancyGroupWithinActive Time-rxx. For M>1 bit, the SCell dormancy indication field associated with an SCell group can indicate separate reception behaviors to the UE. For example, a reception behavior provided to the UE by DormancyGroupWithinActive Time-rxx may correspond to a dormant BWP, e.g., a codepoint ‘00’ of the SCell dormancy indication may indicate an active DL BWP provided by dormantBWP-Id. A ‘01’ value may indicate ‘reception on SBFD DL subband 1 only’, e.g., the UE is indicated SBFD DL subband 1 for reception in an active DL BWP provided by firstWithinActiveTimeBWP-ID if a current active DL BWP is the dormant DL BWP. A ‘10’ value may indicate ‘reception on SBFD DL subband 2 only’, e.g., the UE is indicated SBFD DL subband 2 for reception in an active DL BWP provided by firstWithinActiveTimeBWP-ID) if a current active DL BWP is the dormant DL BWP. A ‘11’ value may indicate a current active DL BWP for the UE for each activated SCell in the corresponding group of configured SCells, if the current active DL BWP is not the dormant BWP.

In one embodiment, using the typical SCell dormancy indication of size M=1 bit for an associated SCell group or using a new size of M>1 bit for the SCell dormancy indication for an associated SCell group, one of multiple possible or allowed reception behaviors for an active DL BWP may be configured for the UE by a new higher layer parameter DormancyGroupWithinActive Time-rxx.

For example, when M=2, a first possible or allowed configurable reception behavior may correspond to codepoint ‘00” indicating ‘dormant BWP’, a codepoint ‘01’ indicating ‘reception on SBFD subband 1 only’, a codepoint ‘10’ indicating ‘reception on SBFD subband 2 only’ and a codepoint ‘11’ indicating ‘reception on any SBFD DL subband’. For example, when M=2, a second possible or allowed configurable reception behavior may correspond to codepoint ‘00’ indicating ‘dormant BWP’, a codepoint ‘01’ indicating ‘reception on non-SBFD symbols only’, a codepoint ‘10’ indicating ‘reception in SBFD DL subband 1 only’ and a codepoint ‘11’ indicating ‘reception in any SBFD DL subband’. For example, when M=2, a third possible or allowed configurable reception behavior may correspond to codepoint ‘00’ indicating ‘dormant BWP’, a codepoint ‘01’ indicating ‘reception on SBFD DL subband 1 based on PDCCH configuration 1’, a codepoint ‘10’ indicating ‘reception on SBFD DL subband 2 based on PDCCH configuration 2’, and a codepoint ‘11’ indicating ‘reception in any SBFD DL subband based on PDCCH configuration 1 only’. It can be seen that the designation of codepoints or values ‘00’, ‘01’, ‘10’ or ‘11’ for the case of M=2 SCell dormancy indication bits associated with an SCell group is chosen for illustration purposes only.

With respect to a higher layer provided UE reception behavior associated with an SCell dormancy indication of M bits for an SCell or an SCell group, in one example, the UE is provided by higher layers a set of four reception behaviors b1, b2, b3 and b4. Reception behavior b1 is associated with no reception. Reception behavior b2 is associated with reception on SBFD DL subband 1 only, but no reception on SBFD DL subband 2 or the SBFD UL subband. Reception behavior b3 is associated with reception on SBFD DL subband 2 only, but no reception on SBFD DL subband 1 or the SBFD UL subband. Reception behavior b4 is associated with reception on any SBFD DL subband. The UE can be provided with a set of indication values associated with the set of higher-layer reception behaviors b1, b2, b3 and b4, e.g., using codepoints ‘00’, ‘01’, ‘01’ and ‘11’ for an indication of reception behaviors b1, b2, b3 and b4, respectively. For example, an M=2, or two-bit field of a DCI format 0_1/0_3/1_1/1_3 or a DCI format 2_6 can be used to signal an indication of a higher layer reception behavior for an SCell to the UE.

When the UE is indicated to use reception behavior b2, the UE monitors receptions on the SBFD DL subband 1 of the active DL BWP on the SCell but not on the SBFD DL subband 2 or the SBFD UL subband. If PDCCH is configured on the SCell, the UE monitors PDCCH receptions according to parameters such as monitoringSlotPeriodicityAndOffset provided by higher-layer PDCCH configuration. The UE may evaluate valid receptions of a PDSCH scheduled or configured for SBFD DL subband 1 but not for SBFD DL subband 2 or for the SBFD UL subband. When the UE is indicated to use reception behavior b3, the UE monitors receptions on the SBFD DL subband 2 of the active DL BWP on the SCell but not on the SBFD DL subband 1 or the SBFD UL subband. When the UE is indicated to use reception behavior b4, the UE monitors reception of PDCCH or PDSCH on any SBFD DL subband. For example, the UE may monitor PDCCH, if configured on the SCell, according parameters such as monitoringSlotPeriodicityAndOffset provided by higher-layer PDCCH configuration. The UE may evaluate valid receptions of a PDSCH scheduled or configured in either or both SBFD DL subbands 1 or 2. For example, if PDCCH monitoring on the SCell is enabled, a CORESET in the NR carrier BW may be configured for the UE such that RBs of the CORESET are comprised within the SBFD DL subbands 1 and 2. In another example, two CORESETs, wherein a CORESET is contained within an SBFD DL subband may be configured for the UE.

For example, a higher layer provided reception behavior for an SCell may be associated with a duration. A same value of a duration or different values of durations may be associated with different reception behaviors. For example, reception behavior b2 associated with reception on SBFD DL subband 1 only may be configured by higher layers for a duration of d2=320 msec, but reception behavior b3 associated with reception on SBFD DL subband 2 only may be configured by higher layers for a duration of d3=160 msec. A higher-layer provided duration may correspond to a default value which is expected by the UE if no value is provided by higher layers.

A motivation is to provide information for a reception behavior to the UE for a first (initial) period of reception on the SCell before the UE can fallback or adjust to another reception behavior in a second (later) period of reception on the SCell. A motivation is faster AGC settling time and more accurate CSI reporting for fast (re-) activation of the SCell using the Dormancy feature.

In another example, the UE is provided by higher layers a set of four reception behaviors b1, b2, b3 and b4. Reception behavior b1 is associated with no reception. Reception behavior b2 is associated with reception on non-SBFD symbols in an active DL BWP of the SCell, but no reception on SBFD symbols. Reception behavior b3 is associated with reception on SBFD symbols in an active DL BWP of the SCell, but no reception on non-SBFD symbols. Reception behavior b4 is associated with reception on both SBFD and non-SBFD symbols in an active DL BWP of the SCell.

When the UE is indicated to use reception behavior b2, the UE monitors receptions on the non-SBFD symbols but not on the SBFD symbols. For example, the UE may monitor PDCCH, if configured on the SCell, according to parameters such as monitoringSlotPeriodicityAndOffset provided by higher-layer PDCCH configuration. The UE may evaluate valid a PDSCH allocation on the non-SBFD symbols of the SCell but may not evaluate valid PDSCH when scheduled or configured for SBFD symbols. When the UE is indicated to use reception behavior b3, the UE skips receptions on the non-SBFD symbols but monitors receptions on the SBFD symbols. For example, the UE can monitor PDCCH reception, if configured on the SCell, according to parameters such as monitoringSlotPeriodicityAndOffset provided by higher-layer PDCCH configuration on the SBFD symbols. The UE does not evaluate valid a PDSCH allocation if scheduled or configured on non-SBFD symbols but receives PDSCH on the SBFD symbols. When the UE is indicated to use reception behavior b4, the UE monitors receptions on both SBFD and non-SBFD symbols. For example, the UE then monitors PDCCH receptions according to PDCCH parameters such as monitoringSlotPeriodicityAndOffset, if provided by higher-layer PDCCH configuration, or evaluates valid PDSCH allocation on either the non-SBFD or the SBFD symbols.

A motivation for enabling different reception behaviors for an active DL BWP of an SCell or an SCell group associated with the SCell dormancy indication for receptions based different SBFD subband types, or based on non-SBFD symbols/slots or SBFD symbols slots is increased link robustness when operating on a serving cell supporting full-duplex operation. By selectively enabling or disabling reception based on a slot/symbol type, or based on an SBFD subband type, using DormancyGroupWithinActive Time-rxx, a gNB (e.g., the gNB 102) can adjust the UE behavior based on DCI indication for a UE to a subset of time-domain or frequency-domain resources corresponding to the SBFD configurations associated with a gNB or for TRP A and/or TRP B, respectively.

Evaluating the existence of SBFD subbands and/or of non-SBFD and SBFD resources and/or of multi-TRP operation, e.g., for a first TRP and for a second TRP, a SCell dormancy indication of size M=2, M=4 bits or M=6 bits associated with an SCell in an SCell dormancy indication field or block of size N bits, can provide additional flexibility.

A motivation is that the larger a number of M bits for the SCell dormancy indication associated with an SCell, the larger the number of reception behaviors that can be indicated per TRP and/or per SBFD subband and/or per resource type (non-SBFD/SBFD symbol).

In one embodiment, an SCell dormancy indication associated with an SCell may be configured by higher layers for the UE with respect to possible or allowed reception behaviors for one or a combination of TRPs.

For example, a mapping of values to reception behaviors for the SCell dormancy indication for combinations of {SBFD, non-SBFD} resources and of {TRP A, TRP B} can be defined where the combinations can be indicated by higher layers. For example, a first combination can be no reception on the SCell on any TRP, a second combination can be {non-SBFD, TRP A, TRP B} on the SCell, a third combination can be {SBFD, TRP A, TRP B} on the SCell, a fourth combination can be {SBFD, non-SBFD, TRP A} on the SCell, a fifth combination can be {SBFD, non-SBFD, TRP A, TRP B} on the SCell, and so on. In another example, a first combination can be no reception on the SCell on any TRP, a second combination can be {SBFD DL subband 1, TRP A, TRP B} on the SCell, a third combination can be {SBFD DL subband 2, TRP A, TRP B} on the SCell, a fourth combination can be {SBFD DL subband 1 for TRP A, SBFD DL subband 2 for TRP B} on the SCell, a fifth combination can be {any SBFD DL subband, TRP A, TRP B} on the SCell, and so on. A same combination can be mapped to multiple values of the SCell dormancy indication associated with an SCell with different reception behaviors or with respect to a TRP for the combination.

For example, a DCI format such as DCI format 0_1/0_3/1_1/1_3 or DCI format 2_6 may include two fields or two blocks for the UE; a first field or block indicating a reception behavior on SBFD subbands or on SBFD resources for both TRP A and TRP B, and a second indicating a reception behavior on non-SBFD resources for both TRP A and TRP B. It is also feasible that a DCI format such as DCI format 0_1/0_3/1_1/1_3 or DCI format 2_6 includes four fields or blocks for the UE; for example, a first indicating a reception behavior on SBFD subbands or SBFD resources for TRP A, a second indicating a reception behavior on non-SBFD resources for TRP A, a third indicating a reception behavior on SBFD subbands or SBFD resources for TRP B, and a fourth indicating a reception behavior on non-SBFD resources for TRP B.

In one embodiment, a UE (e.g., the UE 116) is provided by higher layers from a serving gNB a new parameter DormancyGroupWithinActive Time-rxx for a SCell dormancy indication associated with an SCell that selectively enables or disables reception for an SBFD subband or for a slot/symbol type with respect to a first symbol type such as ‘SBFD’ or ‘F’ for an SCell, but is not applicable to a second symbol type such as ‘non-SBFD’ or ‘D’ symbol for an SCell.

The new parameter DormancyGroupWithinActive Time-rxx may be used to provide a set of reception behaviors for both non-SBFD time or frequency resources and for SBFD time or frequency resources. The new parameter DormancyGroupWithinActive Time-rxx may provide a configuration associated with one or with multiple values of a SCell dormancy indication field.

For example, the new parameter DormancyGroupWithinActive Time-rxx then includes a set of reception behaviors that is applicable only to the first symbol type, e.g., ‘SBFD’ or ‘F’ for a value of the SCell dormancy indication field associated with an SCell. For the second symbol type, e.g., ‘non-SBFD’ or ‘D’, a typical DormancyGroupWithinActive Time parameter may be used to provide a configuration associated with a value of the SCell dormancy indication field for the SCell. Similar principles extend to the case where the new parameter DormancyGroupWithinActive Time-rxx configures reception behavior with respect to an SBFD subband. For example, the new parameter DormancyGroupWithinActive Time-rxx then includes a set of reception behaviors that enables or disables or selects an SBFD subband for receptions on the first symbol type, e.g., ‘SBFD’ or ‘D’ symbol, for a value of the SCell dormancy indication field associated with an SCell, and a typical DormancyGroupWithinActive Time parameter then provides a UE reception behavior for the second symbol type, e.g., ‘non-SBFD’ or ‘F’ symbol.

For example, when an extended SCell dormancy indication of size M=3 bits associated with an SCell is configured for a UE in a DCI format such as DCI format 0_1/0_3/1_1/1_3 or in a DCI format 2_6 for receptions with respect to an active DL BWP, and the set of (legacy) monitoring behaviors provided to the UE by typical DormancyGroupWithinActive Time includes one value and the set of (new) monitoring behaviors provided to the UE by DormancyGroupWithinActive Time-rxx includes three values, a value ‘0’ for the first (legacy) bit of the M=3 bits of the SCell dormancy indication for an SCell may indicate a dormant BWP, e.g., an active DL BWP provided by dormantBWP-Id and a value ‘1’ may indicate an active DL BWP, provided by firstWithinActiveTimeBWP-Id for the UE if a current active DL BWP is the dormant DL BWP, or a current active DL BWP if the current active DL BWP is not the dormant DL BWP. The last two (new) bits of the L=3 bits of the field may indicate (new) reception behavior with respect to an SBFD subband or with respect to non-SBFD or SBFD symbols for an SCell, for SCell(s) for which an SBFD configuration is provided to the UE, or for an SCell group. For example, values ‘00’/‘01’/‘10’/‘11’ for the new field, respectively, may then indicate reception on an associated SCell for an active DL BWP according a first/second/third/fourth reception behavior from DormancyGroupWithinActive Time-rxx for an indicated or selected SBFD subband or for indicated or selected symbol/slot type. Similar procedures can apply if instead of bits from an extended SCell dormancy indication field, a new/additional SCell dormancy indication field is used to indicate a reception behavior on an associated SCell from DormancyGroupWithinActive Time-rxx for an SBFD subband or for a non-SBFD or for an SBFD symbol/slot with respect to receptions from a gNB or from a TRP A or from TRP B, or from TRP A and TRP B.

In the following, parameter DormancyGroupWithinActive Time-rxx can provide a first set of reception behaviors for an SBFD subband or for a non-SBFD symbol/slot for an SCell and a second set of reception behaviors for an SBFD subband or for SBFD symbols/slots for an SCell, or can provide only a set of reception behaviors for an SBFD subband or for an SBFD symbol/slot while a typical parameter DormancyGroupWithinActive Time can provide a (legacy) reception behavior for the associated SCell.

A SCell dormancy indication field or block associated with an SCell or an SCell group in a DCI can be any of:
a typical SCell dormancy indication, e.g., M=1, with a value that maps to more than one sets of values for respective more than one sets of reception behaviors for an SCell, possibly including receptions from a TRP A or from TRP B, or from TRP A and TRP B, where the more than one sets of reception behaviors are associated with non-SBFD slots and SBFD slots, or with an SBFD DL subband or an SBFD UL subband, or an SBFD flexible subband. The value may be applicable to both non-SBFD slots/symbols and SBFD slots/symbols on the SCell, or may be applicable only to slots/symbols of same type as the slot/symbols of the reception with the DCI. One of TRP A or TRP B may be a reference or a default TRP associated with receptions on a serving cell.
an extended SCell dormancy indication, e.g., M=2 or M=3, possibly with a number of bits that is larger than in case of non-full-duplex operation, where first bits from the number of bits provide a first value that maps to a first reception behavior for an SCell in non-SBFD slots and second bits from the number of bits provide a second value that maps to a second reception behavior for the SCell in SBFD slots, possibly with respect to receptions from TRP A or from TRP B, or from TRP A and TRP B. In similar manner, second bits from the number of bits may provide a second value that maps to a second reception behavior in an SBFD DL subband, or an SBFD UL subband, or an SBFD flexible subband of the SCell, possibly with respect to receptions from TRP A or from TRP B, or from TRP A and TRP B. The first and second reception behavior can be from a same set of or from separately provided sets of reception behaviors. In that latter case, a number of first bits and a number of second bits can be different and be determined from a size of a corresponding set of reception behaviors. One of TRP A or TRP B may be a reference or a default TRP associated with receptions on the SCell following reception of a SCell dormancy indication on a serving cell.
a new SCell dormancy indication field, e.g., M=2, that is applicable to SBFD slots or symbols, or to receptions in a configured or indicated SBFD DL subband, SBFD UL subband, or SBFD flexible subband, associated with an SCell, possibly with respect to receptions from TRP A or from TRP B, or from both TRP A and TRP B, while a typical SCell dormancy indication field or block, or another new SCell dormancy indication field or block, is applicable to non-SBFD slots or symbols, or to receptions in an SBFD DL subband, or an SBFD UL subband, or an SBFD flexible subband, of the SCell, possibly with respect to a reference or default TRP associated with receptions on a serving cell. A first number of bits for the typical SCell dormancy indication, or for a first new SCell dormancy indication, can be different from a second number of bits for the new SCell dormancy indication, or for the second new SCell dormancy indication, where the first and second numbers of bits can be determined from the sizes of corresponding sets of reception behaviors. One of TRP A or TRP B may be a reference or a default TRP associated with receptions on the SCell.

Without loss of generality, an indication value associated with a SCell dormancy indication for an SCell, an SCell group, or an SCell supporting SBFD operation within a set of SCells, and/or configured by higher layer parameter DormancyGroupWithinActive Time-rxx for receptions may be provided to the UE using a unicast DCI such as a DCI format 0_1/0_2/0_3/1_1/1_2/1_3 in REF2. The functionality of a SCell dormancy indication field or block associated with an SCell for receptions on SBFD or non-SBFD symbols or on SBFD subbands, with respect to TRP A and/or to TRP B, can also be applicable for a multicast DCI format, e.g., for a PDCCH associated with multicast DCI formats such as DCI format 4_0/4_1 in REF2. A DCI format associated with a SCell dormancy indication and/or configured by higher layer parameter DormancyGroupWithinActive Time-rxx for PDCCH receptions may alternatively be provided to the UE using a separate RNTI value, e.g., dormancy-RNTI. For example, an SCell dormancy indication received by the UE in a DCI format 2_6 using a first ps-RNTI value may be associated with a first set of reception behaviors for an SCell and a second dormancy-RNTI value may be associated with a second set of reception behaviors for the SCell. For example, the first ps-RNTI value may indicate typical UE behavior with respect to a configuration provided by higher layer parameter DormancyGroupWithinActive Time and the second dormancy-RNTI value may indicate UE behavior according to the reception behavior configured by DormancyGroupWithinActive Time-rxx.

For example, when a UE is provided by higher layers from a serving gNB a new parameter, for example DormancyGroupWithinActive Time-rxx, that configures a reception behavior associated with an SCell for a SCell dormancy indication, a codepoint in a SCell dormancy indication field or block of size M, e.g., M=4 bits, can indicate one or more of:
The symbol (or slot) types associated with a reception on an SCell, e.g., SBFD and/or non-SBFD symbol/slots, or ‘D’ and/or ‘F’ and/or ‘U’ symbols/slots
The TRP or TRPs to monitor receptions, e.g., from TRP A and/or TRP B
The SBFD configuration associated with an SCell
The type of SBFD subband to monitor on an SCell, e.g., SBFD DL subband, and/or SBFD UL subband, and/or first SBFD DL subband, and/or second SBFD DL subband, and/or SBFD flexible subband
The duration of monitoring on an SCell, wherein the duration can be in units of slots or symbols or sub-frames or frames, or milliseconds, etc.

In another example, an SCell dormancy indication to enable or disable receptions for an SCell based on a slot or a symbol type, or based on an SBFD subband type, may be provided to the UE by an association with a slot or symbol type, or by an association with an SBFD subband type, where the UE receives such a SCell dormancy indication. Therefore, an interpretation by the UE for an applicability of receptions on an SCell can be for types of symbols or slots or for types of SBFD subbands, such as non-SBFD or SBFD, that are same as a type of symbols or slots or a type of subbands where the UE received a PDCCH that provides the DCI format with the SCell dormancy indication, and the indication is not applicable for receptions in symbols or slots or for SBFD subbands of different types.

For example, parameter DormancyGroupWithinActive Time-rxx may be included in one or more RRC messages and/or IEs and a parameter DormancyGroupWithinActive Time-rxx may be received by the UE based on a system information block (SIB), such as a SIB1, or by a common RRC signaling, or by UE-specific RRC signaling. For example, and without loss of generality, DormancyGroupWithinActive Time-rxx may be provided by the gNB to the UE as part of RRC messages of type RRC Setup, RRCReconfiguration, SIB1 or SystemInformation, or may be included in RRC IEs of type ServingCellConfig, ServingCellConfigCommon, or ServingCellConfigSIB1. Such RRC configuration parameters may be of enumerated, listed or sequence type or may be encoded as a bit string. In one example, DormancyGroupWithinActive Time-rxx may be included in an IE of type PDC CH-Config. Multiple parameter sets for DormancyGroupWithinActive Time-rxx can be provided to the UE. Parameter DormancyGroupWithinActive Time-rxx may indicate slot/symbol indices or a set of slots/symbols where a UE monitors or does not monitor receptions associated with a SCell dormancy indication. The UE may be provided time-domain resources, e.g., slots/symbols, where the UE monitors or does not monitor receptions for an SCell even when the UE determines that a slot/symbol or a slot/symbol type where a reception may occur is part of a higher-layer provided configuration, e.g., associated with a PDCCH monitoring occasion. For example, DormancyGroupWithinActive Time-rxx may include a bitmap to indicate time-domain resources, such as based on an RRC parameter monitoringSlotsWithinSlotGroup or monitoringSymbolsWithinSlot, or frequency-domain resources based on an RRC parameter freqMonitorLocations for receptions associated with an SCell. DormancyGroupWithinActive Time-rxx may be associated with PDCCH configuration using a control channel element (CCE) aggregation level, such as for example limiting a UE when monitoring or not monitoring PDCCH receptions for an indicated CCE aggregation level, such as 8. DormancyGroupWithinActive Time-rxx may be associated with a resource type indication for monitoring or not monitoring receptions, such as a slot or symbol or symbol group of a radio resource that may be of type ‘simultaneous Tx-Rx’, ‘Rx only’, or ‘Tx only’. For example, a resource type indication such as ‘simultaneous Tx-Rx’, ‘Rx only’, or ‘Tx only’ can be provided per slot type ‘D’, ‘U’ or ‘F’ in a slot or symbol. For example, a resource type may be associated with a configured or an indicated SBFD UL and/or DL subband and/or Flexible subband. An indication of the resource type may be provided independently of the transmission direction of a slot or symbol indicated to the UE by the TDD UL-DL frame configuration provided by higher layers.

In one embodiment, the UE determines an SBFD configuration for receptions on an SCell based on a value in the SCell dormancy indication field, wherein the value is associated with an SBFD configuration of the SCell.

For example, an SCell dormancy indication carried by PDCCH on the primary cell such as a DCI format 0_1/0_3/1_1/1_3 within DRX Active Time or a DCI format 2_6 outside DRX Active Time can indicate an SBFD configuration associated with an SCell of the dormancy group to the UE.

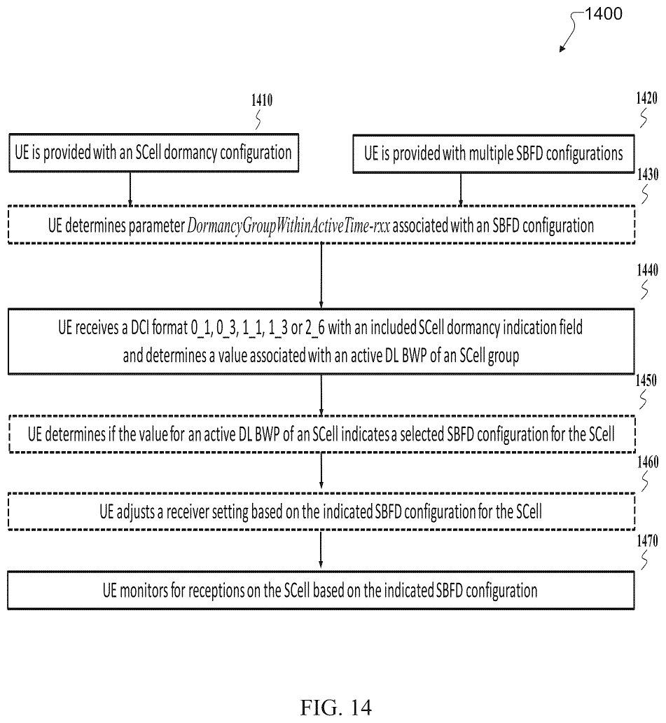

FIG. 14 illustrates a flowchart of an example UE procedure 1400 for SCell dormancy indication according to embodiments of the present disclosure. For example, procedure 1400 for SCell dormancy indication can be followed by any of the UEs 111-116 of FIG. 1, such as the UE 116. This example is for illustration only and other embodiments can be used without departing from the scope of the present disclosure.

The procedure begins in 1410, the UE is provided with an SCell dormancy configuration. In 1420, the UE is provided with multiple SBFD configurations. In 1430, the UE determines a parameter DormancyGroupWithinActive Time-rxx associated with an SBFD configuration for an SCell. In 1440, the UE receives a DCI format 0_1/0_3/1_1/1_3 or 2_6 that provides an SCell dormancy indication in a field/block and determines a value associated with an SCell group. In 1450, the UE determines if the value indicates a selected SBFD configuration for the SCell. In 1460, if the UE determines that reception for a selected SBFD configuration is indicated by the value, the UE may adjust a UE receiver setting based on the indicated SBFD configuration. In 1470, the UE then monitors for receptions on the SCell based on the indicated SBFD configuration.

In one embodiment, a UE is provided with a first SBFD configuration for an SCell and with a second SBFD configuration for the SCell, respectively. The UE is provided with a first value of an SCell dormancy indication associated with the SCell and with a second value of an SCell dormancy indication associated with the SCell, respectively. The first SBFD configuration and the first value of the SCell dormancy indication are associated with each other. The second SBFD configuration and the second value of the SCell dormancy indication are associated with each other.

For example, an SCell or an SCell group provided by higher-layer parameter DormancyGroupWithinActive Time-rxx can be associated with an SBFD configuration with respect to receptions in an active DL BWP of an SCell or an SCell group. In one example, an active BWP may be provided by BWP-Id. In one example an active DL BWP may be provided by dormantBWP-Id. In one example, an active DL BWP may be provided by firstWithinActiveTimeBWP-Id.

In one example, when a UE receives a DL signal or channel such as an SSB, a CSI-RS, a phase tracking reference signal (PTRS), a PDCCH or a PDSCH in an active DL BWP of an SCell based on a first value of an SCell dormancy indication, the UE can expect receptions on the SCell according to the associated first SBFD configuration. When a UE receives a DL signal or channel such as an SSB, a CSI-RS, a PTRS, a PDCCH or a PDSCH in an active DL BWP of an SCell based on a second value of the SCell dormancy indication, the UE can expect receptions on the SCell according to the associated second SBFD configuration. For example, the UE receives a DCI format such as DCI format 0_1/0_3/1_1/1_3 or DCI format 2_6 with an SCell dormancy indication field or block, and determines an SBFD configuration for an SCell based on a codepoint of the DCI with an SCell Indication field or block.

In one example, the UE is provided with a SCell dormancy indication associated with an SCell or an SCell group of size M=2 bits wherein an SCell dormancy indication field or block can be of size up to N bits. The UE is provided by RRC signaling such as RRCReconfiguration with a first SBFD configuration of type ‘DUD’ for an SCell wherein an SBFD UL subband is configured on 51 center RBs in the NR carrier BW of an SBFD symbol and with a second SBFD configuration of type ‘none’ for the SCell, e.g., no SBFD configuration is provided (or an SBFD configuration is not indicated). The first and the second SBFD configurations for the SCell are associated with a first subset K1 and a second subset K2 of the 2M possible codepoints of the SCell dormancy indication, respectively. For example, parameter DormancyGroupWithinActive Time-rxx may provide a reference, or association, or pointer, or link for an SBFD configuration of an SCell or SCell group. For example, the first SBFD configuration may be associated with codepoints ‘01’ and ‘10’ and the second SBFD configuration may be associated with codepoint ‘11’ of the SCell dormancy indication for an SCell or an SCell group. The gNB can then indicate an SBFD configuration to be expected or to be used by the UE for the receptions on the SCell based on a codepoint of the SCell dormancy indication field in a DCI format such as DCI format 0_1/0_3/1_1/1_3 within Active Time or DCI format 2_6 outside Active Time. In another example, when a codepoint of the SCell dormancy indication field is associated with an SBFD configuration for an SCell, one codepoint may be associated with an SBFD configuration of a TRP A on the SCell and one codepoint may be associated with an SBFD configuration of TRP B on the SCell, respectively, to be expected or to be used by the UE for the receptions in the associated SCell upon reception of the SCell dormancy indication.

When the UE receives a SCell dormancy indication for an SCell that maps or associates a codepoint to an SBFD configuration and/or TRP for the SCell, and the UE determines that a change from a current SBFD configuration and/or TRP reception is indicated by the DCI with the SCell dormancy indication, the UE further determines the SBFD configuration associated with the codepoint. For example, if a new SBFD configuration from the first subset K1 of an SBFD configuration is indicated by a codepoint of the SCell dormancy indication, the UE selects the first (example) SBFD configuration of type ‘DUD’ to adjust its receiver processing for reception on the associated SCell. For example, if an SBFD configuration from the second subset K2 is indicated, the UE selects the second SBFD configuration of type ‘none’ to adjust its receiver processing for the associated SCell. The UE can then process receptions on the SCell based on or according to the first or the second SBFD configuration provided by the SCell dormancy indication. For example, if the indicated SBFD configuration is from the first subset K1, the UE may not evaluate valid a CORESET allocation for PDCCH receptions on the SCell if the CORESET frequency-domain allocation comprises RBs in an SBFD UL subband of the first SBFD configuration, or the UE may configure its reception filtering setting based on the known frequency-domain location of the SBFD DL subbands of the SCell based on the first SBFD configuration. The UE may not evaluate valid a PDSCH allocation which is scheduled or configured outside the SBFD DL subbands on the SCell. For example, if the indicated SBFD configuration is from the second subset, the UE may evaluate valid any CORESET allocation for PDCCH reception on the SCell in an active DL BWP, or the UE may configure its reception filtering setting based on the active UE DL BWP. For example, the UE may evaluate valid a PDSCH allocation in an active DL BWP of the SCell. A suitable activation delay and/or a validity duration for an SBFD configuration associated with a codepoint of a SCell dormancy indication for an SCell may be used.

A motivation is the support and dynamicity of SBFD operation, e.g., SBFD-aware UEs configured with the SCell dormancy feature can then be indicated a change to or an adjustment of the SBFD configuration on an SCell. For example, when the SCell dormancy feature is configured for the UE, it can be avoided to re-configure an SBFD configuration for an SCell or SCell group using RRC messages such as RRCReconfiguration on the PCell. This can decrease signaling load. Another motivation is that when a group-common DCI such as DCI format 2_0 based signaling during Active Time is used to provide an indication of an SBFD configuration of a serving cell to a UE, an SCell dormancy indication in a DCI format 2_6 received outside active time can enable to indicate the SBFD configuration of an SCell prior to determination of an active DL BWP for receptions on the SCell, or can avoid separately monitoring a PDCCH with a group-common DCI format to determine an SBFD configuration on the SCell. This can reduce the UE power consumption.

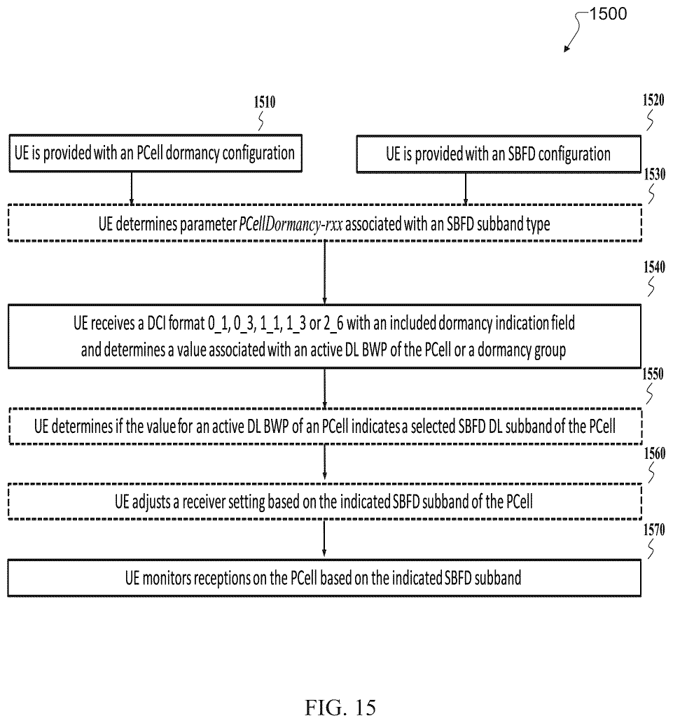

FIG. 15 illustrates a flowchart of an example UE procedure 1500 for dormancy indication according to embodiments of the present disclosure. For example, procedure 1500 for dormancy indication can be followed by any of the UEs 111-116 of FIG. 1, such as the UE 112. This example is for illustration only and other embodiments can be used without departing from the scope of the present disclosure.

The procedure begins in 1510, the UE is provided with an PCell dormancy configuration. In 1520, the UE is provided with an SBFD configuration. In 1530, the UE determines a parameter PCellDormancy-rxx associated with an SBFD configuration for the PCell or a dormancy group. In 1540, the UE receives a DCI format 0_1/0_3/1_1/1_3 or 2_6 that provides a dormancy indication for a PCell in a field/block and determines a value associated with the PCell or dormancy group. In 1550, the UE determines if the value indicates reception on a selected SBFD DL subband of the PCell. In 1560, if the UE determines that reception for a selected SBFD subband is indicated by the value, the UE may adjust a UE receiver setting based on the indicated SBFD subband. In 1570, the UE then monitors for receptions on the PCell based on the indicated SBFD subband.

A dormancy indication carried by PDCCH on the primary cell such as a DCI format 0_1/0_3/1_1/1_3 within DRX Active Time or a DCI format 2_6 outside DRX Active Time provides information to the UE if the UE should receive in a selected SBFD subband or on a selected slot/symbol type in the active DL BWP of the PCell.

In one embodiment, a UE is provided by higher layers from a serving gNB (e.g., the gNB 102) a new parameter, for example PCellDormancy-rxx, for reception of a PCell dormancy indication that selectively enables or disables reception of an active DL BWP on the PCell for an SBFD subband type or a slot/symbol type.

For example, an SBFD subband type may correspond to an SBFD DL subband, an SBFD UL subband, or an SBFD flexible subband. For example, a slot/symbol type may correspond to ‘SBFD’ or ‘non-SBFD’, or may correspond to ‘D’ or ‘F’ or ‘U’. For example, a configured/indicated SBFD subband or non-SBFD/SBFD slot/symbol type may be configured/indicated to the UE as a “dormant” SBFD subband or as a dormant SBFD slot/symbol in a duration. On a dormant SBFD subband or a dormant slot/symbol, the UE does not receive a channel/signal and the UE does not transmit a signal/channel, possibly subject to specific exceptions and rules, e.g., such as reception of an SSB in an SBFD subband.

For example, PCellDormancy-rxx can be associated with a set or a combination of SBFD subbands or subband types such as ‘SBFD DL subband 1 and 2’ or ‘SBFD DL and flexible subband’ or a set or a combination of symbol/slot types such as ‘D and F’ with respect to receptions in an active DL BWP from the gNB or a TRP of a PCell.

For example, when UE receives a dormancy indication selecting an SBFD subband type or a slot/symbol type for receptions on an active DL BWP of the PCell, the UE (e.g., the UE 116) starts monitoring PDCCH, if configured, or receives the PDSCH, if scheduled or configured, on the selected SBFD subband type or on the selected slot/symbol type.

A motivation to enable selective indication of an SBFD subband for reception of an active DL BWP based on a dormancy indication for the PCell is improved radio range. Another motivation is reduced UE power consumption. For example, when one SBFD subband is indicated to the UE for reception in the active DL BWP of the PCell, a single ADC process, a single FFT process, or a single channel estimation process can then be used by the UE. Reuse of the existing SCell dormancy feature to enable selective indication of an SBFD subband or a slot/symbol type for receptions on the PCell can minimize specification delta an minimize UE design impact. Selective indication of a dormant SBFD subband or a dormant slot/symbol type on the PCell for a time duration can reduce supporting dynamic DCI-based indication of transmission/reception direction. This can reduce UE complexity for support of dynamic SBFD operation.

A dormancy indication field carried by PDCCH on the primary cell such as a DCI format 0_1/0_3/1_1/1_3 within DRX Active Time or in a block of DCI format 2_6 outside DRX Active Time can provide information to the UE if the UE should receive in a selected SBFD subband or on a selected slot/symbol type in the active DL BWP of the PCell. For example, dormancy behavior for the PCell may be configured separate from SCell dormancy groups, or a PCell may be configured as part of a dormancy group wherein other serving cells included in the dormancy group may be SCells. For example, a typical dormancy indication field/block format with a new higher-layer parameter, or a new dormancy indication field/block format with a new higher-layer parameter, or based on a typical and a new field/block format may be used to indicate receptions for an SBFD subband or a slot/symbol type on the PCell with SBFD support.

In one embodiment, the existing/typical SCell dormancy indication field such as in DCI format 0_1/0_3/1_1/1_3, or in DCI format 2_6 of the Rel-18 NR specifications is re-used. A (new) UE reception behavior with respect dormancy for an SBFD subband or a slot/symbol type with respect to an active DL BWP on the PCell is provided to the UE based on a new higher layer parameter.

For example, in case of DCI format 2_6, a Wake-up indication field in a block is L=1 bit. The existing SCell dormancy indication field in a block can be up to N=5 bits wherein each of the M=1 bit in the bitmap can correspond to one of the SCell group(s) configured by higher layers. For example, reception of an active DL BWP for a selected SBFD subband or for only SBFD symbols/slot, or for only non-SBFD symbols/slots, or for both SBFD and non-SBFD symbols/slots is configured by a new higher layer parameter PCellDormancy for one of the M=1 bit from the up to N=5 bits wherein the M=1 bit is associated with PCell dormancy. A smaller maximum number of SCell groups may then be used in the existing SCell dormancy indication field/block using the remaining N−1 bits. In another example, one of the M=1 bit is used for dormancy indication of the PCell wherein the PCell is one of the cells of a dormancy group. For example, in case of DCI format 2_6, the UE may determine the size of the DCI format 2_6 by higher layer parameter sizeDCI-2-6. The UE may determine the starting position of the block in the DCI format 2_6 based the parameter ps-PositionDCI-2-6.

A motivation for re-using an existing/typical SCell dormancy indication field such as in DCI format 0_1/0_3/1_1/1_3 or in a block of DCI format 2_6 to indicate PCell dormancy behavior is reduced specification impact and reduced UE implementation effort. Selective indication of an SBFD subband or a slot/symbol type for reception in an active DL BWP associated with the PCell dormancy indication can be supported by existing L1 functionality.

For example, a reception behavior for the PCell provided to the UE by PCellDormancy-rxx may correspond to an active DL BWP, e.g., a ‘0’ value of the PCell dormancy indication for M=1 bit of the bitmap indicates reception ‘in any SBFD subband’. For example, a ‘1’ value may indicate ‘reception on SBFD DL subband 1 only’, e.g., the UE is indicated SBFD DL subband 1 for reception in an active DL BWP of the PCell. Or, one or a combination of UE reception behaviors associated with a ‘1’ value of the PCell dormancy indication may be configured for the UE by PCellDormancyGroup-rxx such as ‘reception in SBFD DL subband 1 only’, ‘reception in SBFD DL subband 2 only’, or ‘reception in both SBFD DL subband 1 and 2’, or ‘reception on SBFD symbols only’, or ‘reception on non-SBFD symbols’, or ‘reception on non-SBFD and SBFD symbols’, etc. It can be seen that the designation of ‘0’ or ‘1’ values is chosen for illustration purposes only. Similar regards with respect to the size up to N=5 bits of the existing/typical SCell dormancy field and M=1 bit associated with a PCell or a PCell as part of a dormancy group in the bitmap can be applied with respect to a dormancy indication provided by other DCI formats such as a DCI format 0_1/0_3/1_1/1_3.

In one embodiment, a new interpretation of an SCell dormancy indication field in a DCI format such as a DCI format 0_1/0_3/1_1/1_3 or a DCI format 2_6 is used. For example, a dormancy indication for either a PCell, or a PCell in a dormancy group, or an SCell dormancy group may use M>1 bit, e.g., M bits correspond to the PCell, or a PCell as part of a dormancy group configured by higher layers.

For example, in the case of DCI format 2_6, a Wake-up indication in a block is L=1 bit, and the dormancy indication field, if configured, is up to N bits in a block as configured for the UE by higher layers. In one variant of the example, the maximum block size Bₘₐₓ of the block configured for the UE by higher layers, e.g., based on the L=1 bit for the Wake-up indication and the M bits of a Dormancy Indication associated with a PCell, or a PCell in a dormancy group or an SCell group, if present, is the same as in an existing/typical DCI format 2_6, e.g., L+N=Bₘₐₓ=6. A smaller maximum number of dormancy groups may then be configured for the UE. In another variant of the example, the maximum block size Bₘₐₓ of the block configured for the UE by higher layers, e.g., based on the L=1 bit for the Wake-up indication and the M bits Dormancy Indication associated with a PCell, or a PCell in a dormancy group, or an SCell group, if present, is different from DCI format 2_6. For example, L+N=Bₘₐₓ=11 and for L=1 and M=2 bits for the Dormancy Indication associated with a PCell, PCell in a dormancy group, or an SCell group, floor (Bₘₐₓ−L)/M=5 groups may be configured in the bitmap. The block configured for a typical UE and the block configured for the later release, e.g., SBFD-aware UE can still be multiplexed into a same DCI format 2_6 even when the blocks have different lengths. This is because the typical UE and the later release UE are separately provided with a configuration of the starting position of a block in the DCI format 2_6 by the gNB. The UE may determine the size of the DCI format 2_6 by higher layer parameter sizeDCI-2-6. The UE may determine the starting position of the block in the DCI format 2_6 based the parameter ps-PositionDCI-2-6. The UE may determine a value, e.g., codepoint, for the dormancy indication bit or bits associated with the PCell, or a dormancy group, based on the starting position and the number of M bits per group or based on the N bits of the bitmap. Similar design evaluations can be applied to a dormancy indication field in DCI formats such as DCI formats 0_1/0_3/1_1/1_3.

A motivation is to support PCell dormancy indication outside Active Time while preserving the ability to multiplex typical and new release UEs based on a same DCI format 2_6 signaling design.

For example, when M=2, a first possible or allowed configurable reception behavior for the PCell may correspond to codepoint ‘00’ indicating ‘active DL BWP’, a codepoint ‘01’ indicating ‘reception on SBFD subband I only’, a codepoint ‘10’ indicating ‘reception on SBFD subband 2 only’ and a codepoint ‘11’ indicating ‘reception on any SBFD subband’. For example, when M=2, a second possible or allowed configurable reception behavior may correspond to codepoint ‘00’ indicating ‘reception on SBFD subband 1 only’, a codepoint ‘01’ indicating ‘reception on non-SBFD symbols only’, a codepoint ‘10’ indicating ‘reception in SBFD DL subband 2 only’ and a codepoint ‘11’ indicating ‘reception in any SBFD DL subband’. It can be seen that the designation of codepoints or values ‘00’, ‘01’, ‘10’ or ‘11’ for the case of M=2 PCell dormancy indication associated, possibly as part of a dormancy group, is chosen for illustration purposes only.

For example, a higher layer provided reception behavior for PCell dormancy with respect to an SBFD subband or a slot/symbol type may be associated with a duration. A same value of a duration or different values of durations may be associated with different reception behaviors. For example, reception behavior b2 associated with reception on SBFD DL subband 1 only on the PCell may be configured by higher layers for a duration of d2=320 msec, but reception behavior b3 associated with reception on SBFD DL subband 2 on the PCell only may be configured by higher layers for a duration of d3=160 msec. A higher-layer provided duration may correspond to a default value which is expected by the UE if no value is provided by higher layers.

As can be seen by someone skilled in the art, a configuration of, or an indication to the UE of reception behavior(s), or a UE procedure with respect to an indicated SBFD subband or indicated slot/symbol type for reception for the PCell dormancy can follow the design principles described for the SCell case in the present disclosure.

For example, a dormancy indication in a field or block associated with the PCell, or a PCell as part of a dormancy group of cells, in a DCI can be any of:
a typical SCell dormancy indication, e.g., M=1, with a value that maps to more than one sets of values for respective more than one sets of reception behaviors for the PCell, possibly including receptions from a TRP A or from TRP B, or from TRP A and TRP B, where the more than one sets of reception behaviors are associated with non-SBFD slots and SBFD slots, or with an SBFD DL subband or an SBFD UL subband, or an SBFD flexible subband. The value may be applicable to both non-SBFD slots/symbols and SBFD slots/symbols on the PCell, or may be applicable only to slots/symbols of same type as the slot/symbols of the reception with the DCI. One of TRP A or TRP B may be a reference or a default TRP associated with receptions on a serving cell.
an extended dormancy indication, e.g., M=2 or M=3, possibly with a number of bits that is larger than in case of non-full-duplex operation, where first bits from the number of bits provide a first value that maps to a first reception behavior for the PCell in non-SBFD slots and second bits from the number of bits provide a second value that maps to a second reception behavior for the PCell in SBFD slots, possibly with respect to receptions from TRP A or from TRP B, or from TRP A and TRP B. In similar manner, second bits from the number of bits may provide a second value that maps to a second reception behavior in an SBFD DL subband, or an SBFD UL subband, or an SBFD flexible subband of the PCell, possibly with respect to receptions from TRP A or from TRP B, or from TRP A and TRP B. The first and second reception behavior can be from a same set of or from separately provided sets of reception behaviors. In that latter case, a number of first bits and a number of second bits can be different and be determined from a size of a corresponding set of reception behaviors. One of TRP A or TRP B may be a reference or a default TRP associated with receptions on the PCell following reception of a dormancy indication on a serving cell.
a new dormancy indication field, e.g., M=2, that is applicable to SBFD slots or symbols, or to receptions in a configured or indicated SBFD DL subband, SBFD UL subband, or SBFD flexible subband, associated with an PCell, possibly with respect to receptions from TRP A or from TRP B, or from both TRP A and TRP B, while a typical SCell dormancy indication field or block, or another new SCell dormancy indication field or block, is applicable to non-SBFD slots or symbols, or to receptions in an SBFD DL subband, or an SBFD UL subband, or an SBFD flexible subband, of the SCell, possibly with respect to a reference or default TRP associated with receptions on a serving cell. A first number of bits for the typical SCell dormancy indication, or for a first new PCell dormancy indication, can be different from a second number of bits for the new SCell dormancy indication, where the first and second numbers of bits can be determined from the sizes of corresponding sets of reception behaviors. One of TRP A or TRP B may be a reference or a default TRP associated with receptions on the SCell.

In certain embodiments, the UE can be provided with a set of RS resources or RS resource indices, or the UE can determine a set of RS resources or RS resource indices for link recovery procedures. For simplicity of description and without loss of generality, the term “failure detection resource” may be used in the disclosure for an RS resource or an RS resource index associated with a link recovery procedure wherein the failure detection resource may be provided to the UE or determined by the UE. The term “failure detection set” may be used in the disclosure for a set of failure detection resources.

For example, a UE may be configured with a set of resource indexes, through a corresponding set of RadioLinkMonitoringRS, for radio link monitoring by failure DetectionResources. In one example, the UE may be provided with a CSI-RS resource configuration index, by csi-RS-Index, or the UE may be provided with an SS/PBCH block index, by ssb-Index. For example, the UE may be provided up to N_{LR-RLM} RadioLinkMonitoringRS for link recovery procedures and for radio link monitoring. In one example, from the N_{LR-RLM} RadioLinkMonitoringRS, up to N_{RLM} RadioLinkMonitoringRS may be used for radio link monitoring depending on L_{MAX} as described in REF3, and up to two RadioLinkMonitoringRS may be used for link recovery procedures. In one example, for NR band n78, the parameters L_{MAX}=8, N_{LR-RLM}=6 and N_{RLM}=4 may be applied.

For example, the UE (e.g., the UE 116) may be provided with a set of RS resources or RS resource indices, e.g., failure detection resources for a link recovery procedure. In one example, the UE may be provided, for each BWP of a serving cell, a set q̅₀ of periodic CSI-RS resource configuration indexes by failureDetectionResourcesToAddModList and a set q̅₁ of periodic CSI-RS resource configuration indexes and/or SS/PBCH block indexes by candidateBeamRSList or candidateBeamRSListExt or candidateBeamRSSCellList for radio link quality measurements on the BWP of the serving cell. In one example, instead of the sets q̅₀ and q̅₁, for each BWP of a serving cell, the UE may be provided respective two sets q̅_{0,0} and q̅_{0,1} of periodic CSI-RS resource configuration indexes by failureDetectionSet1 and failure DetectionSet2 that may be activated by a MAC CE and corresponding two sets q̅_{1,0} and q̅_{1,1} of periodic CSI-RS resource configuration indexes and/or SS/PBCH block indexes by candidateBeamRS-List and candidateBeamRS-List2, respectively, for radio link quality measurements on the BWP of the serving cell. The set q̅_{0,0} can be associated with the set q̅_{1,0} and the set q̅_{0,1} can be associated with the set q̅_{1,1}.

For example, the UE may determine a set of RS resources or RS resource indices, e.g., failure detection resources for a link recovery procedure. In one example, if the UE is not provided q̅₀ by failure DetectionResourcesToAddModList for a BWP of the serving cell, the UE may determine the set q̅₀ to include periodic CSI-RS resource configuration indexes with same values as the RS indexes in the RS sets indicated by TCI-State for respective CORESETs that the UE would use for monitoring PDCCH. In one example, if the UE is not provided q̅_{0,0} and q̅_{0,1} for a BWP of the serving cell, the UE may determine the set q̅_{0,0} and q̅_{0,1} to include periodic CSI-RS resource configuration indexes with same values as the RS indexes in the RS sets indicated by TCI-State for first and second CORESETs that the UE would use for monitoring PDCCH, respectively, where the UE is provided two coresetPoolIndex values 0 and 1 for the first and second CORESETs, or is not provided coresetPoolIndex value for the first CORESETs and is provided coresetPoolIndex value of 1 for the second CORESETs, respectively. For example, if there are two RS indexes in a TCI state, the set q̅₀ or q̅_{0,0}, or q̅_{0,1} may include RS indexes configured with qcl-Type set to ‘typeD’ for the corresponding TCI states. For example, if a CORESET that the UE uses for monitoring PDCCH includes two TCI states and the UE is provided sfnSchemePdcch set to ‘sfnSchemeA’ or ‘sfnSchemeB’, the set q̅₀ may include RS indexes in the RS sets associated with the two TCI states.

For example, the UE may expect to be provided or to determine a minimum or a maximum number of failure detection resources for a serving cell. In one example, the UE may expect that the set q̅₀ includes up to two RS indexes. In on example, if the UE is provided q̅_{0,0} or q̅_{0,1}, the UE may expect the set q̅_{0,0} or the set q̅_{0,1} to include up to a number of N_{BFD} RS indexes indicated by maxBFD-RS-resourcesPerSetPerBWP. For example, if the UE is not provided q̅_{0,0} or q̅_{0,1}, and if a number of active TCI states for PDCCH receptions in the first or second CORESETs is larger than N_{BFD}, the UE may determine the set q̅_{0,0} or q̅_{0,1} to include periodic CSI-RS resource configuration indexes with same values as the RS indexes in the RS sets associated with the active TCI states for PDCCH receptions in the first or second CORESETs corresponding to search space sets according to an ascending order for PDCCH monitoring periodicity. In one example, if more than one first or second CORESETs correspond to search space sets with same monitoring periodicity, the UE may determine the order of the first or second CORESETs according to a descending order of a CORESET index.

In certain embodiments, for simplicity of description and without loss of generality, the term “SCell” may be used in the disclosure for a secondary cell as defined in LTE or NR specifications, e.g., REF6. For example, an SCell may be configured or (de-) activated for the UE by the network (e.g., the network 130) in carrier aggregation or in dual-connectivity, including multi-RAT dual-connectivity cases such as NR-NR or LTE-NR dual-connectivity.

In one embodiment, the UE can be provided with information to use separate beam failure detection and/or separate beam failure recovery procedures on an SCell with SBFD support wherein separate beam failure detection and/or separate beam failure recovery procedures can apply with respect to a selected slot/symbol type or a selected SBFD subband of an SCell. For example, the UE may be provided with information to use separate link recovery procedures on the SCell with respect to a first selected slot/symbol type or selected SBFD subband of an SCell and with respect to a second selected slot/symbol type or selected SBFD subband of an SCell. For example, the UE may be provided with separate parameterization associated with a first and a second link recovery procedure, respectively, on the SCell with SBFD support. In one example, a first and a second value for a parameter such as a parameter for link quality evaluation or a parameter for link recovery, associated with the first and the second link recovery procedure, respectively, are separately provided to the UE. In one example, a second value for a parameter associated with the second link recovery procedure such as a parameter for link quality evaluation or a parameter for link recovery, is determined by the UE based on a higher-layer provided first parameter associated with the first link recovery procedure using an offset or adjustment value.

For example, an SBFD subband type may correspond to an SBFD DL subband, an SBFD UL subband, or an SBFD flexible subband. For example, a slot/symbol type may correspond to ‘SBFD’ or ‘non-SBFD’, or may correspond to ‘D’ or ‘F’ or ‘U’. For example, separate link recovery procedures on the SCell with SBFD support can be associated with a set or a combination of SBFD subbands or subband types such as ‘SBFD DL subband 1 and 2’ or ‘SBFD DL and flexible subband’ or a set or a combination of symbol/slot types such as ‘D and F’. For example, a configuration or parameterization of a link recovery procedure may be provided with respect to a DL BWP. In one example, an DL BWP may be provided by BWP-Id. In one example, a DL BWP may be an active DL BWP. In one example, an active DL BWP may be a dormant BWP, e.g., an active DL BWP may be provided by dormantBWP-Id. In one example, an active DL BWP may be provided by first WithinActiveTimeBWP-Id.

For example, when the UE is provided with information for separate beam failure detection, or separate beam failure recovery, or separate link recovery procedures on an SCell with SBFD support, wherein separate UE measurement and/or evaluation behavior for radio link quality maybe be configured/indicated with respect to a selected slot/symbol type or a selected SBFD subband of an SCell, a separate link recovery procedure may be associated with one or more of:
The symbol (or slot) types associated with a reception on an SCell, e.g., SBFD and/or non-SBFD symbol/slots, or ‘D’ and/or ‘F’ and/or ‘U’ symbols/slots
The TRP or TRPs to monitor receptions on an SCell, e.g., from TRP A and/or TRP B
The SBFD configuration associated with an SCell
The type of SBFD subband to monitor on an SCell, e.g., SBFD DL subband, and/or SBFD UL subband, and/or first SBFD DL subband, and/or second SBFD DL subband, and/or SBFD flexible subband
The duration of monitoring on an SCell, wherein the duration can be in units of slots or symbols or sub-frames or frames, or milliseconds, etc.

A motivation to enable selective indication of slot/symbol type or SBFD subband type for reception on an SCell with SBFD support is improved radio link robustness. Separate beam management for the non-SBFD and SBFD symbols/slots, respectively, can enable an evaluation of radio link quality by the UE which is adjusted to the actual link conditions or QCL expectations in the different slot/symbol types. Another motivation is reduced UE power consumption. For example, when one SBFD subband is indicated to the UE for reception in the active DL BWP of the SCell, a single ADC process, a single FFT process, or a single channel estimation process can then be used by the UE. Upon reception of an indication associated with a limited receive bandwidth, e.g., on an indicated SBFD subband, for an active DL BWP of the SCell, the UE can adjust its receiver correspondingly. For example, the UE may set or adjust an ADC step size or ADC resolution, or adjust an FFT size to process the reception bandwidth in the active DL BWP based on the location or size of the indicated SBFD subband. For example, the UE may set or adjust receive filtering coefficients to increase inter-subband selectivity based on the location or size of the indicated SBFD subband. When separate beam management can be supported for UE operation for an indicated SBFD subband in a limited receive bandwidth for a UE reception of DL data in the indicated SBFD subband of the SCell, a UE reception of DL RS to support a link recovery procedure can then also be contained within the same limited receive bandwidth.

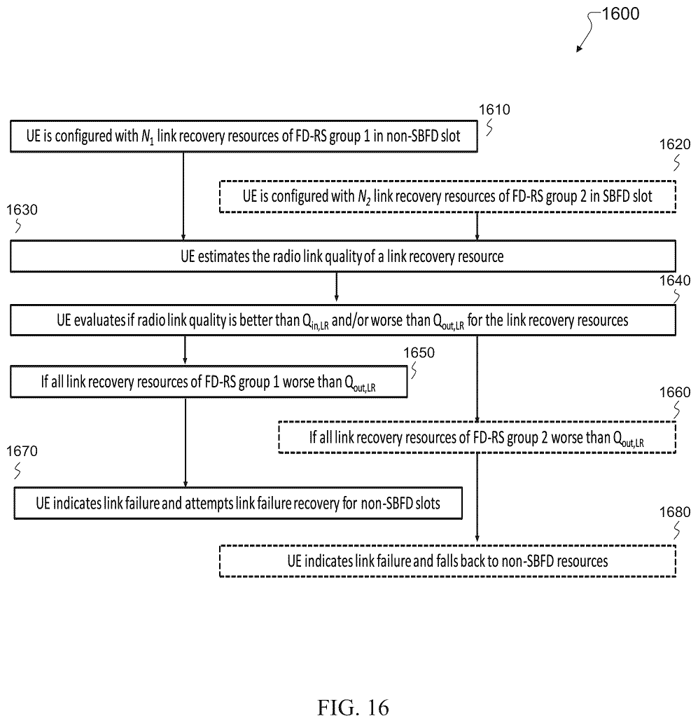

FIG. 16 illustrates a flowchart of an example procedure 1600 for evaluation of link recovery according to embodiments of the present disclosure. For example, procedure 1600 for evaluation of link recovery can be followed by any of the UEs 111-116 of FIG. 1, such as the UE 113. This example is for illustration only and other embodiments can be used without departing from the scope of the present disclosure.

The procedure begins in 1610, a UE is configured with N₁ link recovery resources of FD-RS group 1 in non-SBFD slot. In 1620, the UE is configured with N₂ link recovery resources of FD-RS group 2 in SBFD slot. In 1630, the UE estimates the radio link quality of a link recovery resource. In 1640, the UE evaluates if radio link quality is better than and/or worse than for the link recovery resources. In 1650, the UE determines whether all link recovery resources of FD-RS group are worse than Q_{out,LR}. In 1660, the UE determines whether all link recovery resources of FD-RS group 2 are worse than Q_{out,LR}. In 1670, the UE indicates link failure and attempts link failure recovery for non-SBFD slots. In 1680, the UE indicates link failure and falls back to non-SGFD resources.

In one embodiment, the UE is configured with separate link recovery procedures associated with a selected slot/symbol type or associated with a selected SBFD subband of an SCell, respectively. For example, the UE may be provided with information to use separate link recovery procedures on the SCell with respect to a first selected slot/symbol type or selected SBFD subband of an SCell and with respect to a second selected slot/symbol type or selected SBFD subband of an SCell. In one example, the UE is provided by higher layers with separate failure detection sets for non-SBFD slots/symbols and SBFD slots/symbols, respectively, or for different SBFD subbands, respectively.

In one embodiment, the UE determines separate link recovery procedures associated with a selected slot/symbol type or associated with a selected SBFD subband of an SCell, respectively, based on a configuration/indication of failure detection resource or failure detection set, e.g., using RS resource or an RS resource index for link recovery, provided by higher layers. In one example, the UE is provided by higher layers with failure detection resources in non-SBFD slots/symbols and SBFD slots/symbols, respectively, or in different SBFD subbands, and the UE selects a first subset from the link failure resources configured/indicated in non-SBFD slots/symbols or in a first SBFD subband for a first link recovery procedure, the UE selects a second subset from the link failure resources configured/indicated in SBFD slots/symbols or in a second SBFD subband for a second link recovery procedure.

For example, the UE may be provided with information to use separate link recovery procedures on the SCell with respect to a first selected slot/symbol type or first selected SBFD subband of an SCell and with respect to a second selected slot/symbol type or second selected SBFD subband of an SCell.

In one embodiment, the UE is provided with or the UE determines multiple failure detection (FD) resource set (RS) groups for link recovery. For example, the UE may be provided with or determine Z=2 failure detection resource set (FD-RS) groups (or sets). For example, the UE can be provided a set of reference signal (RS) resources or set of RS resource indices for each FD-RS group. For example, the UE is provided a CSI-RS resource or CSI-RS resource index, or an SSB resource or SSB index, as RS resource or RS resource index for an FD-RS group. An FD-RS group may be associated with a configurable set of time-domain resources, e.g., a set of slots or symbols in which a corresponding set of RS resources or of RS resource indexes are provided to the UE. A UE may also be provided by higher layers an association between slots or symbols for radio link quality or link failure evaluation and an FD-RS group. Alternatively, an association between slots and symbols or an FD-RS group may be indicated through the time-domain resource allocation of the RS resources or RS resource indices configured for an FD-RS group. In one example, the UE evaluates radio link quality or link quality on an SCell based on a parameter provided to the UE by higher layers for a configured/indicated SBFD subband for an SCell or SCell group.

A first FD-RS group may be configured on non-SFBD slots or symbols. A second FD-RS group may be configured on SFBD slots or symbols. The first FD-RS group may be referred to as Primary FD-RS group. The second FD-RS group may be referred to as Secondary FD-RS group. The UE performs radio link monitoring or link failure detection using the RS of an FD-RS group for the associated time-domain resources, e.g., slots or symbols. When evaluating DL radio link quality or link failure detection, the UE may indicate link quality, e.g., using the thresholds Q_{out,LR} and Q_{in,LR}, respectively, to higher layers for each FD-RS group separately. For example, the UE may indicate “below Q_{out,LR}” for the failure detection resources for one FD-RS group while indicating “above Q_{in,LR}” for the failure detection resources in another FD-RS group, or the UE may indicate “above Q_{in,LR}” for the two FD-RS groups, or the UE may indicate that the two FD-RS groups are “below Q_{out,LR}”

For example, on an FD-RS resource of an FD-RS group, the UE may assess the radio link quality and may compare it against the thresholds Q_{out,LR} and Q_{in,LR} for monitoring radio link quality of the configured FD-RS group and its associated time-domain resources on the SCell. In one example, a failure detection resource of an FD-RS group for link recovery may be assessed with respect to the radio link quality of an SSB or a periodic CSI-RS resource configuration which is quasi co-located with the DMRS of PDCCH receptions by the UE on the SCell. For example, the UE can apply the Q_{in,LR} threshold to an L1-RSRP measurement obtained from an SSB. For example, the UE can apply the Q_{in,LR} threshold to the L1-RSRP measurement obtained for a CSI-RS resource after scaling a respective CSI-RS reception power with a value such as provided by powerControlOffsetSS.

For example, the physical layer in the UE may provide an indication to higher layers when the radio link quality or link failure detection evaluation for corresponding resource configurations in an FD-RS group associated with a slot/symbol type or with an SBFD subband that the UE uses to assess the radio link quality or link failure is worse than the threshold Q_{out,LR}. For example, the physical layer in the UE informs the higher layers when the radio link quality or link failure detection evaluation is worse than the threshold Q_{out,LR}.

For example, an indication or information of a radio link quality or link failure detection for an FD-RS group associated with a slot/symbol type or with an SBFD subband on the SCell may then be provided to higher layers with a periodicity. In one example, a periodicity may be determined based on a periodicity of an SSB and/or based on a periodic CSI-RS configuration that the UE uses to assess the radio link quality or link failure detection for the non-SBFD/SBFD resources and/or based on a periodicity associated with a configured/indicated SBFD subband. When in DRX mode operation, the physical layer in the UE may provide an indication to higher layers when the radio link quality or link quality evaluation is worse than the threshold Q_{out,LR} with a periodicity determined based on the DRX configuration, e.g., based on a DRX parameter such as a DRX on-duration timer, or a long or a short DRX cycle, of the first or the second DRX group in which the SCell with SBFD support is configured. For example, when link failure is detected by the UE for a second FD-RS group, e.g., on SBFD slots/symbols, the UE may fall back to data/control channel/signal reception using the radio resources associated with the first FD-RS group, e.g., on non-SBFD slots/symbols.

For example, for an SCell with SBFD support, upon request from higher layers, the UE may provide to higher layers separately the failure detection resources of a first and second FD-RS group, e.g., periodic CSI-RS configuration indexes and/or SSB indexes, possibly including a corresponding measurement such as L1-RSRP, that are larger than or equal to the Q_{in,LR} threshold. In one example, upon request from higher layers, the UE may indicate to higher layers for the first and second FD-RS group separately, whether there is at least one periodic CSI-RS configuration index or SSB index associated with the link recovery in non-SBFD slots/symbols, or SBFD slots/symbols, respectively, or associated with separate SBFD subbands, respectively, possibly including a corresponding measurement such as L1-RSRP that is larger than or equal to the Q_{in,LR} threshold.

It is one advantage of the solution that the multiple FD-RS groups can be configured for the UE to evaluate beam failure detection separately and to indicate the beam failure detection separately to higher layers for the set of non-SBFD or normal DL slots/symbols, and the set of SBFD slots/symbols on the SCell. For a second FD-RS group configured on SBFD slots or symbols, the UE physical layer then can indicate, in frames where the radio link quality is assessed, “below Q_{out,LR}” to higher layers only when the radio link quality is evaluated worse than the threshold Q_{out,LR} for RS resources in the set of configured RS resources in the second FD-RS group on SBFD slots or symbols. Insufficient reception quality of DL beams, e.g., “below Q_{out,LR}” for DL receptions of configured resources of the first FD-RS group on non-SBFD slot or symbols may occur at a different time, such as for example later than “below Q_{out,LR}” for DL receptions of configured resources in the second FD-RS group on SBFD slots due to more favorable Rx SINR conditions in the first group. Similar evaluations apply to the ability of the UE to issue separate “above Q_{in,LR}” indications for the first and the second set of configured FD-RS resources associated with the first and the second FD-RS group, respectively. It is another advantage that radio link failure, beam management for the non-SBFD slots/symbols and SBFD slots/symbols, or for the SBFD subbands on the SCell can then be separately reported and if needed, be adjusted by the gNB.

For example, the UE may determine first and second FD-RS groups, FD-RS₁ and FD-RS₂, for link recovery in a serving cell. The first FD-RS group FD-RSI for a serving cell is associated with RS(s) configured for the UE in a first set of slots or symbols or a first SBFD subband of the serving cell, such as in non-SBFD slots or symbols or an SBFD DL subband 1. The second FD-RS group FD-RS₂ for a serving cell is associated with RS(s) configured for the UE in a second set of slots or symbols or a second SBFD subband on the serving cell, such as in SBFD slots or symbols or an SBFD DL subband 2. On the FD-RS resource(s) in an FD-RS group, the UE estimates the DL radio link quality and compares it to the thresholds Q_{out,LR} and Q_{in,LR} for monitoring radio link quality of the cell in one or multiple slots or symbols or in an SBFD subband. The UE evaluation of the radio link quality thresholds Q_{out,LR} and Q_{in,LR}, may account for an evaluation or indication period. The length, duration or criteria associated with an evaluation or indication period for the first and second FD-RS group, FD-RS₁ and FD-RS₂, respectively, may be indicated or specified by same parameters or by separate parameters.

A first FD-RS group and a second FD-RS group, FD-RS₁ and FD-RS₂ respectively, associated with RS(s) in different FD-RS slot/symbol groups or in different SBFD subbands may be provided to the UE by one or a combination of RRC signaling and/or configuration, MAC CE signaling, L1 control signaling by DCI, or tabulated and/or listed by system operating specifications.

A first FD-RS group FD-RS₁ associated with a first set of time-domain resources, e.g., slots or symbols, is provided to the UE by RRC whereas the UE determines a second FD-RS group FD-RS₂ associated with a second set of time-domain resources, e.g., slots or symbols, from, e.g., L1 control signaling by DCI. The determination of a second FD-RS group FD-RS₂ associated with a second set of time-domain resources, e.g., slots or symbols, may depend on and be a function of a first provided FD-RS group FD-RS₁. For example, the UE may determine RS resources or RS resource indices for FD-RS₂ as a set of RS resources or RS resource indices configured with respect to or as function of a set of RS resources or RS resources indices configured for FD-RS₁. Similar evaluations can apply when time-domain resources associated with a first FD-RS group FD-RS₁ and second FD-RS group FD-RS₂ associated with RS(s) in different SBFD subbands are indicated to or determined by the UE.

For example, the sets of RS resources in a first FD-RS group and a second FD-RS group, FD-RS₁ and FD-RS₂ respectively, on a serving cell may be provided to or determined by the UE by means of RS resource indices. For example, a RS resource index may correspond to an SSB index, or a CSI-RS resource index, or a TCI state for PDCCH reception that includes one or more CSI-RS.

For example, the RS resources or RS resource indices of the first FD-RS group or second FD-RS group may be included in one or more signaling messages and/or IEs. For example, and without loss of generality, the gNB (e.g., the gNB 102) may provide these to the UE as part of RRC signaling messages of type RRCSetup, RRCReconfiguration, SIB1 or SystemInformation and or may provide such configuration in RRC IEs of type ServingCellConfig, ServingCellConfigCommon, or ServingCellConfigSIB1 where an RRC configuration parameter may be of enumerated, listed or sequence type, and/or may be encoded as a bit string.

For example, the UE may determine the radio link quality in a slot or symbol or SBFD subband using a same RS resource or RS resource index configured in both the first and the second FD-RS groups FD-RS₁ and FD-RS₂. A signaling condition or priority rules may then be used by the UE to include the same RS resource or RS resource index in a particular occurrence, e.g., slot or symbol or SBFD subband, in the radio link quality or link failure evaluation.

For example, a same RS resource or RS resource index associated with a first FD-RS group and a second FD-RS group may be configured on a flexible slot or symbol. When the UE determines the flexible slot or symbol to be scheduled or configured by the gNB for DL-only transmissions, the UE includes the same RS resource or RS resource index as part of the radio link quality or link failure evaluation for the first FD-RS group, e.g., on non-full-duplex or non-SBFD slots or symbols. When the UE determines the flexible slot or symbol to be scheduled or configured by the gNB for DL and UL transmissions on the SCell, e.g., the flexible slot or symbol is used by the gNB for full-duplex or SBFD transmissions and receptions, the UE includes the same RS resource or RS resource index as part of the radio link quality or link failure evaluation for the second FD-RS group, e.g., on full-duplex or SBFD slots or symbols. When the UE receives a DCI format scheduling transmission or reception on a slot or symbol, the UE may select an FD-RS group to determine the radio link quality using the associated RS resource or RS resource index of the FD-RS in that slot or symbol.

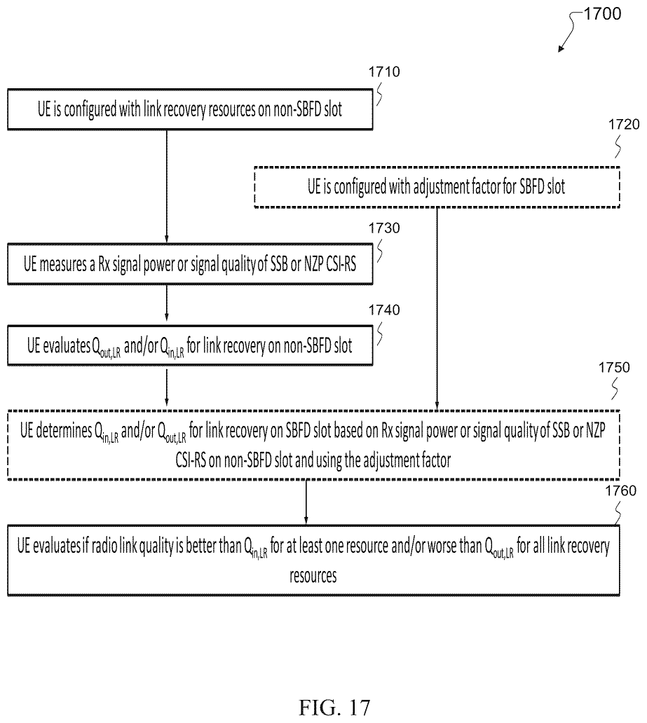

FIG. 17 illustrates a flowchart of an example procedure 1700 for evaluation of link recovery according to embodiments of the present disclosure. For example, procedure 1700 for evaluation of link recovery can be followed by any of the UEs 111-116 of FIG. 1, such as the UE 114. This example is for illustration only and other embodiments can be used without departing from the scope of the present disclosure.

The procedure begins in 1710, a UE is configured with link recovery resources in non-SBFD slot. In 1720, the UE is configured with an adjustment factor for SBFD slow. In 1730, the UE measures a RX signal power or signal quality of SSB or NZP CSI-RS. In 1740, the UE evaluates Q_{out,LR}, and/or Q_{in,LR} for link recovery on non-SBFD slot. In 1750, the UE determines Q_{in,LR}, and/or Q_{out,LR} for link recovery on SBFD slot based on RX receiving signal power or signal quality of SSB or NZP CSI-RS on non-SBFD slot and using the adjustment factor. In 1760, the UE evaluates if the radio link quality is better than Q_{in,LR} for at least one resource and/or worse than Q_{out,LR} for all link recovery resources.

In one embodiment, the UE is provided with separate parameters for rlmInSyncOutOfSyncThreshold, or rsrp-ThresholdSSB or rsrp-ThresholdBFR, respectively, for an RS resource or an RS resource index in a first FD-RS group and in a second FD-RS group, respectively.

For example, a first FD-RS group may be configured on non-SFBD slots or symbols or for SBFD DL subband 1. A second FD-RS group may be configured on SFBD slots or symbols or for SBFD DL subband 2. The UE is indicated by higher layers a first value for parameter rlmInSyncOutOfSyncThreshold₁, or rsrp-ThresholdSSB₁ or rsrp-ThresholdBFR₁.for the RS resource or RS resource indices of the first FD-RS group. The UE is indicated by higher layers a second value for parameter rlmInSyncOutOfSyncThreshold₂, or rsrp-ThresholdSSB₂ or rsrp-ThresholdBFR₂, for the RS resource or RS resource indices of the second FD-RS group. When a UE is not provided a value for a parameter rlmInSyncOutOfSync Threshold, or rsrp-ThresholdSSB or rsrp-ThresholdBER for an RS resource or an RS resource index of the first or the second FD-RS group, the UE may determine a value based on a default value.

In one embodiment, a UE (e.g., the UE 116) evaluates the sets of RS resources or RS resource indices associated with a first FD-RS group and a second FD-RS group using separately determined/indicated respective evaluation periods T_{Evaluate_out} and/or T_{Evaluate_in}. Evaluation periods and adjustment factors applied to a first FD-RS group and a second FD-RS group may account for presence/absence of non-SBFD/SBFD slots or SBFD subband configuration on the SCell. For example, an evaluation period for a first FD-RS group may be increased or scaled by accounting or adjusting for a number of SBFD slots or symbols during a time period on a serving cell. For example, an evaluation period for a second FD-RS group may be decreased or scaled by accounting or adjusting for a number of non-SBFD slots during a time period on a serving cell.

For example, a first FD-RS group may be configured on non-SFBD slots or symbols. A second FD-RS group may be configured on SFBD slots or symbols. The UE evaluates whether the radio link quality on the configured FD-RS resource of the first FD-RS group estimated over the last T_{Evaluate_out,1} [msec] period becomes worse than the threshold Q_{out,LR,1} within T_{Evaluate_out,1} [msec] evaluation period. The UE evaluates whether the radio link quality on the configured FD-RS resource of the first FD-RS group estimated over the last T_{Evaluate_in,LR,1} [msec] period becomes better than the threshold Q_{in,LR,1} within T_{Evaluate_in,LR,1} [msec] evaluation period. The UE evaluates whether the DL radio link quality on the configured FD-RS resource of the second FD-RS group estimated over the last T_{Evaluate_out,LR,2} [msec] period becomes worse than the threshold Q_{out,2} within T_{Evaluate_out,LR,2} [msec] evaluation period. The UE evaluates whether the radio link quality on the configured FD-RS resource of the second FD-RS group estimated over the last T_{Evaluate_in,LR,2} [msec] period becomes better than the threshold Q_{in,LR,2} within T_{Evaluate_in,LR,2} [msec] evaluation period. For example, in the case of no DRX, T_{Evaluate_out,LR,1}=200 msec and T_{Evaluate_out,LR,2}=300 msec, T_{Evaluate_in,LR,1}=100 msec and T_{Evaluate_in,LR,2}=150 msec.

In one embodiment, a UE evaluates the sets of RS resources or RS resource indices associated with a second FD-RS group using an adjustment or offset or scaling value with reference to a first FD-RS group that can be indicated to the UE by higher layers. An adjustment or offset or scaling value for link failure detection a non-SBFD or SBFD slot/symbol or an SBFD subband of an SCell can be used with respect to a measurement on a same SCell or with respect to a measurement on another serving cell and the adjustment or offset or scaling value applied to the SBFD SCell.

The UE applies the Q_{out,LR} Or Q_{in,LR} threshold(s) of a second FD-RS group to the measurement(s) obtained for an SSB-based or CSI-RS based resource of a first FD-RS group after scaling a respective SSB or CSI-RS reception power with an adjustment or offset or scaling value for an FD-RS resource configured in an SBFD slot or symbol or an SBFD subband. Different adjustment or offset or scaling value(s) may be provided to the UE for the Q_{out,LR} Or Q_{in,LR} threshold(s). Multiple adjustment or offset or scaling value(s) may be provided to the UE for the Q_{out,LR} and Q_{in,LR} threshold(s), respectively. A specified default adjustment or offset or scaling value may be expected by the UE when a corresponding indication is not provided to the UE by higher layers.

For example, a first FD-RS group may be configured for non-SFBD slots or symbols or for an SBFD DL subband 1. A second FD-RS group may be configured for SFBD slots or symbols or for an SBFD DL subband 2. The UE is provided with an adjustment value Deltaₒᵤₜ=−6 dB for Q_{out,LR} evaluations by higher layers for the RS resources or RS resource indices of the second FD-RS group. The UE is provided with an adjustment value Deltaᵢₙ=+3 dB for Q_{in,LR} evaluations by higher layers for the RS resources or RS resource indices of the second FD-RS group. The UE evaluates the measurement quantity for an SSB-based RS of the first FD-RS group to evaluate if the Q_{out,LR} evaluation criterion is met. The UE uses the measurement and applies the configured Deltaₒᵤₜ adjustment value to determine if the Q_{out,LR} criterion for an RS of the second FD-RS group is met, e.g., the UE scales a respective SSB or CSI-RS reception power with an adjustment or offset or scaling value for an FD-RS resource configured in an SBFD slot or symbol. The UE uses the measurement and applies the configured Deltaᵢₙ adjustment value to determine if the Q_{in,LR} evaluations criterion for a RS of the second FD-RS group is met. As can be seen, the use of an adjustment or offset or scaling value can be defined as desired, e.g., with respect to a measurement in an SBFD slot which is then adjusted to determine Q_{out,LR} or Q_{in,LR} criterion for a non-SBFD slot, or with respect to a measurement in a first SBFD subband which is then adjusted to determine the Q_{out,LR} or Q_{in,LR} criterion for a second-SBFD subband.

It is one advantage of the solution that radio link quality or link recovery evaluation can be configured for the UE to account for a single expected link degradation factor when comparing DL receptions in non-SBFD and SBFD slots or in different SBFD subbands. When the number of more available DL TRX for DL transmissions using a normal DL slot and the number of fewer DL TRX for DL transmissions using the DL subbands of an SBFD slot are known and other antenna panel design parameters are accounted for, the difference for radio link quality or link recovery evaluation can be estimated by the network implementation and be provided as single offset or adjustment value to balance the expected link failure detection behavior of the UE for the non-SBFD and SBFD slots or for the SBFD subbands. UE complexity to implement link failure detection behavior on the SCell is reduced.

Any of the above variation embodiments can be utilized independently or in combination with at least one other variation embodiment. The above flowchart illustrates example methods that can be implemented in accordance with the principles of the present disclosure and various changes could be made to the methods illustrated in the flowchart herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for a user equipment (UE) to receive physical downlink control channels (PDCCHs), the method comprising:
receiving a set of carrier aggregation (CA) parameters for a serving cell associated with a subband full-duplex (SBFD) configuration on the serving cell;
receiving a first PDCCH that provides a downlink control information (DCI) format, wherein:
the DCI format includes a secondary cell (SCell) dormancy indication enabling or disabling receptions of a second PDCCH, in a downlink (DL) bandwidth part (BWP) associated with a group of configured SCells, for a symbol or a subband type, and
the enabling or disabling of receptions of the second PDCCH is based on the set of CA parameters;
selecting, based on the SCell dormancy indication, the symbol or the subband type for receptions of the second PDCCHs on an SCell in the group of configured SCells; and
receiving, based on (i) the selected symbol or subband type and (ii) the set of CA parameters, the second PDCCH in the BWP of the SCell at a first occasion,
wherein the first occasion is after reception of the first PDCCH and before an end of a time duration, and
wherein the symbol or subband type is one of:
an SBFD symbol or a non-SBFD symbol,
a downlink (DL) or a flexible symbol for an SBFD symbol, or
a first SBFD DL subband, a second SBFD DL subband, an SBFD flexible subband, or an SBFD UL subband.

2. The method of claim 1, wherein:
the SCell dormancy indication corresponds to:
a field in a DCI format 0_1, 0_3, 1_1, or 1_3, or
one or more bits in a block of a DCI format 2_6, and
the method further comprises receiving a radio resource control (RRC) parameter providing the symbol or the subband type associated with receptions of the second PDCCH.

3. The method of claim 1, wherein:
the SCell dormancy indication corresponds to a set of bits in a DCI format 0_1, 0_3, 1_1, 1_3, or 2_6, and
the method further comprises:
receiving a first radio resource control (RRC) parameter providing a first symbol or subband type associated with receptions of the second PDCCH for a first set of codepoints from the set of bits, and
receiving a second RRC parameter providing a second symbol or subband type associated with receptions of the second PDCCH for a second set of codepoints from the set of bits.

4. The method of claim 1, wherein:
the SCell dormancy indication includes first bits and second bits in a field of a DCI format 0_1, 0_3, 1_1, 1_3 or in a block of DCI format 2_6, and
the method further comprises:
receiving a first radio resource control (RRC) parameter providing a first symbol or subband type associated with receptions of the second PDCCH based on the first bits, and
receiving a second RRC parameter providing a second symbol or subband type associated with receptions of the second PDCCH based on the second bits.

5. The method of claim 1, further comprising:
determining a value for a timer or counter associated with the symbol or the subband type for receptions of the second PDCCH,
wherein receiving the second PDCCH further comprises receiving the second PDCCH while the timer or counter value is non-zero.

6. The method of claim 1, wherein a first symbol or the subband type for receptions of the second PDCCH is associated with an radio resource control (RRC) parameter dormantBWP-Id or first WithinActiveTimeBWP-Id.

7. A user equipment (UE), comprising:
a transceiver configured to:
receive a set of carrier aggregation (CA) parameters for a serving cell associated with a subband full-duplex (SBFD) configuration on the serving cell; and
receive a first physical downlink control channel (PDCCH) that provides a downlink control information (DCI) format, wherein:
the DCI format includes a secondary cell (SCell) dormancy indication enabling or disabling receptions of a second PDCCH, in a downlink (DL) bandwidth part (BWP) associated with a group of configured SCells, for a symbol or a subband type, and
the enabling or disabling of receptions of the second PDCCH is based on the set of CA parameters; and
a processor operably coupled with the transceiver, the processor configured to select, based on the SCell dormancy indication, the symbol or the subband type for receptions of the second PDCCHs on an SCell in the group of configured SCells,
wherein the transceiver is further configured to receive, based on (i) the selected symbol or subband type and (ii) the set of CA parameters, the second PDCCH in the BWP of the SCell at a first occasion,
wherein the first occasion is after reception of the first PDCCH and before an end of a time duration, and
wherein the symbol or subband type is one of:
an SBFD symbol or a non-SBFD symbol,
a downlink (DL) or a flexible symbol for an SBFD symbol, or
a first SBFD DL subband, a second SBFD DL subband, an SBFD flexible subband, or an SBFD UL subband.

8. The UE of claim 7, wherein:
the SCell dormancy indication corresponds to:
a field in a DCI format 0_1, 0_3, 1_1, or 1_3, or
one or more bits in a block of a DCI format 2_6, and
the transceiver is further configured to receive a radio resource control (RRC) parameter providing the symbol or the subband type associated with receptions of the second PDCCH.

9. The UE of claim 7, wherein:
the SCell dormancy indication corresponds to a set of bits in a DCI format 0_1, 0_3, 1_1, 1_3, or 2_6, and
the transceiver is further configured to:
receive a first radio resource control (RRC) parameter providing a first symbol or subband type associated with receptions of the second PDCCH for a first set of codepoints from the set of bits, and
receive a second RRC parameter providing a second symbol or subband type associated with receptions of the second PDCCH for a second set of codepoints from the set of bits.

10. The UE of claim 7, wherein:
the SCell dormancy indication includes first bits and second bits in a field of a DCI format 0_1, 0_3, 1_1, 1_3 or in a block of DCI format 2_6, and
the transceiver is further configured to:
receive a first radio resource control (RRC) parameter providing a first symbol or subband type associated with receptions of the second PDCCH based on the first bits, and
receive a second RRC parameter providing a second symbol or subband type associated with receptions of the second PDCCH based on the second bits.

11. The UE of claim 7, wherein:
the processor is further configured to determine a value for a timer or counter associated with the symbol or the subband type for receptions of the second PDCCH, and
the transceiver is further configured to receive the second PDCCH while the timer or counter value is non-zero.

12. The UE of claim 7, wherein a first symbol or the subband type for receptions of the second PDCCH is associated with an radio resource control (RRC) parameter dormantBWP-Id or first WithinActiveTimeBWP-Id.

13. A base station, comprising:
a transceiver configured to:
transmit a set of carrier aggregation (CA) parameters for a serving cell associated with a subband full-duplex (SBFD) configuration on the serving cell;
transmit a first physical downlink control channel (PDCCH) that provides a downlink control information (DCI) format, wherein:
the DCI format includes a secondary cell (SCell) dormancy indication enabling or disabling transmissions of a second PDCCH, in a downlink (DL) bandwidth part (BWP) associated with a group of configured SCells, for a symbol or a subband type, and
the enabling or disabling of transmissions of the second PDCCH is based on the set of CA parameters; and
a processor operably coupled with the transceiver, the processor configured to select, based on the SCell dormancy indication, the symbol or the subband type for transmissions of the second PDCCHs on an SCell in the group of configured SCells,
wherein the transceiver is further configured to transmit, based on (i) the selected symbol or subband type and (ii) the set of CA parameters, the second PDCCH in the BWP of the SCell at a first occasion,
wherein the first occasion is after transmission of the first PDCCH and before an end of a time duration, and
wherein the symbol or subband type is one of:
an SBFD symbol or a non-SBFD symbol,
a downlink (DL) or a flexible symbol for an SBFD symbol, or
a first SBFD DL subband, a second SBFD DL subband, an SBFD flexible subband, or an SBFD UL subband.

14. The base station of claim 13, wherein:
the SCell dormancy indication corresponds to:
a field in a DCI format 0_1, 0_3, 1_1, or 1_3, or
one or more bits in a block of a DCI format 2_6, and
the transceiver is further configured to transmit a radio resource control (RRC) parameter providing the symbol or the subband type associated with transmissions of the second PDCCH.

15. The base station of claim 13, wherein:
the SCell dormancy indication corresponds to a set of bits in a DCI format 0_1, 0_3, 1_1, 1_3, or 2_6, and
the transceiver is further configured to:
transmit a first radio resource control (RRC) parameter providing a first symbol or subband type associated with transmissions of the second PDCCH for a first set of codepoints from the set of bits, and
transmit a second RRC parameter providing a second symbol or subband type associated with transmissions of the second PDCCH for a second set of codepoints from the set of bits.

16. The base station of claim 13, wherein:
the SCell dormancy indication includes first bits and second bits in a field of a DCI format 0_1, 0_3, 1_1, 1_3 or in a block of DCI format 2_6, and
the transceiver is further configured to:
transmit a first radio resource control (RRC) parameter providing a first symbol or subband type associated with transmissions of the second PDCCH based on the first bits, and
transmit a second RRC parameter providing a second symbol or subband type associated with transmissions of the second PDCCH based on the second bits.

17. The base station of claim 13, wherein:
the processor is further configured to determine a value for a timer or counter associated with the symbol or the subband type for transmissions of the second PDCCH, and
the transceiver is further configured to transmit the second PDCCH while the timer or counter value is non-zero.

18. The base station of claim 13, wherein a first symbol or the subband type for transmissions of the second PDCCH is associated with an radio resource control (RRC) parameter dormantBWP-Id or first WithinActiveTimeBWP-Id.
